(19) United States
(12) Patent Application Publication
(10) Pub. No.: US 2020/0387777 A1
(43) Pub. Date: Dec. 10, 2020

(54) LAGRANGE CODED COMPUTING: OPTIMAL DESIGN FOR RESILIENCY, SECURITY, AND PRIVACY

(71) Applicants: UNIVERSITY OF SOUTHERN CALIFORNIA, LOS ANGELES, CA (US); CALIFORNIA INSTITUTE OF TECHNOLOGY, PASADENA, CA (US)

(72) Inventors: Salman AVESTIMEHR, Los Angeles, CA (US); Mohammadreza Mousavi KALAN, Los Angeles, CA (US); Netanel RAVIV, Los Angeles, CA (US); Mahdi SOLTANOLKOTABI, Los Angeles, CA (US); Songze LI, Los Angeles, CA (US); Qian YU, Los Angeles, CA (US)

(21) Appl. No.: 16/893,917

(22) Filed: Jun. 5, 2020

Related U.S. Application Data
(60) Provisional application No. 62/857,379, filed on Jun. 5, 2019.
(60) Provisional application No. 63/016,182, filed on Apr. 27, 2020.

(51) Int. Cl. G06N 3/04; G06N 20/20

(52) U.S. Cl. CPC G06N 3/0481; G06N 20/20; G06N 3/0472

(57) ABSTRACT

A method for calculating a given multivariate polynomial f(Xᵢ) is provided. The multivariate polynomial f(Xᵢ) is to be calculated for every Xᵢ in a large dataset X=(X₁, X₂, . . . ; X_{K}) in accordance with an S-resilient, A-secure, and T-private scheme where K is an integer enumerating the number of elements in the dataset X, S is the number of stragglers to be tolerated, A is the number of adversaries to be tolerated, and T is the number of colluding workers that to be tolerated. The method is implemented by a computer system that includes a master computing device and a plurality of worker computing devices. The working computing devices can include colluding workers, malicious computing devices, and straggler computing devices.

### CROSS-REFERENCE TO RELATED APPLICATIONS

This application claims the benefit of U.S. provisional application Ser. No. 62/857,379 filed Jun. 5, 2019, and U.S. provisional application Ser. No. 63/016,182 filed Apr. 27, 2020, the disclosures of which are hereby incorporated in their entirety by reference herein.

### STATEMENT REGARDING FEDERALLY SPONSORED RESEARCH OR DEVELOPMENT

The invention was made with Government support under Contract No. HR001117C0053 awarded by the Defense Advanced Research Projects Agency; Contract No. CCF-1703575 awarded by the National Science Foundation; Contract No. W911NFA810400 awarded by the Army Research Office; Contract No. N00014-16-1-2189 awarded by the Office of Naval Research; and Contract No. CCF1317694 awarded by the National Science Foundation. The Government has certain rights to the invention.

### TECHNICAL FIELD

In at least one aspect, the present invention is related to coded computing with enhanced resiliency, security, and privacy.

### BACKGROUND

The massive size of modern datasets necessitates computational tasks to be performed in a distributed fashion, where the data is dispersed among many servers that operate in parallel [1]. As we “scale out” computations across many servers, however, several fundamental challenges arise. Cheap commodity hardware tends to vary greatly in computation time, and it has been demonstrated [2]-[4] that a small fraction of servers, referred to as stragglers, can be 5 to 8 times slower than the average, thus creating significant delays in computations. Also, as we distribute computations across many servers, massive amounts data must be moved between them to execute the computational tasks, often over many iterations of a running algorithm, and this creates a substantial bandwidth bottleneck [5]. Distributed computing systems are also much more susceptible to adversarial servers, making security and privacy a major concern [6]-[8].

### SUMMARY

In at least one aspect, in the context of general scenario in which the computation is carried out distributively across several workers, the Lagrange Coded Computing (LCC) framework is provided. The LLC framework is a new framework to simultaneously provide 1) resiliency against straggler workers that may prolong computations; 2) security against Byzantine (or malicious, adversarial) workers, with no computational restriction, that deliberately send erroneous data in order to affect the computation for their benefit; and 3) (information-theoretic) privacy of the dataset amidst possible collusion of workers.

In another aspect, LCC can be applied to any computation scenario in which the function of interest is an arbitrary multivariate polynomial of the input dataset. This covers many computations of interest in machine learning, such as various gradient and loss-function computations in learning algorithms and tensor algebraic operations (e.g., low-rank tensor approximation). The key idea of LCC is to encode the input dataset using the well-known Lagrange polynomial, in order to create computational redundancy in a novel coded form across the workers. This redundancy can then be exploited to provide resiliency to stragglers, security against malicious servers, and privacy of the dataset.

In another aspect, a scenario involving computations over a massive dataset stored distributedly across multiple workers, which is at the core of distributed learning algorithms is provided. We propose Lagrange Coded Computing (LCC), a new framework to simultaneously provide (1) resiliency against stragglers that may prolong computations; (2) security against Byzantine (or malicious) workers that deliberately modify the computation for their benefit; and (3) (information-theoretic) privacy of the dataset amidst possible collusion of workers. LCC, which leverages the well-known Lagrange polynomial to create computation redundancy in a novel coded form across workers, can be applied to any computation scenario in which the function of interest is an arbitrary multivariate polynomial of the input dataset, hence covering many computations of interest in machine learning. LCC significantly generalizes prior works to go beyond linear computations. It also enables secure and private computing in distributed settings, improving the computation and communication efficiency of the state-of-the-art. Furthermore, we prove the optimality of LCC by showing that it achieves the optimal tradeoff between resiliency, security, and privacy, i.e., in terms of tolerating the maximum number of stragglers and adversaries, and providing data privacy against the maximum number of colluding workers. Finally, we show via experiments on Amazon EC2 that LCC speeds up the conventional uncoded implementation of distributed least-squares linear regression by up to 13:43×, and also achieves a 2:36×-12:65× speedup over the state-of-the-art straggler mitigation strategies.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A. An overview of the problem considered by the present invention, where the goal is to evaluate a not necessarily linear function ƒ on a given dataset X=(X₁, X₂, . . . , X_{K}) using N workers. Each worker applies f on a possibly coded version of the inputs (denoted by \tilde{X}ᵢ's). By carefully designing the coding strategy, the master can decode all the required results from a subset of workers, in the presence of stragglers (workers s₁, . . . , s_{S}) and Byzantine workers (workers m₁, . . . , m_{A}), while keeping the dataset private to colluding workers (workers c₁, . . . , c_{T}).

FIG. 1B. A schematic illustration of a neural network that can apply the LLC method of FIG. 1A.

FIG. 2. Modeling the Boolean function as a general polynomial can result in high degree of computations which makes the security threshold low by using LCC encoding. The main idea of our proposed approach is to model it as the concatenation of some low-degree polynomials and the threshold functions.

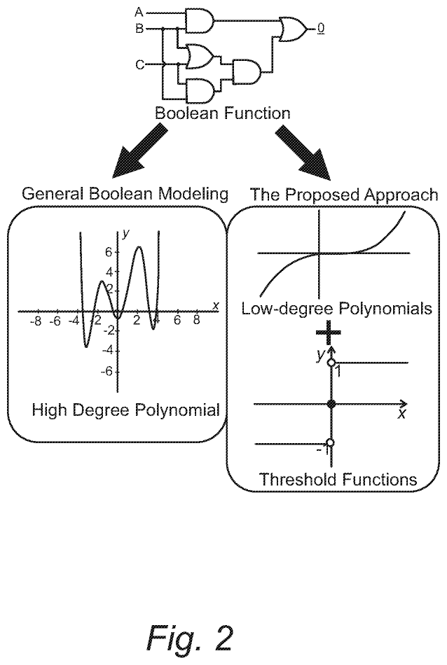

FIG. 3. Run-time comparison of LCC with other three schemes: conventional uncoded, GC, and MVM.

FIG. 4. The distributed training setup consisting of a master and N worker nodes. The master shares with each worker a coded version of the dataset (denoted by \tilde{X}ᵢ's) and the current estimate of the model parameters (denoted by \tilde{W}ᵢ^{(t)}'s) to guarantee the information-theoretic privacy of the dataset against any T colluding workers. Workers perform computations locally over the coded data and send the results back to the master.

FIG. 5. Performance gain of CodedPrivateML over the MPCbased scheme. The plot shows the total training time for accuracy 95:04% (25 iterations) for different number of workers N in Amazon EC2 Cloud Platform.

FIG. 6. Comparison of the accuracy of CodedPrivateML (demonstrated for Case 2 and N=40 workers) vs conventional logistic regression that uses the sigmoid function without quantization. Accuracy is measured with MNIST dataset restructured for binary classification problem between 3 and 7 (using 12396 samples for the training set and 2038 samples for the test set).

FIG. 7. Convergence of CodedPrivateML (demonstrated for Case 2 and N=40 workers) vs conventional logistic regression (using the sigmoid without polynomial approximation or quantization).

FIG. 8. Performance gain of CodedPrivateML over the MPCbased scheme with the smaller dataset. The plot shows the total training time for accuracy 95:04% (25 iterations) for different number of workers N in Amazon EC2 Cloud Platform.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless stated to the contrary, single letters (e.g., i, t, s, etc.) represent integer labels.

Throughout this application, where publications are referenced, the disclosures of these publications in their entireties are hereby incorporated by reference into this application to more fully describe the state of the art to which this invention pertains.

The term “server” refers to any computer, computing device, mobile phone, desktop computer, notebook computer or laptop computer, distributed system, blade, gateway, switch, processing device, or combination thereof adapted to perform the methods and functions set forth herein.

When a computing device is described as performing an action or method step, it is understood that the computing devices is operable to perform the action or method step typically by executing one or more line of source code. The actions or method steps can be encoded onto non-transitory memory (e.g., hard drives, optical drive, flash drives, and the like).

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The term “computing device” refers generally to any device that can perform at least one function, including communicating with another computing device.

Abbreviations:

“ANF” means algebraic normal form.

“DNF” coded Disjunctive normal form.

“LLC” means Lagrange Coded Computing.

“MDS” means Maximum Distance Separable.

“PTF” means polynomial threshold function.

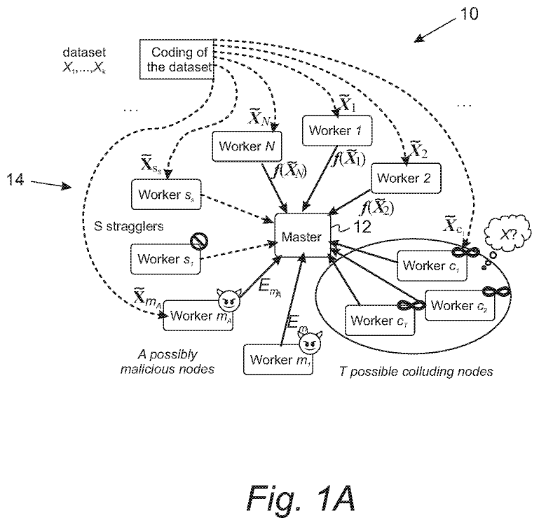

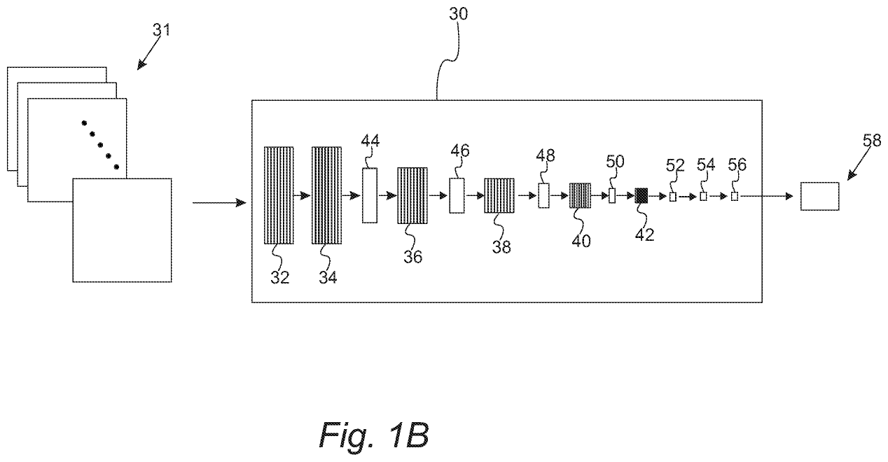

In an embodiment, a method for calculating a given multivariate polynomial f(Xᵢ) (i.e., a predetermined multivariate polynomial to be calculated) is provided. The multivariate polynomial f(Xᵢ) is to be calculated for every Xᵢ in a large dataset X=(X₁, X₂, . . . ; X_{K}) in accordance with an S-resilient, A-secure, and T-private scheme where K is an integer enumerating the number of elements in the dataset X, S is the number of stragglers to be tolerated, A is the number of adversaries to be tolerated, and T is the number of colluding workers that to be tolerated. Referring to FIG. 1, the method is implemented by a computer system 10 that includes a master computing device 12 and a plurality of worker computing devices 14 represented from 1 to N where N is the number of worker computing devices. The working computing devices 14 can include colluding workers c₁ to c_{T} where T is the number of colluding worker computing devices, malicious computing devices m₁ to m_{A} where A is the number of malicious computing devices, and straggler computing devices s₁ to sₛ where s is the number of straggler computing devices.

In general as depicted in FIG. 1A, the master computing device 12 is operable to execute steps of:
a) selecting K+T distinct elements;
b) transforming the K+T distinct elements with a Lagrange interpolation polynomial to determine input variables \tilde{X}ᵢ;
c) provide determine input variables \tilde{X}ᵢ to the plurality of worker computing devices to determine f(\tilde{X}ᵢ);
d) receive outputs f(\tilde{X}ᵢ) from the plurality of worker computing devices; and
e) determine coefficients of f(u(z)) from outputs f(\tilde{X}ᵢ).

In a variation, step a) is implemented by selecting any K+T distinct elements β₁, . . . , β_{K+T} from a field [symbol] where K is a predetermined integer; and step b) is implemented by finding a Lagrange interpolation polynomial u: [symbol] → [symbol] of degree at most K+T−1 such that u(βᵢ)=Xᵢ for any i∈[K], and u(βᵢ)=Zi for i∈{K+1, . . . , K+T}, where all Zi's are chosen uniformly at random from [symbol] , where [symbol] is a vector space of dimension M and determining input variables \tilde{X}ᵢ=u(αᵢ) for any integer (i.e., i∈[N]); Characteristically, deg(f(u(z)))≤deg(f)·(K+T−1), and N≥(K+T−1) deg(f)+S+2A+1 where N is the number of worker computing devices. In a refinement, input variables are encoded as

\tilde{X}ᵢ=u(αᵢ)=(Xₜ, . . . ,X_{K},Z_{K+1}, . . . ,Z_{K+T})·Uᵢ (1.2)

where U∈ [symbol] _{q}^{(K+T)×N} is encoding matrix

$${U}_{i , j} {=}^{Δ} {\sum }_{𝓁 ∈ [ K + T ] ∖ \{ i \}} \frac{{α}_{j} - {β}_{𝓁}}{β i - {β}_{𝓁}} ,$$

and Ui is its i'th column.

The Lagrange interpolation polynomial is typically described by the following formula:

$$u ( z ) {=}^{Δ} {\sum }_{j ∈ [ K ]} {X}_{j} \cdot {Π}_{k ∈ [ K + T ] \backslash \{ j \}} \frac{z - {β}_{k}}{β j - β k} + {\sum }_{j = K + 1}^{K + T} {Z}_{i} \cdot {Π}_{k ∈ [ K + T ] \backslash \{ j \} z} \frac{z - β k}{β j - β k} .$$

In a variation, the mater computing device determines the coefficients of f(u(z)) are determined by applying Reed-Solomon decoding.

Typically, no element of αᵢ is the same as any element of βⱼ. (i.e., {αᵢ}_{i∈[N]}∩{βⱼ}_{i∈[K]}=Ø.) unless T=0.

It should be appreciated that each working computing device is operable to perform certain steps. In particular, the worker computing devices are operable to execute steps of receiving input variables \tilde{X}ᵢ from the master computing device; calculating outputs f(\tilde{X}ᵢ); and sending outputs f(\tilde{X}ᵢ) to the master computing device.

It should be appreciated that the LCC method set forth herein can be applied to polynomial of degree 2 or higher. In a refinement, the LCC method set forth herein can be applied to polynomials having a degree of at least, in increasing order of preference, 2, 3, 4, 5, 6, 7, or 8. Although the LCC is not theoretical limited by an upbound of the degree of the polynomial, the LCC method set forth herein can be applied to polynomials having a degree of at most, in increasing order of preference, 100, 50, 40, 30, 20, 10, 15, or 10.

In a variation, the LCC method set forth herein can be applied to machine learning techniques such as neural networks, support vector machines, regression analysis, and the like. Machine learning techniques typically involve the computation of equations of the form:

W·x+b

where W is a matrix, x is an input vector, and b is an additive parameter (e.g., a bias). A deep network has many layers and relatively few neurons per layer. It can achieve high levels of abstraction using relatively few neurons. Each neuron activates based on the following rule:

y=ƒ(W·x+b)

where ƒ is the activation function; W is the weight matrix; x is the input vector; b is the bias; and Y is the output vector. For example, as depicted in FIG. 1B, convolutional neural network 30 receives one or more inputs 31. Convolutional neural network 30 can include convolution layers 32, 34, 36, 38, 40, and 42 as well as pooling layers 44, 46, 48, 50, and 52. The present invention is not limited by the number of convolution layer or pooling layers. FIG. 1B also depicts a network with global mean layer 54 and batch normalization layer 56. Neural network 30 outputs one or more outputs 58. The present variation is not limited to by number of convolutional layers, pooling layers, fully connected layers, normalization layers, and sublayers therein.

In a variation, the given polynomial that is calculated by the LCC method is the representation of a Boolean function, and in particular, the general representation of a Boolean function.

In another variation, the given polynomial a loss function for a machine learning training process, the training process including gradient computation on both coded (e.g., encoded with the LLC method) and uncoded data (e.g., not encoded with the LCC method) with model updates being decoded at the master. In a refinement, the loss function is a cross-entropy function. For example as set forth below in more detail, a training dataset can be represented by a matrix Xϵ{0, 1}^{m} with row i denoted by xᵢ. Model parameters (weights) wϵR^{d} can be obtained by minimizing the cross-entropy function,

$$C ( w ) = \frac{1}{m} {\sum }_{i = 1}^{m} ( - {y}_{i} log {\hat{y}}_{i} - ( 1 - {y}_{i} ) log ( 1 - {\hat{y}}_{i} ) ) \qquad ( 2.1 . )$$

where ŷᵢ=g(xᵢ·w)ϵ(0, 1) is the estimated probability of label i being equal to 1 and g(·) is a sigmoid function:

g(z)=1/(1+e^{-z}) (2.2)

In a further refinement, C(w) is solved via gradient descent, through an iterative process that updates the model parameters in the opposite direction of the gradient where the gradient for C(w) is given by

$$∇ C ( w ) = \frac{1}{m} {X}^{T} ( g ( X \times w ) - y )$$

and wherein the model parameters are updated as:

$${w}^{t + 1 )} = {w}^{t} - \frac{n}{m} {X}^{T} ( g ( X \times {w}^{⋀} ( ( t ) ) ) - y ) \qquad ( 2.3 )$$

where t is an integer label for each iteration, w^{(t)} holds the estimated parameters from iteration t, n is the learning rate, and function (g(·) operates element-wise over the vector given by X×w^{(t)}.

In another embodiment, a method for calculating a predetermined Boolean function ƒ(X) for every Xᵢ in a large input dataset X=(X₁, X₂, . . . ; X_{K}) to provide security against malicious worker computing devices is provided. The method implemented by a computer system comprising a master computing device and a plurality of worker computing devices. Characteristically, the master computing device operable to execute steps of representing the predetermined Boolean function ƒ(X) as a concatenation of low-degree polynomials and the threshold functions, the low-degree polynomials each having a degree less than a general polynomial representation of the Boolean function ƒ(X); encoding the input data to form a set of encoded input data; transmitting the set of encoded input data to the working computing devices which calculate partial output results; and receiving and decoding the partial output results to determine an output for the predetermined Boolean function. In a refinement, the master computing device applies MDS code to encode the datasets.

In a refinement, the Boolean function ƒ(X) is represented by determining the coded algebraic normal form (ANF) as follows:

$$f ( X ) = f ( X ) = {⊕}_{S ⊆ [ m ]} {μ}_{f} ( S ) {\prod }_{j ∈ S} X [ j ] \qquad ( 3.1 )$$

where X[j] is the j-bit of data X and μ_{f}(S)ϵ{0, 1} is the ANF coefficient of the corresponding monomial Ø_{jεS}X[j].

In another variation, the Boolean function ƒ(X) is represented by coded disjunctive normal form (DNF) as follows:

f=T₁∨T₂∨ . . . ∨T_{w}(f) (3.2)

where each clause Tᵢ has m literals which correspond to an input Yᵢ such that ƒ(Yᵢ)=1.

In another embodiment, a non-transitory computer-readable media encoding instructions for implementing the steps of the methods set forth above is provided. Examples of such non-transitory computer-readable media include, but are not limited to, disk memory devices, chip memory devices, programmable logic devices, and application-specific integrated circuits.

Additional details of the methods and systems of the present invention are set forth below and in Lagrange Coded Computing: Optimal Design for Resiliency, Security and Privacy, Qian Yu, Songze Li, Netanel Raviv, Seyed Mohammadreza Mousavi Kalan, Mahdi Soltanolkotabi, Salman Avestimehr arXiv:1806.00939v4 (2019); Coded Computing for Boolean Functions, Chien-Sheng Yang, A. Salman Avestimehr, arXiv:2001.08720v1 (2020); and CodedPrivateML: A Fast and Privacy-Preserving Framework for Distributed Machine Learning, Jinhyun So, Basak Guler, A. Salman Avestimehr, Payman Mohassel, arXiv:1902.00641v1 (2019); the entire disclosures of which are hereby incorporated by reference.

It should be appreciated that the specific examples set forth below can be applied to polynomials of any degree. For example, the methods in the specific examples can be applied to polynomials of degree of at least 2, 3, 4, 5, 6, 7, or 8 as set forth about.

1. Lagrange Coded Computing: Optimal Design for Resiliency, Security, and Privacy

1.1. Introduction

Specifically, as illustrated in FIG. 1, using a master-worker distributed computing architecture with N workers, the goal is to compute ƒ(Xi) for every Xᵢ in a large dataset X=(X₁, X₂, . . . , X_{K}), where ƒ is a given multivariate polynomial with degree deg ƒ. To do so, N coded versions of the input dataset, denoted by \tilde{X}₁, \tilde{X}₂, . . . , \tilde{X}_{N} are created, and the workers then compute ƒ over the coded data, as if no coding is taking place. For a given N and ƒ, we say that the tuple (S, A, T) is achievable if there exists an encoding and decoding scheme that can complete the computations in the presence of up to S stragglers, up to A adversarial workers, whilst keeping the dataset private against sets of up to T colluding workers.

Our main result is that by carefully encoding the dataset the proposed LCC achieves (S, A, T) if (K+T−1) deg ƒ+S+2A+1≤N. The significance of this result is that by one additional worker (i.e., increasing N by 1) LCC can increase the resiliency to stragglers by 1 or increase the robustness to malicious servers by ½, while maintaining the privacy constraint. Hence, this result essentially extends the well-known optimal scaling of error-correcting codes (i.e., adding one parity can provide robustness against one erasure or ½ error in optimal maximum distance separable codes) to the distributed secure computing paradigm.

We prove the optimality of LCC by showing that it achieves the optimal tradeoff between resiliency, security, and privacy. In other words, any computing scheme (under certain complexity constrains on the encoding and decoding designs) can achieve (S, A, T) if and only if (K+T−1) deg ƒ+S+2A+1≤N.¹ This result further extends the scaling law in coding theory to private computing, showing that any additional worker enables data privacy against 1/deg ƒ additional colluding workers.

Finally, we specialize our general theoretical guarantees for LCC in the context of least-squares linear regression, which is one of the elemental learning tasks, and demonstrate its performance gain by optimally suppressing stragglers. Leveraging the algebraic structure of gradient computations, several strategies have been developed recently to exploit data and gradient coding for straggler mitigation in the training process (see, e.g., [9]-[13]). We implement LCC for regression on Amazon EC2 clusters, and empirically compare its performance with the conventional uncoded approaches, and two state-of-the-art straggler mitigation schemes: gradient coding (GC) [10], [14]-[16] and matrix-vector multiplication (MVM) based approaches [9], [11]. Our experiment results demonstrate that compared with the uncoded scheme, LCC improves the run-time by 6.79×-13.43×. Compared with the GC scheme, LCC improves the run-time by 2.36×-4.29×. Compared with the MVM scheme, LCC improves the run-time by 1.01×-12.65×.

Related works. There has recently been a surge of interest on using coding theoretic approaches to alleviate key bottlenecks (e.g., stragglers, bandwidth, and security) in distributed machine learning applications (e.g., [10], [14], [15], [17]-[25]). As we discuss in more detail in Section 1.3A, the proposed LCC scheme significantly advances prior works in this area by 1) generalizing coded computing to arbitrary multivariate polynomial computations, which are of particular importance in learning applications; 2) extending the application of coded computing to secure and private computing; 3) reducing the computation/communication load in distributed computing (and distributed learning) by factors that scale with the problem size, without compromising security and privacy guarantees; and 4) enabling 2.36×-12.65× speedup over the state-of-the-art in distributed least-squares linear regression in cloud networks.

Secure multiparty computing (MPC) and secure/private Machine Learning (e.g., [26], [27]) are also extensively studied topics that address a problem setting similar to LCC. As we elaborate in Section 1.3A, compared with conventional methods in this area (e.g., the celebrated BGW scheme for secure/private MPC [26]), LCC achieves substantial reduction in the amount of randomness, storage overhead, and computation complexity.

1.2. Problem Formulation and Examples

We consider the problem of evaluating a multivariate polynomial ƒ: [symbol] → [symbol] over a dataset X=(X₁, . . . , X_{K}),² where [symbol] and [symbol] are vector spaces of dimensions M and L, respectively, over the field F. We assume a distributed computing environment with a master and N workers (FIG. 1), in which the goal is to compute

$${Y}_{1} {=}^{Δ} f ( {X}_{1} ) , … , {Y}_{K} {=}^{Δ} f ( {X}_{K} ) .$$

We denote the total degree³ of the polynomial ƒ by deg ƒ.

In this setting each worker has already stored a fraction of the dataset prior to computation, in a possibly coded manner. Specifically, for i∈[N] (where

$$[ N ] {=}^{Δ} \{ 1 , … , N \} ) ,$$

worker i stores \tilde{X}ᵢ, gᵢ(X₁, . . . , X_{K}), where gᵢ is a (possibly random) function, referred to as the encoding function of that worker. We restrict our attention to linear encoding schemes⁴, which guarantee low encoding complexity and simple implementation. Each worker i∈[N] computes \tilde{Y}ᵢ, ƒ(\tilde{X}ᵢ) and returns the result to the master. The master waits for a subset of fastest workers and then decodes Y₁, . . . , Y_{K}. This procedure must satisfy several additional requirements:
Resiliency, i.e., robustness against stragglers. Formally, the master must be able to obtain the correct values of Y₁, . . . , Y_{K} even if up to S workers fail to respond (or respond after the master executes the decoding algorithm), where S is the resiliency parameter of the system. A scheme that guarantees resiliency against S stragglers is called S-resilient.
Security, i.e., robustness against adversaries. That is, the master must be able to obtain correct values of Y₁, . . . , Y_{K} even if up to A workers return arbitrarily erroneous results, where A is the security parameter of the system. A scheme that guarantees security against A adversaries is called A-secure.
Privacy, i.e., the workers must remain oblivious to the content of the dataset, even if up to T of them collude, where T is the privacy parameter of the system. Formally, for every [symbol] ⊆[N] of size at most T, we must have I(X; [symbol] )=0, where I is mutual information, [symbol] represents the collection of the encoded dataset stored at the workers in [symbol] , and X is seen as chosen uniformly at random.⁵ A scheme which guarantees privacy against T colluding workers is called T-private.⁶

More concretely, given any subset of workers that return the computing results (denoted by K), the master computes (Ŷ₁, . . . , Ŷ_{K})=h_{K}({\tilde{Y}ᵢ}_{i∈K}), where each h_{K} is a deterministic function (or is random but independent of both the encoding functions and input data). We refer to the hK's as decoding functions.⁷ We say that a scheme is S-resilient, A-secure, and T-private if the master always returns the correct results (i.e., each Yᵢ=\tilde{Y}ᵢ), and all above requirements are satisfied. Given the above framework, we aim to characterize the region for (S, A, T), such that an S-resilient, A-secure, and T-private scheme can be found, given parameters N, K, and function ƒ, for any sufficiently large field [symbol] . This framework encapsulates many computation tasks of interest, which we highlight as follows.

Linear computation. Consider a scenario where the goal is to compute A\vec{b} for some dataset A={Aᵢ}ᵢ₌₁^{K} and vector \vec{b}, which naturally arises in many machine learning algorithms, such as each iteration of linear regression. Our formulation covers this by letting V be the space of matrices of certain dimensions over [symbol] , [symbol] the space of vectors of a certain length over [symbol] , Xᵢ be Aᵢ, and ƒ(Xᵢ)=Xᵢ·\vec{b} for all i∈[K]. Coded computing for such linear computations has also been studied in [9], [12], [21], [28], [29].

Bilinear computation. Another computation task of interest is to evaluate element-wise products {Aᵢ·Bᵢ}ᵢ₌₁^{K} of two lists of matrices {Aᵢ}ᵢ₌₁^{K} and {Bᵢ}ᵢ₌₁^{K}. This is the key building block for various algorithms, such as fast distributed matrix multiplication [30]. Our formulation covers this by letting [symbol] the space of pairs of two matrices of certain dimensions, [symbol] be the space of matrices of dimension which equals that of the product of the pairs of matrices, Xᵢ=(Aᵢ, Bᵢ), and ƒ(Xᵢ)=Aᵢ·Bᵢ for all i∈[K].

General tensor algebra. Beyond bilinear operations, distributed computations of multivariate polynomials of larger degree, such as general tensor algebraic functions (i.e. functions composed of inner products, outer products, and tensor contractions) [31], also arise in practice. A specific example is to compute the coordinate transformation of a third-order tensor field at K locations, where given a list of matrices {Q(i)}ᵢ₌₁^{K} and a list of third-order tensors {T(i)}ᵢ₌₁^{K} with matching dimension on each index, the goal is to compute another list of tensors, denoted by {T′(i)}ᵢ₌₁^{K}, of which each entry is defined as

$${T}_{{j}^{′} {k}^{′} {𝓁}^{′}}^{{′}^{( i )}} {=}^{Δ} {\sum }_{j , k , 𝓁} {T}_{jk 𝓁}^{{′}^{( i )}} {Q}_{{jj}^{′}}^{( i )} {Q}_{{kk}^{′}}^{( i )} {Q}_{{𝓁𝓁}^{′}}^{( i )} .$$

Our formulation covers all functions within this class by letting [symbol] be the space of input tensors, [symbol] be the space of output tensors, Xᵢ be the inputs, and ƒ be the tensor function. These computations are not studied by state-of-the-art coded computing frameworks.

Gradient computation. Another general class of functions arises from gradient decent algorithms and their variants, which are the workhorse of today's learning tasks [32]. The computation task for this class of functions is to consider one iteration of the gradient decent algorithm, and to evaluate the gradient of the empirical risk

$$∇ {L}_{S} ( h ) {=}^{Δ} {avg}_{z ∈ S} ∇ {𝓁}_{h} ( z ) ,$$

given a hypothesis h: [symbol] ^{d}→ [symbol] , a respective loss function [symbol] ₕ: [symbol] ^{d+1}→ [symbol] , and a training set S⊆R^{d+1} where d is the number of features. In practice, this computation is carried out by partitioning S into K subsets {Si}ᵢ₌₁^{K} of equal sizes, evaluating the partial gradients {∇L_{S}_{ᵢ}(h)}ᵢ₌₁^{K} distributedly, and computing the final result using ∇L_{S}(h)=avg_{i∈[K]} ∇L_{Si}(h). We present a specific example of applying this computing model to least-squares regression problems in Section 1.4.

1.3. Main Results and Prior Works

We now state our main results and discuss their connections with prior works. Our first theorem characterizes the region for (S, A, T) that LCC achieves (i.e., the set of all feasible S-resilient, A-secure, and [symbol] -private schemes via LCC as defined in the previous section).

Theorem 1. Given a number of workers N and a dataset X=(X₁, . . . , X_{K}), LCC provides an S-resilient, A-secure, and T-private scheme for computing {f(Xi)} K i=1 for any polynomial f, as long as

(K+T−1)degƒ+S+2A+1≤N (1.1)

Remark 1. To prove Theorem 1, we formally present LCC in Section 1.4, which achieves the stated resiliency, security, and privacy. The key idea is to encode the input dataset using the well-known Lagrange polynomial. In particular, encoding functions (i.e., gᵢ's) in LCC amount to evaluations of a Lagrange polynomial of degree K−1 at N distinct points. Hence, computations at the workers amount to evaluations of a composition of that polynomial with the desired function ƒ. Therefore, inequality (1) may simply be seen as the number of evaluations that are necessary and sufficient in order to interpolate the composed polynomial, which is later evaluated at a certain point to finalize the computation. LCC also has a number of additional properties of interest. First, the proposed encoding is identical for all computations ƒ, which allows pre-encoding of the data without knowing the identity of the computing task (i.e., universality). Second, decoding and encoding rely on polynomial interpolation and evaluation, and hence efficient off-the-shelf subroutines can be used.⁸

Remark 2. Besides the coding approach presented to achieve Theorem 1, a variation of LCC can be used to achieve any (S, A, T) as long as K(S+2A+deg ƒ·T+1)≤N. This scheme (presented in Appendix D) achieves an improved region when N<Kdegƒ−1 and T=0, where it recovers the uncoded repetition scheme. For brevity, we refer the better of these two scheme as LCC when presenting optimality results (i.e., Theorem 2).

Remark 3. Note that LHS of inequality (1) is independent of the number of workers N, hence the key property of LCC is that adding 1 worker can increase its resilience to stragglers by 1 or its security to malicious servers by ½, while keeping the privacy constraint T the same. Note that using an uncoded replication based approach, to increase the resiliency to stragglers by 1, one needs to essentially repeat each computation once more (i.e., requiring K more machines as opposed to 1 machine in LCC). This result essentially extends the well-known optimal scaling of error-correcting codes (i.e., adding one parity can provide robustness against one erasure or ½ error in optimal maximum distance separable codes) to the distributed computing paradigm.

Our next theorem demonstrates the optimality of LCC.

Theorem 2. LCC achieves the optimal trade-off between resiliency, security, and privacy (i.e., achieving the largest region of (S, A, T)) for any multilinear function ƒ among all computing schemes that uses linear encoding, for all problem scenarios. Moreover, when focusing on the case where no security constraint is imposed, LCC is optimal for any polynomial f among all schemes with additional constraints of linear decoding and sufficiently large (or zero) characteristic of F.

Remark 4. Theorem 2 is proved in Section 1.5. The main proof idea is to show that any computing strategy that outperforms LCC would violate the decodability requirement, by finding two instances of the computation process where the same intermediate computing results correspond to different output values.

Remark 5. In addition to the result we show in Theorem 2, we can also prove that LCC achieves optimality in terms of the amount of randomness used in data encoding. Specifically, we show in Appendix I that LCC requires injecting the minimum amount of randomness, among all computing schemes that universally achieve the same resiliency-security-privacy tradeoff for all linear functions f. We conclude this section by discussing several lines of related work in the literature and contrasting them with LCC.

A. LCC Vs. Prior Works

The study of coding theoretic techniques for accelerating large scale distributed tasks (a.k.a. coded computing) was initiated in [17], [18], [20]. Following works focused largely on matrix-vector and matrix-matrix multiplication (e.g., [21]-[23], [30]), gradient computation in gradient descent algorithms (e.g., [10], [13], [15]), communication reduction via coding (e.g., [33]-[36]), and secure and private computing (e.g., [24], [25]).

LCC recovers several previously studied results as special cases. For example, setting ƒ to be the identity function and [symbol] = [symbol] reduces to the well-studied case of distributed storage, in which Theorem 1 is well known (e.g., the Singleton bound [37, Thin. 4.1]). Further, as previously mentioned, f can correspond to matrix-vector and matrix-matrix multiplication, in which the special cases of Theorem 1 are known as well [9], [30].

More importantly, LCC improves and generalizes these works on coded computing in a few aspects: Generality-LCC significantly generalizes prior works to go beyond linear and bilinear computations that have so far been the main focus in this area, and can be applied to arbitrary multivariate polynomial computations that arise in machine learning applications. In fact, many specific computations considered in the past can be seen as special cases of polynomial computation. This includes matrix-vector multiplication, matrix-matrix multiplication, and gradient computation whenever the loss function at hand is a polynomial, or is approximated by one. Universality—once the data has been coded, any polynomial up to a certain degree can be computed distributedly via LCC. In other words, data encoding of LCC can be universally used for any polynomial computation. This is in stark contrast to previous task specific coding techniques in the literature. Furthermore, workers apply the same computation as if no coding took place; a feature that reduces computational costs, and prevents ordinary servers from carrying the burden of outliers. Security and Privacy—other than a handful of works discussed above, straggler mitigation (i.e., resiliency) has been the primary focus of the coded computing literature. This work extends the application of coded computing to secure and private computing for general polynomial computations.

Providing security and privacy for multiparty computing (MPC) and Machine Learning systems is an extensively studied topic which addresses a problem setting similar to LCC. To illustrate the significant role of LCC in secure and private computing, let us consider the celebrated BGW MPC scheme [26].⁹

Given inputs {Xi}ᵢ₌₁^{K}, BGW first uses Shamir's scheme [38] to encode the dataset in a privacy-preserving manner as Pᵢ(z)=Xᵢ+Z_{i,1}z+ . . . +Z_{i,T} z^{T} for every i∈[K], where Z_{i,j}'s are i.i.d uniformly random variables and T is the number of colluding workers that should be tolerated. The key distinction between the data encoding of BGW scheme and LCC is that we instead use Lagrange polynomials to encode the data. This results in significant reduction in the amount of randomness needed in data encoding (BGW needs KT z_{i,j}'s while as we describe in the next section, LCC only needs T amount of randomness).

The BGW scheme will then store {Pᵢ( [symbol] )}_{i∈[K]} to worker [symbol] for every [symbol] ∈[N], given some distinct values α₁, . . . , α_{N}. The computation is then carried out by evaluating f over all stored coded data at the nodes. In the LCC scheme, on the other hand, each worker [symbol] only needs to store one encoded data (\tilde{X}) and compute ƒ(\tilde{X}). This gives rise to the second key advantage of LCC, which is a factor of K in storage overhead and computation complexity at each worker.

After computation each worker [symbol] in the BGW scheme has essentially evaluated the polynomials {ƒ(Pi(z))}_{I=1}^{K} at Z= [symbol] , whose degree is at most deg(ƒ)·T. Hence, if no straggler or adversary appears (i.e, S=A=0), the master can recover all required results ƒ(Pᵢ(0))'s, through polynomial interpolation, as long as N≥deg(ƒ)·T+1 workers participated in the computation 10. Note that under the same condition, LCC scheme requires N≥deg(ƒ)−(K+T−1)+1 number of workers, which is larger than that of the BGW scheme.

Hence, in overall comparison with the BGW scheme, LCC results in a factor of K reduction in the amount of randomness, storage overhead, and computation complexity, while requiring more workers to guarantee the same level of privacy. This is summarized in Table 1.1.

TABLE 1.1
Comparison between BGW based designs and LCC. The
computational complexity is normalized by that of evaluating ƒ;
randomness, which refers to the number of random entries
used in encoding functions, is normalized by the length of Xᵢ.

| | BGW | LCC |
|---|---|---|
| Complexity | K | 1 |
| per worker | | |
| Frac. Data | 1 | 1/K |
| per worker | | |
| Randomness | KT | T |
| Min. num. | def(ƒ)(T + 1) | def(ƒ)(K + T − 1) + 1 |
| of workers | | |

Recently, [24] has also combined ideas from the BGW scheme and [22] to form polynomial sharing, a private coded computation scheme for arbitrary matrix polynomials. However, polynomial sharing inherits the undesired BGW property of performing a communication round for every bilinear operation in the polynomial; a feature that drastically increases communication overhead, and is circumvented by the one-shot approach of LCC. DRACO [25] is also recently proposed as a secure computation scheme for gradients. Yet, DRACO employs a blackbox approach, i.e., the resulting gradients are encoded rather than the data itself, and the inherent algebraic structure of the gradients is ignored. For this approach, [25] shows that a 2A+1 multiplicative factor of redundant computations is necessary. In LCC however, the blackbox approach is disregarded in favor of an algebraic one, and consequently, a 2A additive factor suffices.

LCC has also been recently applied to several applications in which security and privacy in computations are critical. For example, in [39], LCC has been applied to enable a scalable and secure approach to sharding in blockchain systems. Also, in [40], a privacy-preserving approach for machine learning has been developed that leverages LCC to provides substantial speedups over cyrptographic approaches that relay on MPC.

1.4. Lagrange Coded Computing

In this Section we prove Theorem 1 by presenting LCC and characterizing the region for (S, A, T) that it achieves. 12 We start with an example to illustrate the key components of LCC. A. Illustrating Example Consider the function ƒ(Xᵢ)=Xᵢ², where input Xᵢ's are \sqrt{M}×\sqrt{M} square matrices for some square integer M. We demonstrate LCC in the scenario where the input data X is partitioned into K=2 batches X₁ and X₂, and the computing system has N=8 workers. In addition, the suggested scheme is 1-resilient, 1-secure, and 1-private (i.e., achieves (S, A, T)=(1, 1, 1)).

The gist of LCC is picking a uniformly random matrix Z, and encoding (X₁, X₂, Z) using a Lagrange interpolation polynomial:¹³

$$u ( z ) {=}^{Δ} {X}_{1} \cdot \frac{( z - 2 ) ( z - 3 )}{( 1 - 2 ) ( 1 - 3 )} + {X}_{2} \cdot \frac{( z - 1 ) ( z - 3 )}{( 2 - 1 ) ( 2 - 3 )} + Z \cdot \frac{( z - 1 ) ( z - 2 )}{( 3 - 1 ) ( 3 - 2 )} .$$

We then fix distinct {αᵢ}ᵢ₌₁⁸ in [symbol] such that {αᵢ}ᵢ₌₁⁸∩[2]=Ø, and let workers 1, . . . , 8 store u(α₁), . . . , u(α₈).

First, note that for every j∈[8], worker j sees \tilde{X}ⱼ, a linear combination of X₁ and X₂ that is masked by addition of λ·Z for some nonzero λ∈ [symbol] ₁₁; since Z is uniformly random, this guarantees perfect privacy for T=1. Next, note that worker j computes ƒ(\tilde{X}ⱼ)=ƒ(u(αⱼ)), which is an evaluation of the composition polynomial ƒ(u(z)), whose degree is at most 4, at αⱼ.

Normally, a polynomial of degree 4 can be interpolated from 5 evaluations at distinct points. However, the presence of A=1 adversary and S=1 straggler requires the master to employ a Reed-Solomon decoder, and have three additional evaluations at distinct points (in general, two additional evaluations for every adversary and one for every straggler). Finally, after decoding polynomial ƒ(u(z)), the master can obtain ƒ(X₁) and ƒ(X₂) by evaluating it at z=1 and z=2.

B. General Description

Similar to Subsection 1.4A, we select any K+T distinct elements, β₁, . . . , β_{K+T} from [symbol] , and find a polynomial u: [symbol] → [symbol] of degree at most K+T−1 such that u(βᵢ)=Xᵢ for any i∈[K], and u(βᵢ)=Zi for i∈{K+1, . . . , K+T}, where all Zi's are chosen uniformly at random from [symbol] . This is simply accomplished by letting u be the Lagrange interpolation polynomial

$$u ( z ) {=}^{Δ} {\sum }_{j ∈ [ K ]} {X}_{j} \cdot {\prod }_{k ∈ [ K + T ] ∖ \{ j \}} \frac{z - {β}_{k}}{β j - β k} + {\sum }_{{ }^{j = K + 1}}^{K + T} {Z}_{i} \cdot {\prod }_{k ∈ [ K + T ] ∖ \{ j \} z} \frac{z - β k}{β j - β k} .$$

We then select N distinct elements {αᵢ}_{i∈[N]} from [symbol] such that {αᵢ}_{i∈[N]}∩{βⱼ}_{i∈[K]}=Ø (this requirement is alleviated if T=0), and let \tilde{X}ᵢ=u(αᵢ) for any i∈[N]. That is, the input variables are encoded as

\tilde{X}ᵢ=u(αᵢ)=(X₁, . . . ,X_{K},Z_{K+1}, . . . ,Z_{K+T})·U (1.2)

where U∈ [symbol] _{q}^{(K+T)×N} is the encoding matrix

$${U}_{i , j} {=}^{Δ} {\sum }_{𝓁 ∈ [ K + T ] ∖ \{ i \}} \frac{{α}_{j} - {β}_{𝓁}}{β i - {β}_{𝓁}} ,$$

and Uᵢ is its i'th column.14

Following the above encoding, each worker i applies ƒ on \tilde{X}ᵢ and sends the result back to the master. Hence, the master obtains N−S evaluations, at most A of which are incorrect, of the polynomial ƒ(u(z)). Since deg(ƒ(u(z)))≤deg(ƒ)·(K+T−1), and N≥(K+T−1) deg(ƒ)+S+2A+1, the master can obtain all coefficients of ƒ(u(z)) by applying Reed-Solomon decoding. Having this polynomial, the master evaluates it at βᵢ for every i∈[K] to obtain ƒ(u(βᵢ))=ƒ(Xᵢ), and hence we have shown that the above scheme is S-resilient and A-secure.

As for the T-privacy guarantee of the above scheme, our proof relies on the fact that the bottom T×N submatrix U^{bottom} of U is an MDS matrix (i.e., every T×T submatrix of U^{bottom} is invertible, see Lemma 2 in the supplementary material). Hence, for a colluding set of workers [symbol] ⊆[N] of size T, their encoded data [symbol] satisfies [symbol] =X [symbol] +Z [symbol] , where

$$Z {=}^{Δ} ( {Z}_{K + 1} , … , {Z}_{K + T} ) ,$$

and [symbol] ∈ [symbol] _{q}^{K×T}, [symbol] ∈ [symbol] _{q}^{T×T} are the top and bottom submatrices which correspond to the columns in U that are indexed by [symbol] . Now, the fact that any [symbol] is invertible implies that the random padding added for these colluding workers is uniformly random, which completely masks the coded data X [symbol] . This directly guarantees T-privacy.

1.5. Optimality of LCC

In this section, we provide a layout for the proof of optimality for LCC (i.e., Theorem 2). Formally, we define that a linear encoding function is one that computes a linear combination of the input variables (and possibly a list of independent uniformly random keys when privacy is taken into account15); while a linear decoding function computes a linear combination of workers' output. We essentially need to prove that (a) given any multilinear f, any linear encoding scheme that achieves any (S, A, T) requires at least N≥(K+T−1) deg ƒ+S+2A+1 workers when T>0 or N≥Kdeg ƒ−1, and N≥K(S+2A+1) workers in other cases; (b) for a general polynomial ƒ, any scheme that uses linear encoding and decoding requires at least the same number of workers, if the characteristic of [symbol] is 0 or greater than deg ƒ.

The proof rely on the following key lemma, which characterizes the recovery threshold of any encoding scheme, defined as the minimum number of workers that the master needs to wait to guarantee decodability.

Lemma 1. Given any multilinear f, the recovery threshold of any valid linear encoding scheme, denoted by R, satisfies

$$R \geq {R}_{L C C} ( N , K , f ) {=}^{Δ} min \{ ( K - 1 ) deg f + 1 , N - b N / K c + 1 \} . \qquad ( 1.3 )$$

Moreover, if the encoding scheme is T private, we have R≥RLCC(N, K, f)+T·deg f.

The proof of Lemma 1 can be found in Appendix E, by constructing instances of the computation process for any assumed scheme that achieves smaller recovery threshold, and proving that such scheme fails to achieve decodability in these instances. Intuitively, note that the recovery threshold is exactly the difference between N and the number of stragglers that can be tolerated, inequality (3) in fact proves that LCC (described in Section 1.4 and Appendix G) achieves the optimum resiliency, as it exactly achieves the stated recovery threshold. Similarly, one can verify that Lemma 1 essentially states that LCC achieves the optimal tradeoff between resiliency and privacy.

Assuming the correctness of Lemma 1, the two parts of Theorem 2 can be proved as follows. To prove part (a) of the converses, we need to extend Lemma 1 to also take adversaries into account. This is achieved by using an extended concept of Hamming distance, defined in [30] for coded computing. Part (b) requires generalizing Lemma 1 to arbitrary polynomial functions, which is proved by showing that for any f that achieves any (S, T) pair, there exists a multilinear function with the same degree for which a computation scheme can be found to achieves the same requirement. The detailed proofs can be found in Appendices F and G respectively.

1.6. Application to Linear Regression and Experiments on AWS EC2

In this section we demonstrate a practical application of LCC in accelerating distributed linear regression, whose gradient computation is a quadratic function of the input dataset, hence matching well the LCC framework. We also experimentally demonstrate its performance gain over state of the arts via experiments on AWS EC2 clusters.

Applying LCC for linear regression. Given a feature matrix X∈ [symbol] ^{m×d} containing m data points of d features, and a label vector y∈ [symbol] ^{m}, a linear regression problem aims to find the weight vector w∈ [symbol] ^{d} that minimizes the loss ∥Xw−y∥². Gradient descent (GD) solves this problem by iteratively moving the weight along the negative gradient direction, which is in iteration-t computed as 2X^{T}(Xw^{(t)}−y).

To run GD distributedly over a system comprising a master node and n worker nodes, we first partition X=[X₁ . . . Xₙ]^{T} into n sub-matrices. Each worker stores r coded sub-matrices generated from linearly combining Xⱼs, for some parameter 1≤r≤n. Given the current weight w, each worker performs computation using its local storage, and sends the result to the master. Master recovers X^{T}Xw=Σⱼ₌₁ⁿXⱼXⱼ^{T}w using the results from a subset of fastest workers.¹⁶ To measure performance of any linear regression scheme, we consider the metric recovery threshold (denoted by R), defined as the minimum number of workers the master needs to wait for, to guarantee decodability (i.e., tolerating the remaining stragglers).

We cast this gradient computation to the computing model in Section 1.2, by grouping the sub-matrices into

$$K = ⌈ \frac{n}{r} ⌉$$

blocks such that X=[X̅₁ . . . X̅_{K}]^{T}. Then computing XX^{T}w reduces to computing the sum of a degree-2 polynomial f(X̅_{K})=X̅_{K}X̅ₖ^{T}w, evaluated over X⁻1, . . . , X⁻K. Now, we can use LCC to decide on the coded storage as in (2), and achieve a recovery threshold of

$$RLCC = 2 ( K - 1 ) + 1 = 2 ⌈ \frac{n}{r} ⌉ - 1$$

### (Theorem 1).¹⁷

Comparisons with state of the arts. The conventional uncoded scheme picks r=1, and has each worker j compute XⱼXⱼ^{T}w. Master needs result from each work, yielding a recovery threshold of R_{uncoded}=n. By redundantly storing/processing r>1 uncoded sub-matrices at each worker, the “gradient coding” (GC) methods [10], [14], [15] code across partial gradients computed from uncoded data, and reduce the recovery threshold to R_{GC}=n−r+1. An alternative “matrix-vector multiplication based” (MVM) approach [17] requires two rounds of computation. In the first round, an intermediate vector z=Xw is computed distributedly, which is re-distributed to the workers in the second round for them to collaboratively compute X>z. Each worker stores coded data generated using MDS codes from X and X^{T} respectively. MVM achieves a recovery threshold of

$$RMVM = ⌈ \frac{2 n}{r} ⌉$$

in each round, when the storage is evenly split between rounds.

Compared with GC, LCC codes directly on data, and reduces the recovery threshold by about r/2 times. While the amount of computation and communication at each worker is the same for GC and LCC, LCC is expected to finish much faster due to its much smaller recovery threshold. Compared with MVM, LCC achieves a smaller recovery threshold than that in each round of MVM (assuming even storage split). While each MVM worker performs less computation in each iteration, it sends two vectors whose sizes are respectively proportional to m and d, whereas each LCC worker only sends one dimension-d vector.

We run linear regression on AWS EC2 using Nesterov's accelerated gradient descent, where all nodes are implemented on t2.micro instances. We generate synthetic datasets of m data points, by 1) randomly sampling a true weight w*, 2) randomly sampling each input xi of d features and computing its output yi=x>i w*. For each dataset, we run GD for 100 iterations over n=40 workers. We consider different dimensions of input matrix X as listed in the following scenarios.
Scenario 1 & 2: (m, d)=(8000, 7000).
Scenario 3: (m, d)=(160000, 500).

We let the system run with naturally occurring stragglers in scenario 1. To mimic the effect of slow/failed workers, we artificially introduce stragglers in scenarios 2 and 3, by imposing a 0.5 seconds delay on each worker with probability 5% in each iteration.

To implement LCC, we set the i parameters to 1, . . . , n r, and the αᵢ parameters to 0, . . . , n−1. To avoid numerical instability due to large entries of the decoding matrix, we can embed input data into a large finite field, and apply LCC in it with exact computations. However in all of our experiments the gradients are calculated correctly without carrying out this step.

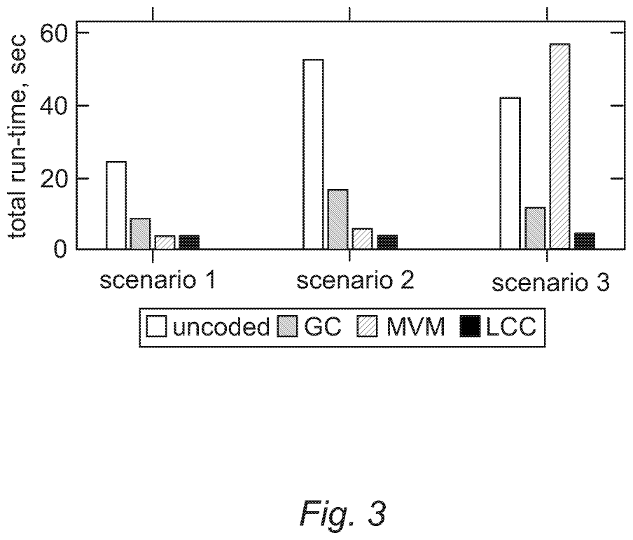

Results. For GC and LCC, we optimize the total run-time over r subject to local memory size. For MVM, we further optimize the run-time over the storage assigned between two rounds of matrix-vector multiplications. We plot the measured run-times in FIG. 3, and list the detailed breakdowns of all scenarios in Appendix K.

We draw the following conclusions from experiments.
LCC achieves the least run-time in all scenarios. In particular, LCC speeds up the uncoded scheme by 6.79×-13.43×, the GC scheme by 2.36-4.29×, and the MVM scheme by 1.01-12.65×.
In scenarios 1 & 2 where the number of inputs m is close to the number of features d, LCC achieves a similar performance as MVM. However, when we have much more data points in scenario 3, LCC finishes substantially faster than MVM by as much as 12.65×. The main reason for this subpar performance is that MVM requires large amounts of data transfer from workers to the master in the first round and from master to workers in the second round (both are proportional to m). However, the amount of communication from each worker or master is proportional to d for all other schemes, which is much smaller than min scenario 3.

1.7 Supplemental Material.

A. Algorithmic Illustration of LCC
I) Algorithmic A1 LCC Encoding (Precomputation)

| 1: | procedure ENCODE(X₁ . . . , X₂, . . . , X_{K}, | [symbol] Encode inputs variables according to |
|---|---|---|
| | T) | LCC |
| 2: | generate uniform random variables Z_{K+1}, . . . , Z_{K+T} | |
| 3: | $joint compute {\tilde{X}}_{i} ← {\sum }_{j ∈ [ K ]} {X}_{j} \cdot {\prod }_{k ∈ [ K + T ] \backslash [ j ]} \frac{{α}_{i} - {β}_{k}}{{β}_{j} - {β}_{k}} + {\sum }_{j = K + 1}^{K + T} {Z}_{j} \cdot {\prod }_{k ∈ [ K + T ] \backslash [ j ]} \frac{{α}_{i} - {β}_{k}}{{β}_{j} - {β}_{k}}$ $for i = 1 , 2 , … , N$ | |
| | using fast polynomial interpolation | |
| 4: | return \tilde{X}₁, . . . , \tilde{X}_{N} | [symbol] The coded variable assigned to worker |
| 5: | end procedure | i is \tilde{X}ᵢ |

Algorithm A2 Computation Stage

| | | |
|---|---|---|
| 1: | procedure WORKERCOMPUTATION(\tilde{X}) | [symbol] Each worker i takes \tilde{X}ᵢ as input |
| 2: | return f(\tilde{X}) | [symbol] Computer as if no coding is taking place |

| 3: | end procedure | |
|---|---|---|
| 1: | procedure DECODE(S, A) | [symbol] Executed by master |

| 2: | wait for a subset of fastest N − S workers | |
|---|---|---|
| 3: | [symbol] ← identifies of the fastest workers | |
| 4: | [symbol] ← results from the fastest workers | |
| 5: | recover Y₁ . . . , Y_{K} from [symbol] using fast interpolation or Reed-Solomon decoding | [symbol] See Appendix B |

| | |
|---|---|
| 6: | return Y₁ . . . , Y_{K} |
| 7: | end procedure |

β1, . . . , β_{K+T} and α₁, . . . , αₙ are global constants in F, satisfying18

1) βᵢ's are distinct,

2) _i's are distinct,

3) {αᵢ}_{i∈[N]}∩{βᵢ}_{j∈[K]}=Ø (this requirement is alleviated if T=0).

B. Coding Complexities of LCC

By exploiting the algebraic structure of LCC, we can find efficient encoding and decoding algorithms with almost linear computational complexities. The encoding of LCC can be viewed as interpolating degree K+T−1 polynomials, and then evaluating them at N points. It is known that both operations only require almost linear complexities: interpolating a polynomial of degree k has a complexity of O(k log² k log log k), and evaluating it at any k points requires the same [41]. Hence, the total encoding complexity of LCC is at most O(N log²(K+T) log log(K+T) dimV), which is almost linear to the output size of the encoder O(N dim [symbol] ).

Similarly, when no security requirement is imposed on the system (i.e., A=0), the decoding of LCC can also be completed using polynomial interpolation and evaluation. An almost linear complexity O(R log² R log log R dim [symbol] ) can be achieved, where R denotes the recovery threshold.

A less trivial case is to consider the decoding algorithm when A>0, where the goal is essentially to interpolate a polynomial with at most A erroneous input evaluations, or decoding a Reed-Solomon code. An almost linear time complexity can be achieved using additional techniques developed in [42]-[45]. Specifically, the following 2A-1 syndrome variables can be computed with a complexity of O((N−S) log²(N−S) log log(N−S) dim [symbol] ) using fast algorithms for polynomial evaluation and for transposed-Vandermonde-matrix multiplication [46].

$${S}_{k} {=}^{Δ} {\sum }_{i ∈ 𝒩}^{ } \frac{{Y}_{i} {α}_{i}^{k}}{{\prod }_{j ∈ 𝒩 \backslash \{ i \}}^{ } ( {α}_{i} - {α}_{j} )} ∀ k ∈ \{ 0 , 1 , … , 2 A - 1 \} . \qquad ( 4 )$$

According to [42], [43], the location of the errors (i.e., the identities of adversaries in LCC decoding) can be determined given these syndrome variables by computing its rational function approximation. Almost linear time algorithms for this operation are provided in [44], [45], which only requires a complexity of O(A log² A log log A dim [symbol] ). After identifying the adversaries, the final results can be computed similar to the A=0 case. This approach achieves a total decoding complexity of O((N−S) log²(N−S) log log(N−S) dim [symbol] ), which is almost linear with respect to the input size of the decoder O((N−S) dim [symbol] ).

Finally, note that the adversaries can only affect a fixed subset of A workers' results for all entries. This decoding time can be further reduced by computing the final outputs entry-wise: for each iteration, ignore computing results from adversaries identified in earlier steps, and proceed decoding with the rest of the results.

C. The MDS Property of U^{bottom}

Lemma 2. The matrix U^{bottom} is an MDS matrix.

Proof. First, let V= [symbol] ^{T×N} be

$${V}_{i , j} = {\prod }_{𝓁 ∈ [ T ] \backslash \{ i \}}^{ } \frac{{α}_{j} - {β}_{𝓁 + K}}{{β}_{i + K} - {β}_{𝓁 + K}} .$$

It follows from the resiliency property of LCC that by having (\tilde{X}₁, . . . , \tilde{X}_{N})=(X₁, . . . , X_{T})·V, the master can obtain the values of X₁, . . . , X_{T} from any T of the \tilde{X}ᵢ's. This is one of the alternative definitions for an MDS code, and hence, V is an MDS matrix.

To show that U^{bottom} is an MDS matrix, it is shown that U^{bottom} can be obtained from V by multiplying rows and columns by nonzero scalars. Let

$$[ T \text{:} K ] {=}^{Δ} \{ T + 1 , T + 2 , … T + K \} ,$$

and notice that for (s, r)∈[T]×[N], entry (s, r) of U^{bottom} can be written as

$${\prod }_{t ∈ [ K + T ] \backslash \{ s + K \}}^{ } \frac{{α}_{r} - {β}_{t}}{{β}_{s + K} - {β}_{t}} = {\prod }_{i ∈ [ K ]}^{ } \frac{{α}_{r} - {β}_{i}}{{β}_{s + K} - {β}_{t}} \cdot {\prod }_{i ∈ [ K : T ] \backslash \{ s + K \}}^{ } \frac{{α}_{r} - {β}_{t}}{{β}_{s + K} - {β}_{t}} .$$

Hence, U^{bottom} can be written as

$${U}^{bottom} = diag ( {( {\prod }_{t ∈ [ K ]}^{ } \frac{1}{{β}_{s + K} - {β}_{i}} )}_{s ∈ [ T ]} ) \cdot V \cdot diag ( {( {\prod }_{t ∈ [ K ]}^{ } ( {α}_{v} - {β}_{t} ) )}_{r ∈ [ 𝒩 ]} ) , \qquad ( 5 )$$

where V is a T×N matrix such that

$${V}_{i , j} = {\prod }_{t ∈ [ T ] \backslash \{ i \}}^{ } \frac{{α}_{j} - {β}_{t + K}}{{β}_{i + K} - {β}_{t + K}} .$$

Since {βₜ}ₜ₌₁^{K}∩{αᵣ}ᵣ₌₁^{K}=Ø, and since all the βᵢ's are distinct, it follows from (5) that U^{bottom} can be obtained from V by multiplying each row and each column by a nonzero element, and hence U^{bottom} is an MDS matrix as well.

D. The Uncoded Version of LCC

In Section 1.4B, we have described the LCC scheme, which provides an S-resilient, A-secure, and T-private scheme as long as (K+T−1) deg ƒ+S+2A+1≤N. Instead of explicitly following the same construction, a variation of LCC can be made by instead selecting the values of αᵢ's from the set {βⱼ}_{j∈[K]} (not necessarily distinctly).

We refer to this approach as the uncoded version of LCC, which essentially recovers the uncoded repetition scheme, which simply replicates each Xi onto multiple workers. By replicating every Xi between └N/K┘ and ┌N/K┐ times, it can tolerate at most S stragglers and A adversaries, whenever

S+2A≤└N/K┘−1 (1.6)

which achieves the optimum resiliency and security when the number of workers is small and no data privacy is required (specifically, N<K deg ƒ−1 and T=0, see Section 1.5).

When privacy is taken into account (i.e., T>0), an alternative approach in place of repetition is to instead store each input variable using Shamir's secret sharing scheme [38] over └N/K┘ to ┌N/K┐ machines. This approach achieves any (S, A, T) tuple whenever N≥K(s+2A+deg ƒ·T+1). However, it does not improve LCC.

E. Proof of Lemma 1

We start by defining the following notations. For any multilinear function ƒ defined on V with degree d, let X_{i,1}, X_{i,2}, . . . , X_{i,d} denote its d input entries (i.e., Xᵢ=(X_{i,1}, X_{i,2}, . . . , X_{i,d}) and f is linear with respect to each entry). Let [symbol] ₁, . . . , [symbol] _{d} be the vector space that contains the values of the entries. For brevity, we denote deg ƒ by d in this appendix. We first provide the proof of inequality (3).

Proof of inequality (3). Without loss of generality, we assume both the encoding and decoding functions are deterministic in this proof, as the randomness does not help with decodability.19 Similar to [30], we define the minimum recovery threshold, denoted by R*(N, K, ƒ), as the minimum number of workers that the master has to wait to guarantee decodability, among all linear encoding schemes. Then we essentially need to prove that R*(N, K, ƒ)≥R*_{LCC}(N, K, ƒ), i.e., R*(N, K, ƒ)≥(K−1)d+1 when N≥Kd−1, and R*(N, K, ƒ)≥N−└N/K┘+1 when N<Kd−1.

Obviously, R*(N, K, ƒ) is a non-decreasing function with respect to N. Hence, it suffices to prove that R*(N, K, ƒ)≥N−└N/K┘+1 when N≤Kd−1. We prove this converse bound by induction.

(a) If d=1, then f is a linear function, and we aim to prove R*(N, K, ƒ)≥N+1 for N≤Kd−1. This essentially means that no valid computing schemes can be found when N<K. Assuming the opposite, suppose we can find a valid computation design using at most K−1 workers, then there is a decoding function that computes all ƒ(Xᵢ)'s given the results from these workers.

Because the encoding functions are linear, we can thus find a non-zero vector (α₁, . . . , α_{K}) ∈ [symbol] ^{K} such that when Xᵢ=αᵢV for any V∈ [symbol] the coded variable \tilde{X}ᵢ stored by any worker equals the padded random key, which is a constant. This leads to a fixed output from the decoder. On the other hand, because ƒ is assumed to be non-zero, the computing results {ƒ(Xᵢ)}_{i∈[K]} is variable for different values of V, which leads to a contradiction. Hence, we have prove the converse bound for d=1.

(b) Suppose we have a matching converse for any multilinear function with d=d₀. We now prove the lower bound for any multilinear function ƒ of degree d₀+1. Similar to part (a), it is easy to prove that R*(N, K, ƒ)≥N+1 for N≤K−1. Hence, we focus on N≥K.

The proof idea is to construct a multilinear function let ƒ′ with degree do based on function ƒ, and to lower bound the minimum recovery threshold of ƒ using that of let ƒ′. More specifically, this is done by showing that given any computation design for function ƒ, a computation design can also be developed for the corresponding let ƒ′, which achieves a recovery threshold that is related to that of the scheme for ƒ.

In particular, for any non-zero function ƒ(X_{i,1}, X_{i,2}, . . . , X_{id}_{₀}₊₁), we let ƒ′ be a function which takes inputs X_{i,1}, X_{i,2}, . . . , X_{i,d}_{₀} and returns a linear map, such that given any X_{i,1}, X_{i,2}, . . . , X_{i,d}_{₀}₊₁), we have ƒ′(X_{i,1}, X_{i,2}, . . . , X_{id}_{₀})(X_{i,d}_{₀}₊₁)=ƒ(X_{i,1}, X_{i,2}, . . . , X_{i,d}_{₀}₊₁). One can verify that ƒ′ is a multilinear function with degree d₀, Given parameters K and N, we now develop a computation strategy for ƒ′ for a dataset of K inputs and a cluster of

$${N}^{′} {=}^{Δ} N - K$$

workers, which achieves a recovery threshold of R*(N, K, ƒ)−(K−1). We construct this computation strategy based on an encoding strategy off that achieves the recovery threshold R*(N, K, ƒ). For brevity, we refer to these two schemes as the ƒ′-scheme and ƒ-scheme respectively.

Because the encoding functions are linear, we consider the encoding matrix, denoted by G∈ [symbol] ^{K×N}, and defined as the coefficients of the encoding functions \tilde{X}ᵢ=Σⱼ₌₁^{K}XⱼGⱼᵢ+\tilde{z}ᵢ, where \tilde{z}ᵢ denotes the value of the random key padded to variable \tilde{X}ᵢ. Following the same arguments we used in the d=1 case, the left null space of G must be {0}. Consequently, the rank of G equals K, and we can find a subset [symbol] of K workers such that the corresponding columns of G form a basis of [symbol] ^{K}. Hence we can construct the ƒ′-scheme by letting each of the

$${N}^{′} {=}^{Δ} N - K$$

workers store the coded version of (X_{i,1}, X_{i,2}, . . . , X_{i,d}_{₀}) that is stored by a unique respective worker in [N] [symbol] in f-scheme.

Now it suffices to prove that the above construction achieves a recovery threshold of R*(N, K, ƒ)−(K−1). Equivalently, we need to prove that given any subset [symbol] of [N]\ [symbol] of size R*(N, K, ƒ)−(K−1), the values of ƒ(X_{i,1}, X_{i,2}, . . . , X_{i,d}_{₀}, x) for any i∈[K] and x∈ [symbol] are decodable from the computing results of workers in [symbol] .

We exploit the decodability of the computation design for function ƒ. For any j∈ [symbol] the set [symbol] ∪ [symbol] \{j} has size R*(N, K, ƒ). Consequently, for any vector (X_{i,d}_{₀}₊₁, . . . , X_{i,d}_{₀}₊₁) ∈ [symbol] _{d}_{₀}₊₁^{K}, we have that {ƒ(X_{i,1}, X_{i,2}, . . . , X_{i,d}_{₀}, x_{i,d}_{₀}₊₁)}_{i∈[K]} is decodable given the results from workers in [symbol] ∪ [symbol] \{j} computed in ƒ-scheme, if each x_{i,d}_{₀}₊₁ is used as the (d₀+1)th entree for each input.

Because columns of G with indices in [symbol] form a basis of [symbol] ^{K}, we can find values for each input X_{i, d}_{₀}₊₁ such that workers in [symbol] would store 0 for the X_{i,d}_{₀}₊₁ entry in the ƒ-scheme. We denote these values by x̅_{1,d}_{₀}₊₁, . . . x̅_{K,d}_{₀}₊₁. Note if these values are taken as inputs, workers in [symbol] would return constant 0 due to the multilinearity of ƒ. Hence, decoding ƒ(X_{i,1}, X_{i,2}, . . . , X_{i,d}_{₀}, x_{i,d}_{₀}₊₁) only requires results from workers not in [symbol] , i.e., it can be decoded given computing results from workers in S using the f-scheme. Note that these results can be directly computed from corresponding results in the f0-scheme. We have proved the decodability of ƒ(X_{i,1}, X_{i,2}, . . . , X_{i,d}_{₀}, x) for x=x̅_{K,d}_{₀}₊₁.

Now it remains to prove the decodability of ƒ(X_{i,1}, X_{i,2}, . . . , X_{i,d}_{₀}, x) for each i for general x∈ [symbol] . For any j∈ [symbol] , let α^{(j)}∈ [symbol] ^{K} be a non-zero vector that is orthogonal to all columns of G with indices in [symbol] {j}. If α^{(j)}×+x̅_{i,d}_{₀}₊₁ is used for each input X_{i,d}_{₀}₊₁ in the ƒ-scheme, then workers in [symbol] \{j} would store 0 for the X_{i,d}_{₀}₊₁ entry, and return constant 0 due to the multilinearity of ƒ. Recall that ƒ(X_{i,1}, X_{i,2}, . . . , X_{i,d}_{₀}, αᵢ^{(j)}×+x̅_{i,d}_{₀}₊₁) is assumed to be decodable in the ƒ-scheme given results from workers in [symbol] ∪ [symbol] \{j}. Following the same arguments above, one can prove that ƒ(X_{i,1}, X_{i,2}, . . . , X_{i,d}_{₀}, αᵢ^{(j)}×+x̅_{i,d}_{₀}₊₁) is also decodable using the ƒ′-scheme. Hence, the same applies for αᵢ^{(j)}ƒ(X_{i,1}, X_{i,2}, . . . , X_{i,d}_{₀}, x) due to multilinearity of ƒ.

Because columns of G with indices in [symbol] form a basis of [symbol] ^{K}, the vectors a(j) for j2K also from a basis. Consequently, for any i there is a non-zero αᵢ^{(j)}, and thus ƒ(X_{i,1}, X_{i,2}, . . . , X_{i,d}_{₀}, αᵢ^{(j)}x) is decodable. This completes the proof of decodability.

To summarize, we have essentially proved that R*(N, K, ƒ)−(K−1)≥R*(N-k, K, ƒ)−(K−1). We can verify that the converse bound R*(N, K, ƒ)−(K−1)≥N−└N/K┘+1 under the condition N≤Kd−1 can be derived given the above result and the induction assumption, for any function ƒ with degree d₀+1.

(c)Thus, a matching converse holds for any d∈ [symbol] ₊, which proves inequality (3).

Now we proceed to prove the rest of Lemma 1, explicitly, we aim to prove that the recovery threshold of any T-private encoding scheme is at least R_{LCC}(N, K, J)+T·deg ƒ. Inequality (3) essentially covers the case for T=0. Hence, we focus on T>0. To simplify the proof, we prove a stronger version of this statement: when T>0, any valid T-private encoding scheme uses at least N≥R_{LCC}(N, K, ƒ)+T·deg ƒ workers. Equivalently, we aim to show that N≥(K+T−1) deg ƒ+1 for any such scheme.

We prove this fact using an inductive approach. To enable an inductive structure, we prove an even stronger converse by considering a more general class of computing tasks and a larger class of encoding schemes, formally stated in the following lemma.

Lemma 3. Consider a dataset with inputs

$$X {=}^{Δ} ( {X}_{1} , … , {X}_{K} ) ∈ {( {𝔽}^{d} )}^{k} ,$$

and an input vector

$$Γ {=}^{Δ} ( {Γ}_{1} , … , {Γ}_{K} )$$

which belongs to a given subspace of [symbol] ^{K} with dimension r>0; a set of N workers where each can take a coded variable in [symbol] ^{d+1} and return the product of its elements; and a computing task where the master aim to recover

$${Y}_{i} {=}^{Δ} ( {X}_{i , 1} \cdot … \cdot {X}_{i , d} \cdot {Γ}_{i} ) .$$

If the inputs entries are encoded separately such that each of the first d entries assigned to each worker are some T_{X}>0—privately linearly coded version of the corresponding entries of Xᵢ's, and the (d+1)th entry assigned to each worker is a T-privately linearly coded version of F, moreover, if each Γᵢ (as a variable) is non-zero, then any valid computing scheme requires N≥(T_{X}+K−1)d+T+r.

Proof. Lemma 3 is proved by induction with respect to the tuple (d, T, r). Specifically, we prove that (a) Lemma 3 holds when (d, T, r)=(0, 0, 1); (b) If Lemma 3 holds for any (d, T, r)=(d₀, 0, r₀), then it holds when (d, T, r)=(d₀, 0, r₀+1); (c) If Lemma 3 holds for any (d, T, r)=(d₀, 0, r₀), then it holds when (d, T, r)=(d₀, T, r₀) for any T; (d) If Lemma 3 holds for any d=d0 and arbitrary values of T and r, then it holds if (d, T, r)=(d₀+1; 0; 1). Assuming the correctness of these statements, Lemma 3 directly follows by induction's principle. Now we provide the proof of these statements as follows.

(a). When (d, T, r)=(0; 0; 1), we need to show that at least 1 worker is needed. This directly follows from the decodability requirement, because the master aims to recover a variable, and at least one variable is needed to provide the information.

(b). Assuming that for any (d, T, r)=(d₀, 0, r₀) and any K and T_{X}, any valid computing scheme requires N≥(T_{X}+K−1)d₀+r workers, we need to prove that for (d, T, r)=(d₀, 0, r₀+1), at least (T_{X}+K−1)d₀+r₀+1 workers are needed.

We prove this fact by fixing an arbitrary valid computing scheme for (d, T, r)=(d₀, 0, r₀+1). For brevity, let \tilde{Γ} denotes the coded version of Γ stored at worker i. We consider the following two possible scenarios: (i) there is a worker i such that \tilde{Γ}ᵢ is not identical (up to a constant factor) to any variable Γⱼ, or (ii) for any worker i, \tilde{Γ}ᵢ is identical (up to a constant factor) to some Γⱼ.

For case (i), similar to the ideas we used to prove inequality (3), it suffices to show that if the given computing scheme uses N workers, we can construct another computation scheme achieving the same T_{X}, for a different computing task with parameters d=d₀ and r=r₀, using at most N−1 workers.

Recall that we assumed that there is a worker i, such that \tilde{Γ}ᵢ is not identical (up to a constant factor) to any Γⱼ. We can always restrict the value of Γ to a subspace with dimension r₀, such that \tilde{Γ}ᵢ becomes a constant 0. After this operation, from the computation results of the rest N−1 workers, the master can recover a computing function with r=r₀ and non-zero Γj's, which provides the needed computing scheme.

For case (ii), because each Γⱼ is assumed to be non-zero, we can partition the set of indices j into distinct subsets, such that any j and j′ are in the same subset if Γⱼ is a constant multiple of Γ_{j′}. We denote these subsets by [symbol] ₁, . . . , [symbol] ₘ. Moreover, for any k∈[m], let [symbol] ₘ denote the subset of indices i such that \tilde{Γ}ᵢ is identical (up to a constant factor) to Γⱼ for j in [symbol] ₖ.

Now for any k∈[m], we can restrict the value of Γ to a subspace with dimension r₀, such that Γⱼ is zero for any j∈ [symbol] ₖ. After applying this operation, from the computation results of workers in [N]\ [symbol] ₖ, the master can recover a computing function with r=r₀, where K′=K−| [symbol] ₖ| sub-functions has non-zero Γⱼ's. By applying the induction assumption on this provided computing scheme, we have N−| [symbol] ₖ|≥(T_{X}+K−| [symbol] ₖ|−1)d₀+r₀. By taking the summation of this inequality over k∈[m], we have

$$Nm - {\sum }_{k = 1}^{m} \vert {ℐ}_{k} \vert \geq ( {T}_{X} m + Km - K - m ) {d}_{0} + {r}_{0} m . \qquad ( 1.7 )$$

Recall that for any worker i, \tilde{Γ}ᵢ is identical (up to a constant factor) to some Γⱼ, we have ∪_{k∈[m]} [symbol] ₖ=[N]. Thus, Σₖ| [symbol] ₖ|≥N. Consequently, inequality (7) implies that

Nm−N≥(T_{X}m+Km−K−m)d₀+r₀m (1.8

Note that r₀+1>1, which implies that at least two Γⱼ's are not identical up to a constant factor. Hence, m−1>0, and (8) is equivalently

$$\begin{matrix}N \geq \frac{( {T}_{X} m + Km - K - m ) {d}_{0} + {r}_{0} m}{m - 1} & ( 1.9 ) \\ = ( {T}_{X} + K - 1 ) {d}_{0} + {r}_{0} + ( ( {T}_{X} - 1 ) {d}_{0} + {r}_{0} ) \frac{1}{m - 1} . & ( 1.10 )\end{matrix}$$

Since Tₓ and r₀ are both positive, we have (Tₓ−1)d₀+r₀>0. Consequently,

$$( ( {T}_{X} - 1 ) {d}_{0} + {r}_{0} ) \frac{1}{m - 1} > 0 ,$$

and we have

N≥(T_{X}+K−1)d₀+r₀+1 (1.11)

which proves the induction statement.

(c). Assuming that for any (d, T, r)=(d₀, 0, r₀), any valid computing scheme requires N≥(Tₓ+K−1)d₀+r₀ workers, we need to prove that for (d, T, r)=(d₀, T₀, r₀), N≥(Tₓ+K−1) d₀+T₀+r₀. Equivalently, we aim to show that for any T₀>0, in order to provide T₀-privacy to the d₀+1th entry, To extra worker is needed. Similar to the earlier steps, we consider an arbitrary valid computing scheme for (d, T, r)=(d₀, T₀, r₀) that uses N workers. We aim to construct a new scheme for (d, T, r)=(d₀, 0, r₀), for the same computation task and the same Tₓ, which uses at most N−T₀ workers.

Recall that if an encoding scheme is T₀ private, then given any subset of at most T₀ workers, denoted by T, we have I(Γ; [symbol] )=0. Consequently, conditioned [symbol] =0, the entropy of the variable Γ remains unchanged. This indicates that F can be any possible value when [symbol] =0. Hence, we can let the values of the padded random variables be some linear combinations of the elements of Γ, such that worker in [symbol] returns constant 0.

Now we construct an encoding scheme as follows. Firstly it is easy to show that when the master aims to recover a non-constant function, at least T₀+1 workers are needed to provide non-zero information regarding the inputs. Hence, we can arbitrarily select a subset of T₀ workers, denoted by [symbol] . As we have proved, we can find fix the values of the padded random variables such that [symbol] =0. Due to multilinearity of the computing task, these workers in [symbol] also returns constant 0.

Conditioned on these values, the decoder essentially computes the final output only based on the rest N−T₀ workers, which provides the needed computing scheme. Moreover, as we have proved that the values of the padded random variables can be chosen to be some linear combinations of the elements of Γ, our obtained computing scheme encodes Γ linearly. This completes the proof for the induction statement.

(d). Assuming that for any d=d₀ and arbitrary values of T and r, any valid computing scheme requires N≥(Tₓ+K−1)d₀+T+r workers, we need to prove that for (d, T, r)=(d₀+1, 0, 1), N≥(Tₓ+K−1)(d₀+1)+1. Observing that for any computing task with r=1, by fixing a non-zero Γ, it essentially computes K functions where each multiplies d₀ variables. Moreover, for each function, by viewing the first (d₀−1) entries as a vector X′ᵢ and by viewing the last entry as a scalar Γ′ᵢ, it essentially recovers the case where the parameter d is reduced by 1, K remain unchanged, and r equals K. By adapting any computing scheme in the same way, we have Tₓ remain unchanged, and T becomes Tₓ. Then by induction assumption, any computing scheme for (d, T, r)=(d₀+1, 0, 1) requires at least (Tₓ+K−1)d₀+Tₓ+K=(Tₓ+K−1)(d₀+1)+1 workers.

Remark 6. Using exactly the same arguments, Lemma 3 can be extended to the case where the entries of X are encoded under different privacy requirements. Specifically, if the ith entry is Ti-privately encoded, then at least Σᵢ₌₁^{d}Tᵢ+(K−1)d+T+r worker is needed. Lemma 3 and this extended version are both tight, in the sense for any parameter values of d, K and r, there are computing tasks where a computing scheme that uses the matching number of workers can be found, using constructions similar to the Lagrange coded computing.

Now using Lemma 3, we complete the proof of Lemma 1 for T>0. Similar to the proof ideas for inequality (3) part (a), we consider any multilinear function ƒ with degree d, and we find constant vectors V₁, . . . , V_{d}, such that ƒ(V₁, . . . , V_{d}) is non-zero. Then by restricting the input variables to be constant multiples of V₁, . . . , V_{d}, this computing task reduces to multiplying d scalars, given K inputs. As stated in Lemma 3 and discussed in part (d) of its induction proof, such computation requires (T+K−1)d+1 workers. This completes the proof of Lemma 1.

F. Optimality on the Resiliency-Security-Privacy Tradeoff for Multilinear Functions

In this appendix, we prove the first part of Theorem 2 using Lemma 1. Specifically, we aim to prove that LCC achieves the optimal trade-off between resiliency, security, and privacy for any multilinear function ƒ. By comparing Lemma 1 and the achievability result presented in Theorem 1 and Appendix D, we essentially need to show that for any linear encoding scheme that can tolerates A adversaries and S stragglers, it can also tolerate S+2A stragglers.

This converse can be proved by connecting the straggler mitigation problem and the adversary tolerance problem using the extended concept of Hamming distance for coded computing, which is defined in [30]. Specifically, given any (possibly random) encoding scheme, its hamming distance is defined as the minimum integer, denoted by d, such that for any two instances of input X whose outputs Y are different, and for any two possible realizations of the N encoding functions, the computing results given the encoded version of these two inputs, using the two lists of encoding functions respectively, differs for at least d workers.

It was shown in [30] that this hamming distance behaves similar to its classical counterpart: an encoding scheme is S-resilient and A-secure whenever S+2A≤d−1. Hence, for any encoding scheme that is A-secure and S-resilient, it has a hamming distance of at least S+2A+1. Consequently it can tolerate S+2A stragglers. Combining the above and Lemma 1, we have completed the proof.

G. Optimality on the Resiliency-Privacy Tradeoff for General Multivariate Polynomials

In this appendix, we prove the second part of Theorem 2 using Lemma 1. Specifically, we aim to prove that LCC achieves the optimal trade-off between resiliency and privacy, for general multivariate polynomial f. The proof is carried out by showing that for any function ƒ that allows S-resilient T-private designs, there exists a multilinear function with the same degree for which a computation scheme can be found that achieves the same requirement.

Specifically, given any function ƒ with degree d, we aim to provide an explicit construction of an multilinear function, denoted by ƒ′, which achieves the same requirements. The construction satisfies certain properties to ensure this fact. Both the construction and the properties are formally stated in the following lemma (which is proved in Appendix H):

Lemma 4. Given any function ƒ of degree d, let ƒ′ be a map from [symbol] ^{d}→ [symbol] such that ƒ′(Z₁, . . . , Z_{d})=Σ_{S⊆[d]}(−1)^{|S|} ƒ(Σ_{j∈S}Zⱼ) for any {Zⱼ}_{j∈[d]}∈ [symbol] ^{d}. Then ƒ′ is multilinear with respect to the d inputs. Moreover, if the characteristic of the base field [symbol] is 0 or greater than d, then ƒ′ is non-zero.

Assuming the correctness of Lemma 4, it suffices to prove that ƒ′ enables computation designs that tolerates at least the same number of stragglers, and provides at least the same level of data privacy, compared to that of ƒ. We prove this fact by constructing such computing schemes for ƒ′ given any design for ƒ.

Note that ƒ′ is defined as a linear combination of functions ƒ((Z_{j∈S}Zⱼ), each of which is a composition of a linear map and ƒ. Given the linearity of the encoding design, any computation scheme of ƒ can be directly applied to any of these functions, achieving the same resiliency and privacy requirements. Since the decoding functions are linear, the same scheme also applies to linear combinations of them, which includes ƒ′. Hence, the resiliency-privacy tradeoff achievable for ƒ can also be achieved by ƒ′. This concludes the proof.

H. Proof of Lemma 4

We first prove that ƒ′ is multilinear with respect to the d inputs. Recall that by definition, ƒ is a linear combination of monomials, and ƒ′ is constructed based on f through a linear operation. By exploiting the commutativity of these two linear relations, we only need to show individually that each monomial in ƒ is transformed into a multilinear function.

More specifically, let ƒ be the sum of monomials

$${h}_{k} {=}^{△} {U}_{k} \cdot {Π}_{l = 1}^{{d}_{k}} {h}_{k , l} ( \cdot )$$

where k belongs to a finite set, Uₖ∈ [symbol] , dₖ∈{0, 1, . . . , d} and each h_{k,1} is a linear map from [symbol] to [symbol] . Let h′ₖ denotes the contribution of hₖ in ƒ′, then for any Z=(Zᵢ, . . . , Z_{d})∈ [symbol] d we have

$$\begin{matrix}{h}_{k}^{′} ( Z ) = {\sum }_{⊆ [ d ]} {( - 1 )}^{\vert \vert} {h}_{k} ( {\sum }_{j ∈} {Z}_{j} ) \\ = {\sum }_{⊆ [ d ]} {( - 1 )}^{\vert \vert} {U}_{k} \cdot {{\prod }_{𝓁 = 1}}^{{d}_{k}} {h}_{k , 𝓁} ( {\sum }_{j ∈} {Z}_{j} ) .\end{matrix} \qquad ( 1.12 )$$

By utilizing the linearity of each h_{k,1}, we can write h′ₖ as

$$\begin{matrix}{h}_{k}^{′} ( Z ) = {U}_{k} \cdot {\sum }_{⊆ [ d ]} {( - 1 )}^{\vert \vert} {\sum }_{𝓁 = 1}^{{d}_{k}} {\sum }_{j ∈} {h}_{k , 𝓁} ( {Z}_{j} ) \\ = {U}_{k} \cdot {\sum }_{⊆ [ d ]} {( - 1 )}^{\vert \vert} {\prod }_{𝓁 = 1}^{{d}_{k}} {\sum }_{j = 1}^{d} ( j ∈ ) \cdot {h}_{k , 𝓁} ( {Z}_{j} )\end{matrix} \qquad ( 1.13 )$$

Then by viewing each subset [symbol] of [d] as a map from [d] to {0, 1}, we have

$${h}_{k}^{′} ( Z ) = {U}_{k} {\sum }_{s ∈ {\{ 0 , 1 \}}^{d}} ( {\prod }_{m = 1}^{d} {( - 1 )}^{{s}_{m}} ) \cdot {\prod }_{𝓁 = 1}^{{d}_{k}} {\prod }_{j = 1}^{d} {s}_{j} \cdot {h}_{k , 𝓁} ( {Z}_{j} ) = {U}_{k} {\sum }_{j ∈ {[ d ]}^{d} k} {\sum }_{s ∈ {\{ 0 , 1 \}}^{d}} ( {\prod }_{m = 1}^{d} {( - 1 )}^{{s}_{m}} ) \cdot {\prod }_{𝓁 = 1}^{{d}_{k}} ( {s}_{ji} \cdot {h}_{k , 𝓁} ( {Z}_{{j }_{𝓁}} ) ) . \qquad ( 14 )$$

Note that the product Πᵢ₌₁^{d}^{ₖ}sⱼₗ′ can be alternatively written as Πₘ₌₁^{d}sₘ^{(m in j)}, where #(m in j) denotes the number of elements in j that equals m. Hence

$${h}_{k}^{′} ( Z ) = {U}_{k} \cdot {\sum }_{j ∈ {[ d ]}^{d} k} {\sum }_{s ∈ {\{ 0 , 1 \}}^{d}} ( {\prod }_{m = 1}^{d} ( {( - 1 )}^{{s}_{m}} {s}_{m}^{\# ( m in j )} ) ) \cdot {\prod }_{𝓁 = 1}^{{d}_{k}} {h}_{k , 𝓁} ( {Z}_{{j}_{𝓁}} ) = {U}_{k} \cdot {\sum }_{j ∈ {[ d ]}^{d} k} ( {\prod }_{m = 1}^{d} {\sum }_{s ∈ \{ 0 , 1 \}} {( - 1 )}^{s} {s}^{\# ( m in j )} ) \cdot {\prod }_{𝓁 = 1}^{{d}_{k}} {h}_{k , 𝓁} ( {Z}_{{j}_{𝓁}} ) . \qquad ( 15 )$$

The sum Σ_{i∈{0,1}}(−1)^{s}s^{#(m in j)} is non-zero only if m appears in j. Consequently, among all terms that appear in (15), only the ones with degree dₖ=d and distinct elements in j have non-zero contribution. More specifically,

$${h}_{k}^{′} ( Z ) = {( - 1 )}^{d} \cdot 1 ( {d}_{k} = d ) \cdot {U}_{k} \cdot {\sum }_{g ∈ {S}_{d}} {\prod }_{j = 1}^{d} {h}_{k , g ( j )} ( {Z}_{j} ) . \qquad ( 1.16 )$$

Recall that ƒ′ is a linear combination of h′ₖ's. Consequently, it is a multilinear function.

Now we prove that ƒ′ is non-zero. From equation (16), we can show that when all the elements Zⱼ's are identical, ƒ′(Z) equals the evaluation of the highest degree terms of ƒ multiplied by a constant (−1)^{d}d! with Zⱼ as the input for any j. Given that the highest degree terms cannot be zero, and (−1)^{d}d! is non-zero as long as the characteristic of the field [symbol] is greater than d, we proved that ƒ′ is non-zero.

I. Optimality in Randomness

In this appendix, we prove the optimality of LCC in terms of the amount of randomness needed in data encoding, which is formally stated in the following theorem.

Theorem 3. (Optimal randomness) Any linear encoding scheme that universally achieves a same tradeoff point specified in Theorem 1 for all linear functions ƒ(i.e., (S, A, T) such that K+T+S+2A=N) must use an amount of randomness no less than that of LCC.

Proof. The proof is taken almost verbatim from [47], Chapter 3. In what follows, an (n, k, r, [symbol] secure RAID scheme is a storage scheme over [symbol] _{q}^{t} (where [symbol] _{q} is a field with q elements) in which k message symbols are coded into n storage servers, such that the k message symbols are reconstructible from any n−r servers, and any z servers are information theoretically oblivious to the message symbols. Further, such a scheme is assumed to use v random entries as keys, and by [47], Proposition 3.1.1, must satisfy n−r≥k+z.

Theorem 4 [47]. Theorem 3.2.1. A linear rate-optimal [symbol] secure RAID scheme uses at least zt keys over [symbol] _{q} (i.e., v−z).

Clearly, in our scenario [symbol] can be seen as [symbol] for some q. Further, by setting N=n, T=z, and t=dim [symbol] , it follows from Theorem 4 that any encoding scheme which guarantees information theoretic privacy against sets of T colluding workers must use at least T random entries {Zᵢ}_{i∈[T]}

J. Optimality of LCC for Linear Regression

In this section, we prove that the proposed LCC scheme achieves the minimum possible recovery threshold R* to within a factor of 2, for the linear regression problem discussed in Section 1.6.

As the first step, we prove a lower bound on R* for linear regression. More specifically, we show that for any coded computation scheme, the master always needs to wait for at least

$$⌈ \frac{n}{r} ⌉$$

workers to be able to decode the final result, i.e.,

$${R}^{*} \geq ⌈ \frac{n}{r} ⌉ .$$

Before starting the proof, we first note that since here we consider a more general scenario where workers can compute any function on locally stored coded sub-matrices (not necessarily matrix-matrix multiplication), the converse result in Theorem 2 no longer holds.

To prove the lower bound, it is equivalent to show that, for any coded computation scheme and any subset N of workers, if the master can recover X^{T}Xw given the results from workers in N, then we must have

$$\vert \vert \geq ⌈ \frac{n}{r} ⌉ .$$

Suppose the condition in the above statement holds, then we can find encoding, computation, and decoding functions such that for any possible values of X and w, the composition of these functions returns the correct output.

Note that within a GD iteration, each worker performs its local computation only based on its locally stored coded sub-matrices and the weight vector w. Hence, if the master can decode the final output from the results of the workers in a subset [symbol] , then the composition of the decoding function and the computation functions of these workers essentially computes X^{T}Xw, using only the coded sub-matrices stored at these workers and the vector w. Hence, if any class of input values X gives the same coded sub-matrices for each worker in [symbol] , then the product X^{T}Xw must also be the same given any w.

Now we consider the class of input matrices X such that all coded sub-matrices stored at workers in [symbol] equal the values of the corresponding coded sub-matrices when X is zero. Since 0^{T}0w is zero for any w, X^{T}Xw must also be zero for all matrices X in this class and any w. However, for real matrices X=0 is the only solution to that condition. Thus, zero matrix must be the only input matrix that belongs to this class.

Recall that all the encoding functions are assumed to be linear. We consider the collection of all encoding functions that are used by workers in [symbol] , which is also a linear map. As we have just proved, the kernel of this linear map is {0}. Hence, its rank must be at least the dimension of the input matrix, which is dm. On the other hand, its rank is upper bounded by the dimension of the output, where each encoding function from a worker contributes at most

$$\frac{r d m}{n} .$$

Consequently, the number of workers in [symbol] must be at least

$$⌈ \frac{n}{r} ⌉$$

to provide sufficient rank to support the computation.

Having proved that

$${R}^{*} \geq ⌈ \frac{n}{r} ⌉ ,$$

the factor of two characterization of LCC directly follows since

$${R}^{*} \leq {R}_{L C C} = 2 ⌈ \frac{n}{r} ⌉ - 1 < 2 ⌈ \frac{n}{r} ⌉ \leq 2 {R}^{*} .$$

Note that the converse bound proved above applies to the most general computation model, i.e., there are no assumptions made on the encoding functions or the functions that each worker computes. If additional requirements are taken into account, we can show that LCC achieves the exact optimum recovery threshold (e.g., see [30]).

K. Complete Experimental Results

In this section, we present the complete experimental results using the LCC scheme proposed in the paper, the gradient coding (GC) scheme [10] (the cyclic repetition scheme), the matrix-vector multiplication based (MVM) scheme [17], and the uncoded scheme for which there is no data redundancy across workers, measured from running linear regression on Amazon EC2 clusters.

In particular, experiments are performed for the following 3 scenarios.
Scenario 1 & 2: # of input data point m=8000, # of features d=7000.
Scenario 3: # of input data point m=160000, # of features d=500.

In scenarios 2 and 3, we artificially introduce stragglers by imposing a 0:5 seconds delay on each worker with probability 5% in each iteration.

We list the detailed breakdowns of the run-times in experiment scenarios in Tables 1.2, 1.3, and 1.4 respectively. In particular, the computation (comp.) time is measured as the summation of the maximum local processing time among all non-straggling workers, over 100 iterations. The communication (comm.) time is computed s the difference between the total run-time and the computation time.

TABLE 1.2
BREAKDOWNS OF THE RUN-TIMES IN SCENARIO ONE.

| | # batches/ | | | | | | | |
|---|---|---|---|---|---|---|---|---|
| schemes | worker (r) | recovery | comm. | | comp. | | total | |
| uncoded | 1 | 40 | 24.125 | s | 0.237 | s | 24.362 | s |
| GC | 10 | 31 | 6.033 | s | 2.431 | s | 8.464 | s |
| MVM Rd. 1 | 5 | 8 | 1.245 | s | 0.561 | s | 1.806 | s |
| MVM Rd. 2 | 5 | 8 | 1.340 | s | 0.480 | s | 1.820 | s |
| MVM total | 10 | — | 2.585 | s | 1.041 | s | 3.626 | s |
| LCC | 10 | 7 | 1.719 | s | 1.868 | s | 3.587 | s |

TABLE 1.3
BREAKDOWNS OF THE RUN-TIMES IN SCENARIO TWO.

| | # batches/ | | | | | | | |
|---|---|---|---|---|---|---|---|---|
| schemes | worker (r) | recovery | comm. | | comp. | | total | |
| uncoded | 1 | 40 | 7.928 | s | 44.772 | s | 52.700 | s |
| GC | 10 | 31 | 14.42 | s | 2.401 | s | 16.821 | s |
| MVM Rd. 1 | 5 | 8 | 2.254 | s | 0.475 | s | 2.729 | s |
| MVM Rd. 2 | 5 | 8 | 2.292 | s | 0.586 | s | 2.878 | s |
| MVM total | 10 | — | 4.546 | s | 1.061 | s | 5.607 | s |
| LCC | 10 | 7 | 2.019 | s | 1.906 | s | 3.925 | s |

TABLE 1.4
BREAKDOWNS OF THE RUN-TIMES IN SCENARIO THREE

| | # batches/ | | | | | | | |
|---|---|---|---|---|---|---|---|---|
| schemes | worker (r) | recovery | comm. | | comp. | | total | |
| uncoded | 1 | 40 | 0.229 | s | 41.765 | s | 41.994 | s |
| GC | 10 | 31 | 8.627 | s | 2.962 | s | 11.589 | s |
| MVM Rd. 1 | 5 | 8 | 3.807 | s | 0.664 | s | 4.471 | s |
| MVM Rd. 2 | 5 | 8 | 52.232 | s | 0.754 | s | 52.986 | s |
| MVM total | 10 | — | 56.039 | s | 1.418 | s | 57.457 | s |
| LCC | 10 | 7 | 1.962 | s | 2.597 | s | 4.541 | s |

Jim2. CodedPrivateML: A Fast and Privacy-Preserving Framework for Distributed Machine Learning

How to train a machine learning model while keeping the data private and secure? We present CodedPrivateML, a fast and scalable approach to this critical problem. CodedPrivateML keeps both the data and the model information-theoretically private, while allowing efficient parallelization of training across distributed workers. We characterize CodedPrivateML's privacy threshold and prove its convergence for logistic (and linear) regression. Furthermore, via experiments over Amazon EC2, we demonstrate that CodedPrivateML can provide an order of magnitude speedup (up to ˜34×) over the state-of-the-art cryptographic approaches.

2.1 Introduction

Modern machine learning models are breaking new ground by achieving unprecedented performance in various application domains. Training such models, however, is a daunting task. Due to the typically large volume of data and complexity of models, training is a compute and storage intensive task. Furthermore, training should often be done on sensitive data, such as healthcare records, browsing history, or financial transactions, which raises the issues of security and privacy of the dataset. This creates a challenging dilemma. On the one hand, due to its complexity, training is often desired to be outsourced to more capable computing platforms, such as the cloud. On the other hand, the training dataset is often sensitive and particular care should be taken to protect the privacy of the dataset against potential breaches in such platforms. This dilemma gives rise to the main problem that we study here: How can we offload the training task to a distributed computing platform, while maintaining the privacy of the dataset?

More specifically, we consider a scenario in which a data-owner (e.g., a hospital) wishes to train a logistic regression model by offloading the large volume of data (e.g., health-care records) and computationally-intensive training tasks (e.g., gradient computations) to Nmachines over a cloud platform, while ensuring that any collusions between T out of N workers do not leak information about the training dataset. We focus on the semi-honest adversary setup, where the corrupted parties follow the protocol but may leak information in an attempt to learn the training dataset.

We propose CodedPrivateML for this problem, which has three salient features:

1. provides strong information-theoretic privacy guarantees for both the training dataset and model parameters in the presence of colluding workers.

2. enables fast training by distributing the training computation load effectively across several workers.

3. leverages a new method for secret sharing the dataset and model parameters based on coding and information theory principles, which significantly reduces the communication overhead and the complexity for distributed training.

At a high level, CodedPrivateML can be described as follows. It secret shares the dataset and model parameters at each round of the training in two steps. First, it employs stochastic quantization to convert the dataset and the weight vector at each round into a finite domain. It then combines (or encodes) the quantized values with random matrices, using a novel coding technique named Lagrange coding ([48]), to guarantee privacy (in an information-theoretic sense) while simultaneously distributing the workload among multiple workers. The challenge is however that Lagrange coding can only work for computations that are in the form of polynomial evaluations. The gradient computation for logistic regression, on the other hand, includes non-linearities that cannot be expressed as polynomials. CodedPrivateML handles this challenge through polynomial approximations of the non-linear sigmoid function in the training phase.

Upon secret sharing of the encoded dataset and model parameters, each worker performs the gradient computations using the chosen polynomial approximation of the sigmoid function, and sends the result back to the master. It is useful to note that the workers perform the computations over the quantized and encoded data as if they were computing over the true dataset. That is, the structure of the computations are the same for computing over the true dataset versus computing over the encoded dataset.

Finally, the master collects the results from a subset of fastest workers and decodes the gradient over the finite field. It then converts the decoded gradients to the real domain, up-dates the weight vector, and secret shares it with the worker nodes for the next round. We note that since the computations are performed in a finite domain while the weights are updated in the real domain, the update process may lead to undesired behaviour as weights may not converge. Our system guarantees convergence through the proposed stochastic quantization technique while converting between real and finite fields.

We theoretically prove that CodedPrivateML guarantees the convergence of the model parameters, while providing information-theoretic privacy for the training dataset. Our theoretical analysis also identifies a trade-off between privacy and parallelization. More specifically, each additional worker can be utilized either for more privacy, by protecting against a larger number of collusions T, or more parallelization, by reducing the computation load at each worker. We characterize this trade-off for CodedPrivateML.

Furthermore, we empirically demonstrate the impact of CodedPrivateML by comparing it with state-of-the-art crypto-graphic approaches based on secure multi-party computing (MPC) ([49]-[50]), that can also be applied to enable privacy-preserving machine learning tasks (e.g. see ([51]-[56]). In particular, we envision a master who secret shares its data and model parameters among multiple workers who collectively perform the gradient computation using a multi-round MPC protocol. Given our focus on information-theoretic privacy, the most relevant MPC-based scheme for empirical comparison is the BGW-style [79] approach based on Shamir's secret sharing [57]. While several more recent work design MPC-based private learning solutions with information-theoretic security ([58]-[59]), their constructions are limited to three or four parties.

We run extensive experiments over Amazon EC2 cloud to empirically demonstrate the performance of CodedPrivateML. We train a logistic regression model for image classification over the MNIST dataset ([60]), while the computation workload is distributed to up to N=40 machines over the cloud. We demonstrate that CodedPrivateML can provide substantial speedup in training time (up to ˜34.1×), compared with MPC-based schemes, while guaranteeing the same level of accuracy. The primary disadvantage of the MPC-based scheme is its reliance on extensive communication and coordination between the workers for distributed private computing, and not benefiting from parallelization among the workers as the whole computation is repeated by all players who take part in MPC. They however guarantee a higher privacy threshold (i.e., larger T) compared with CodedPrivateML.

Other related works. Apart from MPC-based schemes to this problem, one can consider two other solutions. One is based on Homomorphic Encryption (HE) ([61]) which allows for computation to be performed over encrypted data, and has been used to enable privacy-preserving machine learning solutions ([62]-[69]). The privacy guarantees of HE are based on computational assumptions, whereas our system provides strong information-theoretic security. Moreover, HE requires computations to be per-formed over encrypted data which leads to many orders of magnitude slow down in training. For example, for image classification on the MNIST dataset, HE takes 2 hours to learn a logistic regression model with %96 accuracy ([69]). In contrast, in CodedPrivateML there is no slow down in performing the coded computations which allows for a faster implementation. As a trade-off, HE allows collusion between a larger number of workers whereas in CodedPrivateML this number is determined by other system parameters such as number of workers and the computation load assigned to each worker.

Another possible solution is based on differential privacy (DP), which is a release mechanism that preserves the privacy of personally identifiable information, in that the removal of any single element from the dataset does not change the computation outcomes significantly ([70]). In the context of machine learning, DP is mainly used for training when the model parameters are to be released for public use, to ensure that the individual data points from the dataset cannot be identified from the released model ([71]-[77]). The main difference between these approaches and our work is that we can guarantee strong information-theoretic privacy that leaks no information about the dataset, and preserve the accuracy of the model throughout the training. We note however that it is in principal possible to compose techniques of CodedPrivateML with differential privacy to obtain the best of both worlds if the intention is to publicly release the final model, but we leave this as future work.

2.2. Problem Setting

We study the problem of training a logistic regression model. The training dataset is represented by a matrix Xϵ{0, 1}^{m}. Row i is denoted by xᵢ. The model parameters (weights) wϵR^{d} are obtained by minimizing the cross-entropy function,

$$C ( w ) = \frac{1}{m} {\sum }_{i = 1}^{m} ( - {y}_{i} log {\hat{y}}_{i} - ( 1 - {y}_{i} ) log ( 1 - {\hat{y}}_{i} ) ) \qquad ( 2.1 )$$

where ŷ_{I}=g(xᵢ·w)ϵ(0, 1) is the estimated probability of label I being equal to 1 and g(·) is the sigmoid function

g(z)=1/(1+e^{-z}) (2.2)

The problem in (2.1) can be solved via gradient descent, through an iterative process that updates the model parameters in the opposite direction of the gradient. The gradient for (2.1) is given by

$$∇ C ( w ) = \frac{1}{m} {X}^{T} ( g ( X \times w ) - y ) .$$

Accordingly, model parameters are updated as,

$${w}^{t + 1 )} = {w}^{t} - \frac{n}{m} {X}^{T} ( g ( X \times {w}^{( t )} ) - y ) \qquad ( 2.3 )$$

where w^{(t)} holds the estimated parameters from iteration t, n is the learning rate, and function (g(·) operates element-wise over the vector given by X×w^{(t)}.

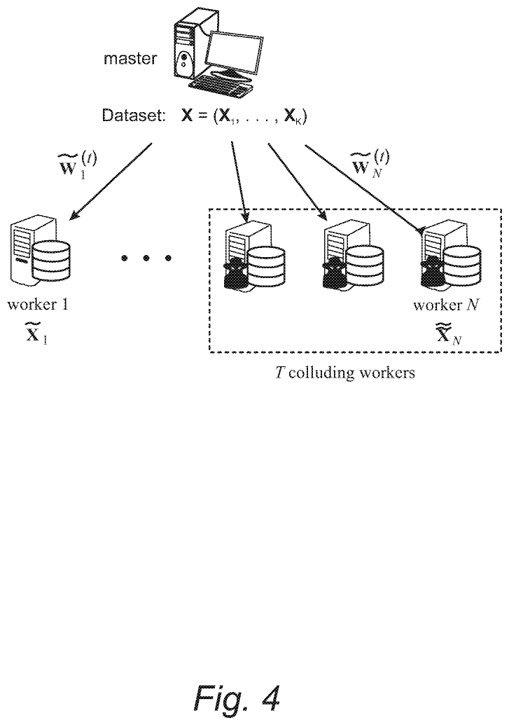

As shown in FIG. 4, we consider a master-worker distributed computing architecture, where the master offloads the computationally-intensive operations to N workers. These operations correspond to gradient computations in (3). In doing so, master wishes to protect the privacy of the dataset X against any potential collusions between up to T workers, where T is the privacy parameter of the system. At the beginning of the training, dataset X is shared in a privacy-preserving manner among the workers. To do so, X is first partitioned into K submatrices X=X₁^{T} . . . X_{K}^{T}]^{T}, for some Kϵ [symbol] Parameter K is related to the computation load at each worker (i.e., what fraction of the dataset is processed at each worker), as well as the number of workers the master has to wait for, to reconstruct the gradient at each step. The master then creates N encoded submatrices, denoted by \tilde{X}₁, . . . , \tilde{X}_{N}, by combining the K parts of the dataset together with some random matrices to preserve privacy, and sends \tilde{X}₁ to worker i∈[N]. This process should only be performed once for the dataset X.

At each iteration t of the training, the master also needs to send to worker i∈[N] the current estimate of the model parameters (i.e., w^{(t)} in (3)). However, it is recently shown that the intermediate model parameters can also leak substantial information about the dataset ([78]). The master also needs to prevent the leakage of these intermediate parameters. To that end, the master creates an encoded matrix \tilde{W}ᵢ^{(t)} to secret share the current estimate of model parameters with worker i∈[N]. This coding strategy should also be private against any T colluding workers.

More specifically, the coding strategy that is used for secret sharing the dataset (i.e., creating) and model parameters (i.e., creating \tilde{X}₁'s) and model parameters (i.e., creating \tilde{W}ᵢ^{(t)}'s) should be such that any subset of T colluding workers cannot learn any information, in the strong information-theoretic sense, about the training dataset X. Formally, for every subset of workers T⊆[N] of size at most T, we should have,

I(X; [symbol] , [symbol] )=0 2.4

where I denotes the mutual information, J is the number of iterations, and [symbol] , [symbol] is the collection of the coded matrices and coded parameter estimations stored at workers in T. We refer to a protocol that guarantees privacy against T colluding workers as a T-private protocol.

At X^{T}g(X×w^{(t)})=Σₖ₌₁^{K}Xₖ^{T}g(Xₖ×w^{(t)}), each iteration, worker i∈[N] performs its computation locally using \tilde{X}₁ and \tilde{W}ᵢ^{(t)} and sends the result back to the master. After receiving the results from a sufficient number of workers, the master recovers reconstructs the gradients, and updates the model parameters using (3). In doing so, the master needs to wait only for the fastest workers. We define the recovery threshold of the protocol as the minimum number of workers the master needs to wait for. The relations between the recovery threshold and parameters N, K, and Twill be detailed in our theoretical analysis.

Remark 1. Although our presentation is based on logistic regression, CodedPrivateML can also be applied to linear regression with minor modifications.

2.3. The Proposed CodedPrivateML Strategy

CodedPrivateML strategy consists of four main phases that are first described at a high-level below, and then with details in the rest of this section.

Phase 1: Quantization. In order to guarantee information-theoretic privacy, one has to mask the dataset and the weight vector in a finite field F using uniformly random matrices, so that the added randomness can make each data point appear equally likely. In contrast, the dataset and weight vectors for the training task are defined in the domain of real numbers. We address this by employing a stochastic quantization technique to convert the parameters from the real domain to the finite domain and vice versa. Accordingly, in the first phase of our system, master quantizes the dataset and weights from the real domain to the domain of integers, and then embeds them in a field Fₚ of integers modulo a prime p. The quantized version of the dataset X is given by X̅. The quantization of the weight vector w^{(t)}, on the other hand, is represented by a matrix W̅^{(t)}, where each column holds an independent stochastic quantization of w^{(t)}. This structure will be important in ensuring the convergence of the model. Parameter p is selected to be sufficiently large to avoid wrap-around in computations. Its value depends on the bitwidth of the machine as well as the number of additive and multiplicative operations. For example, in a 64-bit implementation, we select p=15485863 (the largest prime with 24 bits) as detailed in our experiments.

Phase 2: Encoding and Secret Sharing. In the second phase, the master partitions the quantized dataset X into K submatrices and encodes them using the recently proposed Lagrange coding technique ([48]), which we will describe in detail in Section 2.3.2. It then sends to worker i∈[N] a coded submatrix

$${\tilde{X}}_{i} ∈ {𝔽}_{p}^{\frac{m}{K} \times d} .$$

As we will illustrate later, this encoding ensures that the coded matrices do not leak any information about the true dataset, even if T workers collude. In addition, the master has to ensure the weight estimations sent to the workers at each iteration do not leak information about the dataset. This is because the weights updated via (3) carry information about the whole training set, and sending them directly to the workers may breach privacy. In order to prevent this, at iteration t, master also quantizes the current weight vector w(t) to the finite field and encodes it again using Lagrange coding.

Phase 3: Polynomial Approximation and Local Computations. In the third phase, each worker performs the computations using its local storage and sends the result back to the master. We note that the workers perform the computations over the encoded data as if they were computing over the true dataset. That is, the structure of the computations are the same for computing over the true dataset versus computing over the encoded dataset. A major challenge is that Lagrange coding is designed for distributed polynomial computations. However, the computations in the training phase are not polynomials due to the sigmoid function. We overcome this by approximating the sigmoid with a polynomial of a selected degree r. This allows us to represent the gradient computations in terms of polynomials that can be computed locally by each worker.

Phase 4: Decoding and Model Update. The master collects the results from a subset of fastest workers and decodes the gradient over the finite field. Finally, master converts the decoded gradients to the real domain, updates the weight vector, and secret shares it with workers for the next round.

We next provide the details of each phase. The overall algorithm of CodedPrivateML, and each of its four phases, are also presented in Appendix A.1 of supplementary materials.

2.3.1. Quantization

We consider an element-wise lossy quantization scheme for the dataset and weights. For quantizing the dataset X∈R^{m×d}, we use a simple deterministic rounding technique:

$$Round ( x ) = \{ \begin{matrix}⌊ x ⌋ & if x - ⌊ x ⌋ < 0.5 \\ ⌊ x ⌋ + 1 & otherwise\end{matrix} \qquad ( 2.5 )$$

where └x┘ is the largest integer less than or equal to x We define the quantized dataset as

$$\overline{X} {=}^{Δ} φ ( Round ( {2}^{{l}_{x}} \cdot X ) ) \qquad ( 2.6 )$$

where the rounding function from (5) is applied element-wise to the elements of matrix X and lx is an integer parameter that controls the quantization loss. Function φ: Z→Fp is a mapping defined to represent a negative integer in the finite field by using two's complement representation,

$$φ ( x ) = \{ \begin{matrix}x & if x \geq 0 \\ p + x & if x < 0\end{matrix} \qquad ( 2.7 )$$

Note that the domain of (6) is

$$[ - \frac{p - 1}{{2}^{( {l}_{x} + 1 )}} , \frac{p - 1}{{2}^{( {l}_{x} + 1 )}} ] .$$

To avoid a wrap-around which may lead to an overflow error, prime p should be large enough, i.e., p≥2^{I}^{ₓ}⁺¹ max{|X_{i,j}|}+1.

At each iteration, master also quantizes the weight vector w^{(t)} from real domain to the finite field. This proves to be a challenging task as it should be performed in a way to ensure the convergence of the model. Our solution to this is a quantization technique inspired by ([79]-[80]). Initially, we define a stochastic quantization function:

$$Q ( x ; {l}_{w} ) {=}^{Δ} φ ( {Round}_{stoc} ( {2}^{{l}_{w}} \cdot x ) ) \qquad ( 2.8 )$$

where I_{w} is an integer parameter to control the quantization loss. Round_{stoc}: R→Z is a stochastic rounding function:

$${Round}_{stoc} ( x ) = \{ \begin{matrix}⌊ x ⌋ & with prob . 1 - ( x - ⌊ x ⌋ ) \\ ⌊ x ⌋ + 1 & with prob . x - ⌊ x ⌋\end{matrix}$$

The probability of rounding x to └x┘ is proportional to the proximity of x to └x┘ so that stochastic rounding is unbiased (i.e., E[Round_{stoc}(x)]=x).

For quantizing the weight vector w^{(t)}, the master creates r independent quantized vectors:

$${\overline{w}}^{( t ) , j} {=}^{Δ} {Q}_{j} ( {w}^{( t )} ; {l}_{w} ) ∈ {𝔽}_{p}^{d \times 1} for j ∈ [ r ] \qquad ( 2.9 )$$

where the quantization function (8) is applied element-wise to the vector w^{(t)} and each Qⱼ(·; ·) denotes an independent realization of (8). The number of quantized vectors r is equal to the degree of the polynomial approximation for the sigmoid function, which we will describe later in Section 2.3.3. The intuition behind creating r independent quantizations is to ensure that the gradient computations performed using the quantized weights are unbiased estimators of the true gradients. As detailed in Section 2.4, this property is fundamental for the convergence analysis of our model. The specific values of parameters Iₓ and I_{w} provide a trade-off between the rounding error and overflow error. In particular, a larger value reduces the rounding error while increasing the chance of an overflow. We denote the quantization of the weight vector w^{(t)} as

W̅^{(t)}=[w̅^{(t),1}. . . w̅^{(t),r}] (2.10)

by arranging the quantized vectors from (9) to matrix form.

2.3.2. Encoding and Secret Sharing

The master first partitions the quantized dataset X into K submatrices X=[X̅₁^{T} . . . X̅_{K}^{T}], where

$${\overline{X}}_{i} ∈ {𝔽}_{p}^{\frac{m}{K} \times d}$$

for iϵ[K]. It also selects K+T distinct elements β₁, . . . , B_{K+T} from Fₚ. It then employees Lagrange coding ([48]) to encode the dataset. More specifically, it finds a polynomial u:

$${𝔽}_{p} -> {𝔽}_{p}^{\frac{m}{K} \times d}$$

of degree at most K+T−1 such that u(βᵢ)=X̅ᵢ for i∈[K] and u(βᵢ)=Zᵢ for i∈{K+1, . . . , K+T} where Zᵢ's are chosen uniformly at random from

$${𝔽}_{p}^{\frac{m}{K} \times d}$$

(the role Zᵢ's is to mask the dataset and provide privacy against up to T colluding workers). This is accomplished by letting u be the respective Lagrange interpolation polynomial

$$u ( z ) {=}^{Δ} {\sum }_{j ∈ [ K ]} {\overline{X}}_{j} \cdot {\prod }_{k ∈ [ K + T ] \backslash \{ j \}} \frac{z - {β}_{k}}{{β}_{j} - {β}_{k}} + {\sum }_{j = K + 1}^{K + T} {Z}_{j} \cdot {\prod }_{k ∈ [ K + T ] \backslash \{ j \}} \frac{z - {β}_{k}}{{β}_{j} - {β}_{k}} . \qquad ( 2.11 )$$

Master then selects N distinct elements {αᵢ}_{i∈[N]} from [symbol] ₚ such that {αᵢ}_{i∈[N]}∩{βⱼ}_{j∈{K}}=Ø, and encodes the dataset by letting \tilde{X}ᵢ=u(αᵢ) for i∈[N]. By defining an encoding matrix U=[u₁ . . . u_{N}]∈ [symbol] ₚ^{(K+T)×N} whose (i, j)th element is given by

$${u}_{ij} = {Σ}_{l ∈ [ K + T ] \{ i \}} \frac{{α}_{j} - {β}_{l}}{{β}_{i} - {β}_{l}} ,$$

one can also represent the encoding of the dataset as,

\tilde{X}ᵢ=u(αᵢ)=(X̅₁, . . . ,X̅_{K},Z_{K+1}, . . . ,Z_{K+T})·uᵢ (2.12)

At iteration t, the quantized weights W̅^{(t)} are also encoded using a Lagrange interpolation polymer,

$$u ( z ) {=}^{Δ} {\sum }_{j ∈ [ K ]} {\overline{W}}^{( t )} \cdot {\prod }_{k ∈ [ K + T ] \backslash \{ j \}} \frac{z - {β}_{k}}{{β}_{j} - {β}_{k}} + {\sum }_{j = K + 1}^{K + T} {V}_{j} \cdot {\prod }_{k ∈ [ K + T ] \backslash \{ j \}} \frac{z - {β}_{k}}{{β}_{j} - {β}_{k}} . \qquad ( 2.13 )$$

where Vⱼ for j∈[K+1, K+T] are chosen uniformly at random from [symbol] ₚ^{d×r}. The coefficients β₁, . . . , β_{K+T} are the same as the ones in (11). We note that the polynomial in (13) has the property v(βᵢ)=W̅^{(t)} for i∈[K].

The master then encodes the quantized weight vector by using the same evaluation points {αᵢ}_{i∈[N]}. Accordingly, the weight vector is encoded as

\tilde{W}ᵢ^{t}=v(αᵢ)=(W̅^{(t)}, . . . ,W̅^{(t)},V_{K+1}, . . . ,V_{K+T})·uᵢ (2.14)

For i∈[N], using the encoding matrix U from (12). The degree of the polynomials u(z) and v(z) are both K+T−1.

2.3.3. Polynomial Approximation and Local Computation

Upon receiving the encoded (and quantized) dataset and weights, workers should proceed with gradient computations. However, a major challenge is that Lagrange coding is originally designed for polynomial computations, while the gradient computations that the workers need to do are not polynomials due to the sigmoid function. Our solution is to use a polynomial approximation of the sigmoid function,

$$\hat{g} ( z ) = {\sum }_{i = 0}^{r} {c}_{i} {z}^{i} , \qquad ( 2.15 )$$

where r and cᵢ denotes the degree and coefficients of the polynomial, respectively. The coefficients are obtained by fitting the sigmoid function via least squares estimation.

Using this polynomial approximation we can rewrite (3) as,

$${w}^{( t + 1 )} = {w}^{( t )} - \frac{η}{m} {\overline{X}}^{T} ( \hat{g} ( \overline{X} \times {w}^{( T )} ) - y ) . \qquad ( 2.16 )$$

where X is the quantized version of X, and ĝ(·) operates element-wise over the vector X̅×w^{(t)}.

Another challenge is to ensure the convergence of weights. As we detail in Section 2.4, this necessitates the gradient estimations to be unbiased using the polynomial approximation with quantized weights. We solve this by utilizing the computation technique from Lemma 4:1 in ([79]) using the quantized weights formed in Section 2.3.1. Specifically, given a degree r polynomial from (15) and r independent quantizations from (10), we define a function,

$$\overline{g} ( \overline{X} , {\overline{W}}^{( t )} ) {=}^{Δ} {\sum }_{i = 0}^{r} {c}_{i} {\prod }_{j \leq i} ( \overline{X} \times {\overline{w}}^{( t ) , j} ) \qquad ( 2.17 )$$

where the product Π_{j≤i} operates element-wise over the vectors (X̅×w̅^{(t)j}) for j≤i. Lastly, we note that (17) is an unbiased estimator of ĝ(X̅×w̅^{(t)}),

E[g̅(X̅,W̅^{(t)})]ĝ(X̅×w^{(t)}) (2.18)

where ĝ(·) acts element-wise over the vector X̅×w̅^{(t)}, and the result follows from the independence of quantizations.

$${w}^{( t + 1 )} = {w}^{( t )} - \frac{η}{m} {\overline{X}}^{T} ( \overline{g} ( \overline{X} , {\overline{W}}^{( t )} ) - y ) . \qquad ( 2.19 )$$

Using (17), we rewrite the update equations from (16) in terms of the quantized weights, The computations are then performed at each worker locally. In particular, at each iteration, worker i∈[N] locally computes ƒ:

$${𝔽}_{p}^{\frac{m}{K} \times d} \times {𝔽}_{p}^{d \times r} -> {𝔽}_{p}^{d}$$

ƒ(\tilde{X}ᵢ,\tilde{W}ᵢ^{(t)})=\tilde{X}ᵢ^{T}g̅(\tilde{X}ᵢ,\tilde{W}ᵢ^{(t)}) (2.20)

using \tilde{X}ᵢ and \tilde{W}ᵢ^{(t)} and sends the result back to the master. This computation is a polynomial function evaluation in finite field arithmetic and the degree of ƒ is deg(ƒ)=2r+1.

2.3.4. Decoding and Model Update

After receiving the evaluation results in (20) from a sufficient number of workers, master decodes {ƒX̅ₖ, W̅^{(t)})}_{k∈[K]} over the finite field. The minimum number of workers the master needs to wait for is termed the recovery threshold of the system and is equal to (2r+1)(K+T−1)+1 as we demonstrate in Section 2.4.

We now proceed to the details of decoding. By construction of the Lagrange polynomials in (11) and (13), one can define a univariate polynomial h(z)=ƒ(u(z), v(z)) such that

$$\begin{matrix}h ( {β}_{i} ) = f ( u ( {β}_{i} ) , v ( {β}_{i} ) ) \\ = f ( {\overline{X}}_{i} , {\overline{W}}^{( t )} ) \\ = {\overline{X}}_{i}^{T} \overline{g} ( {\overline{X}}_{i} , {\overline{W}}^{( t )} )\end{matrix} \qquad ( 2.21 )$$

for i∈[K]. On the other hand, from (20), the computation result from worker i equals to

$$\begin{matrix}h ( {α}_{i} ) = f ( u ( {α}_{i} ) , v ( {α}_{i} ) ) \\ = f ( {\tilde{X}}_{i} , {\tilde{W}}_{i}^{( t )} ) \\ = {\tilde{X}}_{i}^{T} \overline{g} ( {\tilde{X}}_{i} , {\tilde{W}}^{( t )} )\end{matrix} \qquad ( 2.22 )$$

The main intuition behind the decoding process is to use the computations from (2.22) as evaluation points h(αᵢ) to interpolate the polynomial h(z). Specifically, the master can obtain all coefficients of h(z) from (2r+1)(K+T−1)+1 evaluation results as long deg(h(z)) (2r+1)(K+T−1). After h(z) is recovered, the master can recover (21) by computing h(βᵢ) for i∈[K] and evaluating

$${\sum }_{k = 1}^{K} f ( {\overline{X}}_{k} , {\overline{W}}^{( t )} ) = {\sum }_{k = 1}^{K} {\overline{X}}_{k}^{T} \overline{g} ( {\overline{X}}_{k} , {\overline{W}}^{( t )} ) = {\overline{X}}^{T} \overline{g} ( \overline{X} , {\overline{W}}^{( t )} ) \qquad ( 2.23 )$$

Lastly, master converts (23) from the finite field to the real domain and updates the weights according to (19). This conversion is attained by the function,

Qₚ⁻¹(x̅;l)=2⁻¹·ϕ⁻¹(x̅) (2.24)

where we let l=lₓ+r(lₓ+l_{w}), and ϕ⁻¹: [symbol] ₚ→ [symbol] defined as follows,

$${φ}^{- 1} ( \overline{x} ) = \{ \begin{matrix}\overline{x} & if 0 \leq \overline{x} < \frac{p - 1}{2} \\ \overline{x} - p & if \frac{p - 1}{2} \leq \overline{x} < p\end{matrix} \qquad ( 2.25 )$$

2.4. Convergence and Privacy Guarantees

Consider the cost function (1) that we aim to minimize in logistic regression when dataset X is replaced with the quantized dataset X̅ using (6). Also denote w* as the optimal weight vector that minimizes (1) when ŷᵢ=g(x̅ᵢ·w), where x̅ᵢ is row i of X̅. In this section we prove that CodedPrivateML would guarantee convergence to the optimal model parameters (i.e., w*) while maintaining the privacy of the dataset against colluding workers. Recall that the model update at the master node in CodedPrivateML follows (19), which is

$${w}^{( t + 1 )} = {w}^{( t )} - \frac{η}{m} {\overline{X}}^{T} ( \overline{g} ( \overline{X} , {\overline{W}}^{( t )} ) - y ) . \qquad ( 2.26 )$$

We first state a lemma, which is proved in Appendix A.2 in supplementary materials.

Lemma 1. Let

$${P}^{( t )} {=}^{Δ} \frac{1}{m} {\overline{X}}^{T} ( \overline{g} ( \overline{X} , {\overline{W}}^{( t )} ) - y ) . \qquad$$

denote the gradient computation using the quantized weights W̅^{(t)} in CodedPrivateML. Then we have
(Unbiasedness) Vector p^{(t)} is an asymptotically unbiased estimator of the true gradient. [symbol] [p^{(t)}]=∇C(w^{(t)})+ϵ(r), and ϵ(r)→0 as r→∞ where r is the degree of polynomial in (15) and expectation is taken with respect to the quantization errors,
(Variance bound)

$$𝔼 [ {‖ {p}^{( t )} - E [ {p}^{( t )} ] ‖}_{2}^{2} ] \leq \frac{1}{{2}^{- {l}_{w}} {m}^{2}} {‖ \overline{X} ‖}_{F}^{2} {=}^{Δ} {σ}^{2}$$

where ∥·∥₂ and ∥·∥_{F} denote the l₂−norm and Frobenius norm, respectively.

We also need the following basic lemma, which is proved in Appendix A.3 of supplementary materials.

Lemma 2. The gradient of the cost function (1) with quantized dataset X (as defined in (6)) is L-Lipschitz with

Lemma 2. The gradient of the cost function (1) with quantized dataset X̅ (as defined in (6)) is L-Lipschitz with

∥∇C(w)−∇C(w′)∥≤L∥w−w′∥ (2.27)

We now state our main theorem for CodedPrivateML.

Theorem 1. Consider the training of a logistic regression model in a distributed system with N workers using CodedPrivateML with dataset X=(Xᵢ, . . . , X_{K}), initial weight vector w⁽⁰⁾, and constant step size η=1/L (where L is defined in Lemma 2). Then, CodedPrivateML guarantees
(Convergence)

$$𝔼 [ C ( \frac{1}{J} {\sum }_{t = 0}^{J} {w}^{( t )} ) ] - C ( {w}^{*} ) \leq \frac{‖ {w}^{( 0 )} - {w}^{*} ‖}{2 η J} + η {σ}^{2}$$

in J interations, where σ² is given in Lemma 1
(Privacy) X remains information—
   theoretically private against any T colluding workers, i.e., I(X; [symbol] , [symbol] )=0, ∀ [symbol] ⊂[N]. | [symbol] |≤≤T as long as we have N≥(2r+1)(K+T−1)+1, where r is the degree of the polynomial approximation in (15).

Remark 2. Theorem 1 reveals an important trade-off be-tween privacy and parallelization in CodedPrivateML. The parameter K reflects the amount of parallelization in CodedPrivateML, since the computation load at each worker node is proportional to 1/K-th of the dataset. The pa-rameter T also reflects the privacy threshold in CodedPrivateML. Theorem 1 shows that, in a cluster with N workers, we can achieve any K and T as long as N≥(2r+1)(K+T−1)+1. This condition further implies that, as the number of workers N increases, the parallelization (K) and privacy threshold (T) of CodedPrivateML can also increase linearly, leading to a scalable solution.

Remark 3. Theorem 1 also applies to the simpler linear regression problem. The proof follows the same steps.

Proof. (Convergence) First, we show that the master can decode X g̅(X, W) over the finite field as long as N≥(2r+1)(K+T−1)+1. As described in Sections 2.3.3 and 2.3.4, given the polynomial to approximation of the sigmoid function in (15), the degree of h(z) in (21) is a most (2r+1)(K+T−1). The decoding process uses the computations from workers as evaluation points h(αᵢ) to interpolate the polynomial h(z). The master can obtain all coefficients of h(z) as long as the master collects at least deg h(z)+1≤(2r+1)(K+T−1)+1 evaluation results of h(αi). After h(z) is recovered, the master can decode the sub-gradient Xᵢ g⁻(Xᵢ, W) by computing

Next, we consider the update equation in CodedPrivateML (see (26)) and prove its convergence to w*. From the L—Lipschitz continuity of ∇C(w) stated in Lemma 2, we have

$$C ( {w}^{( t + 1 )} ) \leq C ( {w}^{( t )} ) + 〈 ∇ C ( {w}^{( t )} ) , {w}^{( t + 1 )} - {w}^{( t )} 〉 + \frac{L}{2} {‖ {w}^{( t + 1 )} - {w}^{( t )} ‖}^{2} = C ( {w}^{( t )} ) - η 〈 ∇ C ( {w}^{( t )} ) , {p}^{( t )} 〉 + \frac{L}{2} {‖ {p}^{( t )} ‖}^{2} ,$$

where [symbol] ,·, [symbol] is the inner product. By Taking the expectation with respect to the quantization noise on both sides,

$$\begin{matrix}𝔼 [ C ( {w}^{( t + 1 )} ) ] \leq C ( {w}^{( t )} ) - η {‖ ∇ C ( {w}^{( t )} ) ‖}^{2} + \frac{L {η}^{2}}{2} ( {‖ ∇ C ( {w}^{( t )} ) ‖}^{2} + {σ}^{2} ) \leq C ( {w}^{( t )} ) - η ( 1 - L η / 2 ) {‖ ∇ C ( {w}^{( t )} ) ‖}^{2} + L {η}^{2} {σ}^{2} / 2 \leq C ( {w}^{( t )} ) - η / 2 {‖ ∇ C ( {w}^{( t )} ) ‖}^{2} + η {σ}^{2} / 2 & ( 2.28 ) \\ \leq C ( {w}^{*} ) + 〈 ∇ C ( {w}^{( t )} ) , {w}^{( t )} - {w}^{*} 〉 - \frac{η}{2} {‖ ∇ C ( {w}^{( t )} ) ‖}^{2} + η {σ}^{2} / 2 & ( 2.29 ) \\ \leq C ( {w}^{*} ) + 〈 𝔼 [ {p}^{( t )} ] , {w}^{( t )} - {w}^{*} 〉 - \frac{η}{2} 𝔼 [ {‖ {p}^{( t )} ‖}^{2} ] + η {σ}^{2} = C ( {w}^{*} ) + η {σ}^{2} + {𝔼 [ 〈 {p}^{( t )} , {w}^{( t )} - {w}^{*} 〉 - \frac{η}{2} ‖ {p}^{( t )} ) ‖}^{2} ] = C ( {w}^{*} ) + {ησ}^{2} + \frac{1}{2 η} ( {‖ {w}^{( t )} - {w}^{*} ‖}^{2} - {‖ {w}^{( t + 1 )} - {w}^{*} ‖}^{2} ) & ( 2.30 )\end{matrix}$$

where (28) follows from Lη≤1, (29) from the convexity of C, and (30) holds since [symbol] [p^{(t)}]=V̅C(w)^{(t)}) and [symbol] [∥p^{(t)}∥²]−∥∇C(w)^{(t)}∥²≤σ² from Lemma 1 with assuming the arbitrarily large r. Summing the above equations for t=0, . . . , J−1, we have

$${\sum }_{t = 0}^{J - 1} ( 𝔼 [ C ( {w}^{( t + 1 )} ) ] - C ( {w}^{*} ) ) \leq \frac{1}{2 η} ( {‖ {w}^{( 0 )} - {w}^{*} ‖}^{2} - {‖ {w}^{( J )} - {w}^{*} ‖}^{2} ) + J η {σ}^{2} \leq \frac{{‖ {w}^{( 0 )} - {w}^{*} ‖}^{2}}{2 η} + J η {σ}^{2} .$$

Finally, since C is convex, we observe that

$$𝔼 [ C ( \frac{1}{J} {\sum }_{t = 0}^{J} {w}^{( t )} ) ] \leq {\sum }_{t = 0}^{J - 1} ( 𝔼 [ C ( {w}^{( t + 1 )} ) ] - C ( {w}^{*} ) ) \leq \frac{{‖ {w}^{( 0 )} - {w}^{*} ‖}^{2}}{2 η J} + η {σ}^{2} ,$$

which completes the proof of convergence.
(Privacy) Proof of T-privacy is deferred to Appendix A.4 in the supplementary materials.

3.5. Experiments

We now experimentally demonstrate the impact of CodedPri-vateML, and make comparisons with existing cryptographic approaches to the problem. Our focus is on training a logistic regression model for image classification, while the computation load is distributed to multiple machines on the Amazon EC2 Cloud Platform.

Setup. We train the logistic regression model from (1) for binary image classification on the MNIST dataset ([60]) to experimentally examine two things: the accuracy of CodedPrivateML and the performance gain in terms of training time. The size of dataset is (m, d)=(12396, 1568)1. Experiments with additional dataset sizes are provided in Appendix A.6 of supplementary material.

We implement CodedPrivateML using the MPI4Py ([81]) message passing interface on Python. Computations are performed in a distributed manner on Amazon EC2 clusters using m3.xlarge machine instances.

We then compare CodedPrivateML with the MPC-based approach when applied to our problem. In particular, we implement a BGW-style construction ([50]) based on Shamir's secret sharing scheme ([57]) where we secret share the dataset among N workers who proceed with a multiround protocol to compute the gradient. We further incorporate the quantization and approximation techniques introduced here as BGW-style protocols are also bound to arithmetic operations over a finite field. See Appendix A.5 of supplementary materials for additional detail.

TABLE 1
Breakdown of the total run time with N = 40 workers.

| | Encode | Comm. | Comp. | Total run |
|---|---|---|---|---|
| Protocol | time (s) | time (s) | time (s) | time (s) |
| MPC approach | 845.55 | 49.51 | 3457.99 | 4304.60 |
| CodedPrivateML (Case 1) | 50.97 | 3.01 | 66.95 | 126.20 |
| CodedPrivateML (Case 2) | 90.65 | 6.45 | 110.97 | 222.50 |

CodedPrivateML parameters. There are several system parameters in CodedPrivateML that should be set. Given that we have a 64-bit implementation, we select the field size tobe p=15485863, which is the largest prime with 24 bits to avoid the overflow on intermediate multiplication. We then optimize the quantization parameters, 1× in (6) and lw in (9), by taking into account the trade-off between the rounding and overflow error. In particular, we choose 1×=2 and lw=4. We also need to set the parameter r, the degree of the polynomial for approximating the sigmoid function. We consider both r=1 and r=2 and as we show later empirically observe that a degree one approximation provides very good accuracy. We finally need to select T (privacy threshold) and K (amount of parallelization) in CodedPrivateML. As stated in Theorem 1, these parameters should satisfy N≥(2r+1)(K+T−1)+1. Given our choice of r=1, we consider two cases
Case 1 (maximum parallelization). All resources to parallelization by setting

$$K = ⌊ \frac{N - 1}{3} ⌋$$

### and T=1,

Case 2 (equal parallelization and privacy). The re-sources are split equally by setting

$$K = T = ⌊ \frac{N + 2}{6} ⌋ ,$$

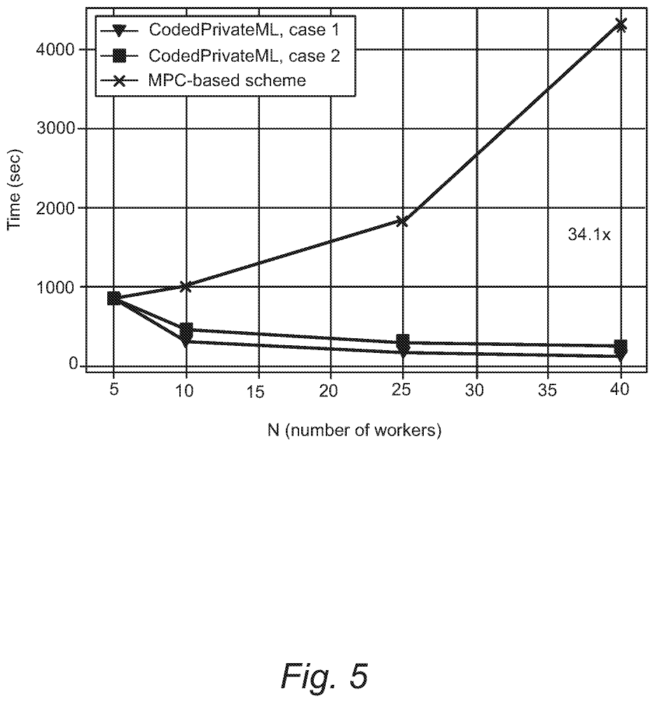

Training time. In the first set of experiments, we measure the training time while increasing the number of workers N gradually. The results are demonstrated in FIG. 5. We make the following observations. 2
CodedPrivateML provides substantial speedup over the MPC approach, in particular, up to 34.1× and 19.4× speedup in Cases 1 and 2, respectively. The breakdown of the total run time for one scenario is shown in Table 2.1. One can note that CodedPrivateML provides significant improvement in all three categories of dataset encoding and secret sharing; communication time between the workers and the master; and computation time. One reason for this is that, in MPCbased schemes, size of the secret shared dataset at each worker is the same as the original dataset, while in CodedPrivateML it is 1/K-th of the dataset. This provides a large parallelization gain for CodedPrivateML. The other reason is the communication complexity of MPC-based schemes. We provide the results for more scenarios in Appendix A.6 of supplementary material.
We note that the total run time of CodedPrivateML decreases as the number of workers increases. This is again due to the parallelization gain of CodedPrivateML (i.e., increasing K while N increases). This parallelization gain is not achievable in MPC-based scheme, since the whole computation has to be repeated by all players who take part in MPC. We should however point out that MPC-based scheme could attain a higher privacy threshold (T=N/2−1), while CodedPrivateML can achieve T

$$T = ⌊ \frac{N + 2}{6} ⌋$$

### (Case 2).

TABLE 2.1
Breakdown of the total run time with N = 40 workers.

| | Encode | Comm. | Comm. | Comm. |
|---|---|---|---|---|
| Protocol | time (s) | time (s) | time (s) | time (s) |
| MPC approach | 845.55 | 49.51 | 3457.99 | 4304.60 |
| CodedPrivateML (Case 1) | 50.97 | 3.01 | 66.95 | 126.20 |
| CodedPrivateML (Case 1) | 90.65 | 6.45 | 110.97 | 222.50 |

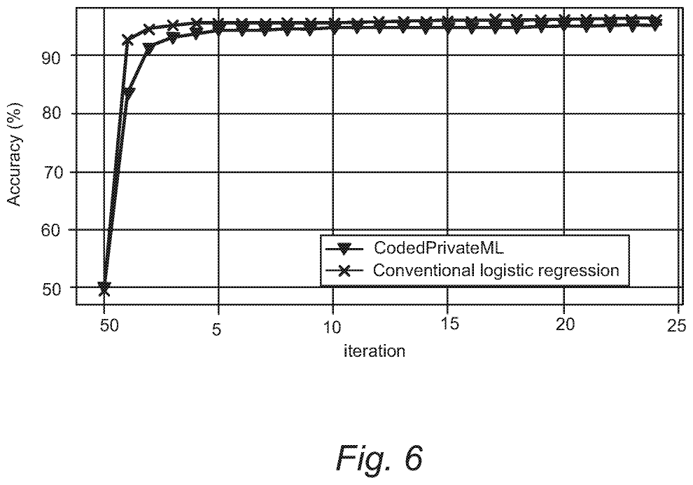

Accuracy. We also examine the accuracy and convergence of CodedPrivateML in the experiments. FIG. 6 illustrates the test accuracy of the binary classification problem be-tween digits 3 and 7. With 25 iterations, the accuracy of CodedPrivateML with degree one polynomial approximation and conventional logistic regression are 95.04% and 95.98%, respectively. This result shows that CodedPri-vateML guarantees almost the same level of accuracy, while being privacy preserving. Our experiments also show that CodedPrivateML achieves convergence with comparable rate to conventional logistic regression. Those results are provided in Appendix A.6 in the supplementary materials.

2.6 Appendix-Supplementary Materials

2.A.1. Algorithms

The overall procedure of the CodedPrivateML protocol is given in Algorithm 1. Procedures for individual phases are shown in Algorithms 2-5 for Sections 2.3.1-2.3.4, respectively.

Algorithm 1 CodedPrivateML

input Dataset X, y
output Model parameters (weights) w^{(J)}

| | |
|---|---|
| 1: | (Master) Compute the quantized dataset X̅ using (6). |
| 2: | (Master) Form the encoded matrices {\tilde{X}ᵢ}_{i∈[N]} in (12). |
| 3: | (Master) Send \tilde{X}ᵢ to worker i ∈ [N]. |
| 4: | (Master) Initialize the weights w⁽⁰⁾ ∈ [symbol] ^{d×1}. |
| 5: | for iteration t = 0, . . . , J − 1 do |
| 6: | (Master) Find the quantized weights W̅^{(t)} from (10). |
| 7: | (Master) Encode W̅^{(t)} into {\tilde{W}ᵢ^{(t)}}_{i∈[N]} using (14). |
| 8: | (Master) Send \tilde{W}ᵢ^{(t)} to worker i ∈ [N]. |
| 9: | (Worker i = 1, . . . , N) Compute f (\tilde{X}ᵢ, \tilde{W}ᵢ^{(t)}) from (20) and |
| | send the result back to the master. |
| 10: | if Master received results from (2r + 1)(K + T − 1) + 1 workers |
| | then |
| 11: | (Master) Decode {f(X̅ₖ, W̅ₖ^{(t)})}_{k∈[K]} via polynomial interpola- |
| | tion from the received results. |
| 12: | end if |
| 13: | (Master) Compute Σₖ₌₁^{K} f(X̅ₖ, W̅ₖ^{(t)}) in (23) and convert it from |
| | finite field to real domain using (24). |
| 14: | (Master) Update the weight vector via (19). |
| 15: | end for |
| 16: | return w^{(J)} |

Algorithm 2 Quantization

input Dataset X and weights w^{(t)}
output Quantized dataset X̅ and weights W̅^{(t)}

| | |
|---|---|
| 1: | (Master) Compute the quantized dataset from (6), |
| | X̅ = ϕ (Round(2^{l}^{ₓ} · X)) |
| | using function Round(·) from (5) and ϕ(·) from (7). |
| 2: | (Master) Compute r independent stochastic quantizations |
| | of vector w^{(t)} given in (9), |
| | ${\overline{w}}^{( t ) , j} {=}^{Δ} {Q}_{j} ( {w}^{( t )} ; {l}_{w} ) , j = 1 , … , r ,$ |
| | by applying the quantization function (8) element-wise |
| | over the vector w^{(t)}. |
| 3: | (Master) Construct the quantized weight matrix in (10), |
| | W̅^{(t)} = [w̅^{(t),1} . . . w̅^{(t),r}] |
| | using the quantized vectors w̅^{(t),j} for j = 1, . . . , r. |
| 4: | return X̅ and W̅^{(t)} |

Algorithm 3 Encoding and Secret Sharing

input Quantized dataset X̅ and weights W̅^{(t)}
output Encoded dataset \tilde{X}ᵢ and weights \tilde{W}ᵢ^{(t)} for i ∈ [N]

| | |
|---|---|
| 1: | (Master) Partition the quantized dataset X̅ into K sub-matrices X̅ = |
| | [X̅₁^{T} . . . X̅_{K}^{T}]^{T}. |
| 2: | (Master) Construct the encoded matrices \tilde{X}ᵢ for i ∈ [N] as in (12) |
| | using the Lagrange polynomial from (11). |
| 3: | (Master) Construct the encoded weights \tilde{W}ᵢ^{(t)} for i ∈ [N] as in (14) |
| | using the Lagrange polynomial from (13). |
| 4: | (Master) Send \tilde{X}ᵢ and \tilde{W}ᵢ^{(t)} to worker i, where i ∈ [N]. |

Algorithm 4 Polynomial Approximation and Local
Computations

input Encoded dataset \tilde{X}ᵢ and weights \tilde{W}ᵢ^{(t)} for i ∈ [N]
output Computation results j (\tilde{X}ᵢ, \tilde{W}ᵢ^{(t)}) for i ∈ [N]

| | |
|---|---|
| 1: | (Master) Find the polynomial approximation coefficients {cᵢ}ᵢ₌₀^{r} |
| | from (15), by fitting the sigmoid function to a degree r poly- |
| | nomial via least squares. |
| 2: | (Master) Send the coefficients {cᵢ}ᵢ₌₀^{r} to all workers. |
| 3: | (Worker i = 1, . . . , N) Locally compute the function, |
| | f(\tilde{X}ᵢ, \tilde{W}ᵢ^{(t)}) = \tilde{X}ᵢ^{T} g̅(\tilde{X}ᵢ, \tilde{W}ᵢ^{(t)}) |
| | using \tilde{X}ᵢ and \tilde{W}ᵢ^{(t)} as given in (20), and send the result back to |
| | the master. |

Algorithm 5 Decoding and Model Update

input Computation results f (\tilde{X}ᵢ, \tilde{W}ᵢ^{(t)}) from fastest (2r + 1)

| | (K + T − 1) + 1 workers |
|---|---|
| | output Updated weights w^{(t+1)} |
| 1: | (Master) Collect the results from (2r + 1)(K + T − 1) + 1 |
| | fastest workers. |
| 2: | (Master) Decode {f(X̅ₖ, W̅^{(t)})}_{k∈[K]} from (21) |
| | through polynomial interpolation using the computations |
| | f(\tilde{X}ᵢ, \tilde{W}ᵢ^{(t)}) from (22) that are received from |
| | (2r + 1)(K + T − 1) + 1 workers. |
| 3: | (Master) Compute Σₖ₌₁^{K} f(X̅ₖ, W̅^{(t)}) = |
| | X̅^{T}g̅(X̅, W̅^{(t)}) and convert the result from finite field |
| | to the real domain using (24). |
| 4: | (Master) Update the weight vector according to (19), |
| | ${w}^{( t + 1 )} = {w}^{( t )} - \frac{η}{m} {\overline{X}}^{T} ( \overline{g} ( \overline{X} , {\overline{W}}^{( t )} ) - y ) .$ |
| 5: | return w^{(t+1)} |

2.A.2. Proof of Lemma 1

(Unbiasedness) Given X̅, we have

$$\begin{matrix}𝔼 [ {p}^{( t )} ] = \frac{1}{m} {\overline{X}}^{T} ( 𝔼 [ \overline{g} ( \overline{X} , {\overline{W}}^{( t )} ) ] - y ) \\ = \frac{1}{m} {\overline{X}}^{T} ( \hat{g} ( \overline{X} \times {w}^{( t )} ) - y )\end{matrix} \qquad ( 3.31 )$$

where (31) follows (18). Then, we obtain

$$𝔼 [ {p}^{( t )} ] - ∇ C ( {w}^{( t )} ) = \frac{1}{m} {\overline{X}}^{T} ( \hat{g} ( \overline{X} \times {w}^{( t )} ) - g ( \overline{X} \times {w}^{( t )} ) ) . \qquad ( 3.32 )$$

Assume w^{(t)} is constrained such that |w^{(t)}|≤R for some real value R∈ [symbol] (([79], Lemma 4.2). Then, from the Weierstrass approximation theorem ([82]), for every ϵ>0, there exists a polynomial that approximates the sigmoid arbitrarily well, i.e., |ĝ(x)−g(x)|≤ϵ for all x in the constrained interval. Therefore, given X̅, there exists a polynomial making the norm of (32) arbitrarily small.

(Variance bound) The variance of p^{(t)} satisfies,

$$\begin{matrix}𝔼 [ {‖ {p}^{( t )} - 𝔼 [ {p}^{( t )} ] ‖}_{2}^{2} ] = \frac{1}{{m}^{2}} 𝔼 [ ‖ {\overline{X}}^{T} ( \overline{g} ( \overline{X} , {\overline{W}}^{( t )} ) - \\ { \hat{g} ( \overline{X} \times {w}^{( t )} ) ) ‖}_{2}^{2} ] \\ = \frac{1}{{m}^{2}} 𝔼 [ Tr ( {\overline{X}}^{T} {q}^{( t )} {q}^{( t ) T} \overline{X} ) ] \\ = \frac{1}{{m}^{2}} Tr ( {\overline{X}}^{T} 𝔼 [ {q}^{( t )} {q}^{( t ) T} ] \overline{X} )\end{matrix} \qquad ( 3.33 )$$

where Tr(·) denotes the trace of a matrix, and we let

$${q}^{( t )} {=}^{Δ} \overline{g} ( \overline{X} , {\overline{W}}^{( t )} ) - \hat{g} ( \overline{X} \times {w}^{( t )} ) .$$

From Lemma 4 of ([79]), we have that if i=j, otherwise

$$𝔼 [ {q}_{i}^{( t )} {q}_{j}^{( t )} ] \{ \begin{matrix}\leq {2}^{- 2 {I}_{w}} {( {\sum }_{k = 0}^{r} {{c}_{k} ( {\overline{x}}_{i} {w}^{( t )} )}^{k} )}^{2} \\ = 0\end{matrix} \qquad ( 3.34 )$$

where qᵢ^{(t)} denotes the i^{th} element of q^{(t)}.

Combining equations (33) and (34) with the fact that (Σₖ₌₀^{r} cₖ(X̅ᵢ·w^{(t)})^{k})²≈(g(x̅ᵢ w^{(t)}))²≤1 for all i∈{m}, we obtain

$$\begin{matrix}𝔼 [ {‖ {p}^{( t )} - 𝔼 [ {p}^{( t )} ] ‖}_{2}^{2} ] \leq \frac{1}{{2}^{- 2 {l}_{w}} {m}^{2}} Tr ( {\overline{X}}^{T} \overline{X} ) \\ = \frac{1}{{2}^{- 2 {l}_{w}} {m}^{2}} {‖ \overline{X} ‖}_{F}^{2} .\end{matrix}$$

A.3. Proof of Lemma 2

For the logistic regression cost function C(w), the Lipschitz constant L is less or equal than the largest eigenvalue of the Hessian ∇²(w) for all w and is given by

L=¼max{eig(X̅^{T}X̅)} (3.35)

2.A.4. Privacy Proof of Theorem 1

Let U^{top}∈ [symbol] ₚ^{K×N} and U^{bottom} ∈ [symbol] ₚ^{T×N} are the top and bottom submatrix of the encoding matrix U constructed in Section 2.3.2, respectively. From Lemma 2 of ([48]), U^{bottom} is an MDS matrix. Therefore, every T×T submatrix of U^{bottom} is invertible. For a colluding set of workers [symbol] ⊂[N] of size T, their received dataset satisfies

[symbol]

=X̅× [symbol] +Z× [symbol] (2.36)

where Z=(Z_{K}, . . . , Z_{K+T}), and [symbol] ∈ [symbol] ₚ^{K×T} and [symbol] ∈ [symbol] ₚ^{T×T} are the top and bottom submatrices which correspond to the columns in U that are indexed by [symbol] . Since [symbol] ∈ [symbol] ₚ^{T×T} is invertible, [symbol] is completely masked by the random matrix Z. Similarly, [symbol] is completely masked by the random matrix V=(V_{K+1}, . . . , V_{K+T}) for all t∈[J], where J is the total number of iterations.

Since [symbol] and [symbol] are completely masked by the random padding matrices, T colluding workers get no information about X̅, i.e., I(X̅; [symbol] , [symbol] )=0. Then, from the data-processing inequality ([83]),

$$I ( \overline{X} ; {\tilde{X}}_{𝒯} , {\{ {\tilde{W}}_{𝒯}^{( t )} \}}_{t ∈ [ j ]} ) \geq I ( X ; {\tilde{X}}_{𝒯} , {\{ {\tilde{W}}_{𝒯}^{( t )} \}}_{t ∈ [ j ]} ) \geq 0 \qquad ( 2.37 )$$

Therefore, I(X̅; [symbol] , [symbol] ) and the original dataset remains information-theoretically private against T colluding workers

2.A.5. Details of the Implemented MPC-based Scheme

We implement an MPC-based system with a similar privacy structure, that is, any collusions between T out of N workers do not reveal information (in an information-theoretic sense) about the dataset. To do so, we utilize the well-known BGW protocol, a secure MPC protocol that can compute polynomial evaluations privately, by ensuring collusions between up to T out of N workers do not leak information about the input variables ([50]). Due to the polynomial nature of the computations supported by the protocol, we again use polynomial approximation for the sigmoid function. The protocol utilizes Shamir's secret sharing scheme for secret sharing the input variables ([57]), which also requires the input variables to be represented in the finite field. Therefore, we again use our quantization technique to convert the dataset and weights from the real to finite domain. The system parameters used for quantization and polynomial approximation are selected to be the same as the ones used for CodedPrivateML.

In order to implement the MPC-based scheme in our problem, we encode the quantized dataset and weights using Shamir's secret sharing. For the (quantized) dataset X̅=[X̅₁^{T} . . . X̅_{K}^{T}]^{T} this is achieved by creating a random polynomial

Pᵢ(z)=X̅ᵢ+zRᵢ₁+ . . . +z^{T}R_{iT} (2.38)

for each i∈[K], where Rᵢⱼ for j∈[T] are i.i.d. uniformly distributed random matrices. Then, each worker is assigned a secret share of the dataset using the polynomial from (38). We note that in this setup each worker receives a share for every i∈[K]. Therefore, the total amount of data stored at each worker is equal to the size of the whole dataset X̅. A similar polynomial is created for secret sharing the quantized weights W̅^{(t)}.

The workers then perform addition and multiplication operations on the secret shared data. For performing an addition operation, each worker locally adds its own shares. At the end of this phase, each worker will hold a secret share corresponding to the addition of the original variables. For performing a multiplication operation, workers first multiply their shares locally. After this phase, the protocol requires a communication step to take place between the workers, in which workers create new shares. We implement this communication phase also using the MPI4Py message passing interface. One can reduce the number of communication rounds by using a vectorized form for operations involving vector products, and implementing a communication step between workers after each vectorized product. In our experiments, we implement this faster vectorized form. The protocol guarantees privacy against

$$⌊ \frac{N - 1}{2} ⌋$$

colluding workers ([50]). In our experiments, the time spent during the communication phase between workers is included in the reported computation time.

2. A.6. Additional Experiments

A.6.1. BREAKDOWN OF THE TOTAL RUN TIME FOR

Additional Scenarios

We present the breakdown of the run time when training is done by different number of workers, using the dataset from Section 2.5. Tables 2.2 and 2.3 demonstrate the corresponding results for N=10 and N=25 workers, respectively. One can note that, in all scenarios, CodedPrivateML provides significant improvement in all three categories of dataset encoding and secret sharing; communication time between the workers and the master; and computation time.

TABLE 2.2
Breakdown of the total run time with N = 10 workers

| | Encode | Comm. | Comp. | Total run |
|---|---|---|---|---|
| Protocol | time (s) | time (s) | time (s) | time (s) |
| MPC-based scheme | 53.87 | 11.71 | 957.12 | 1001.53 |
| CodedPrivateML (Case 1) | 21.86 | 3.31 | 259.54 | 303.13 |
| CodedPrivateML (Case 2) | 32.20 | 5.55 | 390.98 | 465.52 |

TABLE 2.3
Breakdown of the total run time with N = 25 workers.

| | Encode | Comm. | Comp. | Total run |
|---|---|---|---|---|
| Protocol | time (s) | time (s) | time (s) | time (s) |
| MPC-based scheme | 328.19 | 30.61 | 1492.44 | 1818.63 |
| CodedPrivateML (Case 1) | 33.27 | 3.06 | 97.46 | 144.77 |
| CodedPrivateML (Case 2) | 78.69 | 7.12 | 194.09 | 295.68 |

2.A.6.2. CONVERGENCE OF CODEDPRIVATEML

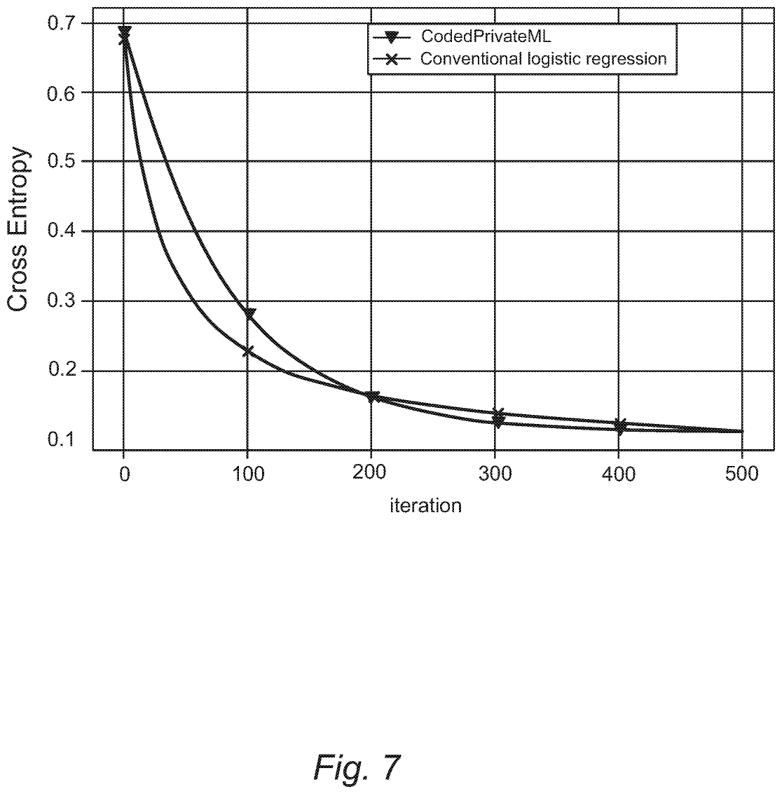

We also experimentally analyze the convergence behavior of CodedPrivateML. FIG. 7 presents the cross entropy loss for CodedPrivateML versus the conventional logistic regression model, over the dataset from Section 2.5. The latter setup uses the sigmoid function and no polynomial approximation, in addition, no quantization is applied to the dataset or the weight vectors. We observe that CodedPrivateML achieves convergence with comparable rate to conventional logistic regression. This result shows that CodedPrivateML guarantees almost the same convergence rate, while being privacy preserving.

2.A.6.3. EXPERIMENTS FOR A SMALLER DATASET

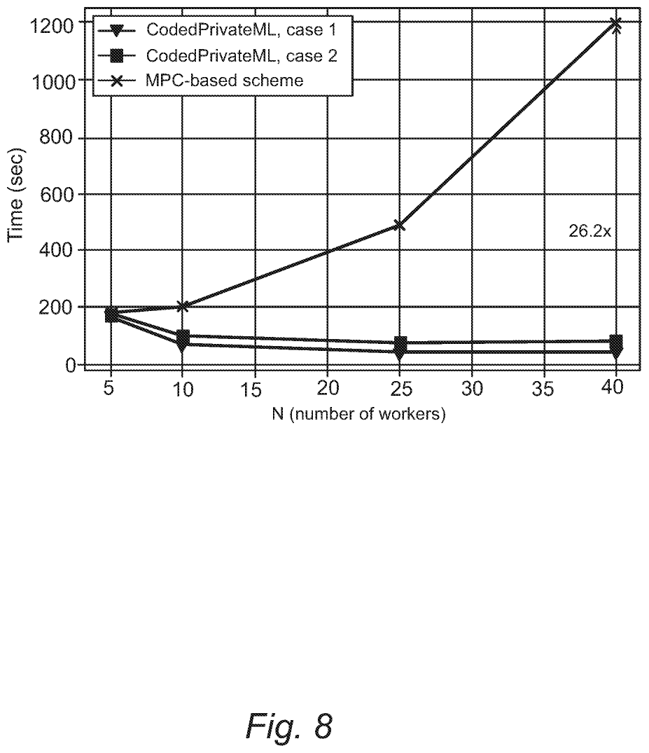

In this section, we demonstrate the performance of CodedPrivateML on a smaller dataset, by considering (m, d)=(12396, 784). FIG. 8 illustrates the training time while increasing the number of workers N gradually. Tables 3.4-3.6 provide the breakdown of the run time for the training phase, with 10; 25, and 40 workers, respectively.

Upon inspecting the performance gains from Tables 2.1-2.3 versus Tables 2.4-2.6, we conclude that CodedPrivateML achieves a higher performance gain (from 26:2× to 34:1× when N=40) as the dimension of dataset gets larger. Our interpretation of this behaviour is based on the following observation. Increasing the number of workers in the system has two major impacts on the training time of CodedPrivateML. The first one is reducing the computation load per worker, as each new worker can be used to increase the parameter K (i.e., the parallelization gain). This in turn reduces the computation load per worker as the amount of work done by each worker is scaled with respect to 1/K. The second one is that increasing the number of workers increases the encoding time. Therefore, for small datasets, i.e., when the computation load at each worker is small, the gain from increasing the number of workers beyond a certain point may be minimal and the system may saturate. A similar behavior is observed in FIG. 8 when the number of workers is increased from N=25 to N=40.

Therefore, in order to achieve the best performance gain, we find that CodedPrivateML is well suited for data intensive distributed training environments for processing large datasets. Furthermore, it can be tuned to meet the specific performance guarantees required by different applications, i.e., a faster implementation versus more privacy.

TABLE 2.4
Breakdown of the run time with
(m, d) = (12396, 784) for N = 10 workers.

| | Encode | Comm. | Comp. | Total run |
|---|---|---|---|---|
| Protocol | time (s) | time (s) | time (s) | time (s) |
| MPC-based scheme | 26.70 | 5.41 | 177.44 | 204.86 |
| CodedPrivateML (Case 1) | 8.15 | 1.26 | 50.97 | 62.23 |
| CodedPrivateML (Case 2) | 15.97 | 2.33 | 76.46 | 96.70 |

TABLE 2.5
Breakdown of the run time with
(m, d) = (12396, 784) for N = 25 workers.

| | Encode | Comm. | Comp. | Total run |
|---|---|---|---|---|
| Protocol | time (s) | time (s) | time (s) | time (s) |
| MPC-based scheme | 166.04 | 14.87 | 316.55 | 484.09 |
| CodedPrivateML (Case 1) | 16.40 | 1.29 | 18.26 | 38.87 |
| CodedPrivateML (Case 2) | 28.62 | 3.12 | 38.26 | 72.39 |

TABLE 2.6
Breakdown of the run time with
(m, d) = (12396, 784) for N = 40 workers.

| | Encode | Comm. | Comp. | Total run |
|---|---|---|---|---|
| Protocol | time (s) | time (s) | time (s) | time (s) |
| MPC-based scheme | 418.07 | 24.33 | 774.20 | 1194.12 |
| CodedPrivateML (Case 1) | 26.64 | 1.11 | 11.18 | 45.58 |
| CodedPrivateML (Case 2) | 46.52 | 2.79 | 21.07 | 76.81 |

Jim3. Coded Computing for Boolean Functions

The growing size of modern datasets necessitates a massive computation into smaller computations and operate in a distributed manner for improving overall performance. However, the adversarial servers in the distributed computing system deliberately send erroneous data in order to affect the computation for their benefit. Computing Boolean functions is the key component of many applications of interest, e.g., the classification problem, verification functions in the blockchain and the design of cryptographic algorithm. In this section, we consider the problem of computing the Boolean function in which the computation is carried out distributively across several workers with particular focus on security against Byzantine workers. We note that any Boolean function can be modeled as a multivariate polynomial which have high degree in general. Hence, the Lagrange Coded Computing (LCC) method set forth above can be used to simultaneously provide resiliency, security, and privacy. However, the security threshold (i.e., the maximum number of adversarial workers can be tolerated) provided by LCC can be extremely low if the degree of polynomial is high. Our goal is to design an efficient coding scheme which achieves the optimal security threshold with low decoding overhead. In this section, three different schemes called coded Algebraic normal form (ANF), coded Disjunctive normal form (DNF) and coded polynomial threshold function (PTF) are examined. Instead of modeling the Boolean function as a general polynomial, the key idea of the proposed schemes is to model it as the concatenation of some low-degree polynomials and the threshold functions. In terms of the security threshold, we show that the proposed coded ANF and coded DNF are optimal. For the Boolean functions with the polynomial size of sparsity and weight, it is demonstrated that the proposed coded PTF outperforms LCC in terms of the security threshold and the decoding complexity.

3.1 Introduction

With the growing size of modern datasets for applications such as machine learning and data science, it is necessary to partition a massive computation into smaller computations and perform these smaller computations in a distributed manner for improving overall performance [84]. However, distributing the computations to some external entities, which are not necessarily trusted, i.e., adversarial servers make security a major concern [85]-[87]. Thus, it is important to provide security against adversarial workers that deliberately send erroneous data in order to affect the computation for their benefit.

Computing Boolean functions is the key component of many applications of interest. For instance, learning a Boolean function for the inference of classification in discrete attribute spaces from examples of its input/output behavior has been widely studied in the past few decades [88]. The examples in the classification problem are represented by binary (0 or 1) attributes, and the inference can be converted into a Boolean function which outputs the category of each example belongs to [89]. For hash functions based on bit mixing (e.g., SHA-2), the Boolean functions are used to represent the verification functions. Moreover, Boolean functions are also primarily used in the design of cryptographic algorithm [90].

In this section, we consider the problem of computing the Boolean function in which the computation is carried out distributively across several workers with particular focus on security against Byzantine workers. Specifically, using a master-worker distributed computing system with N workers, the goal is to compute the Boolean function ƒ: {0, 1}^{m}→{0, 1} over a large dataset X=(X₁, X₂, . . . , X_{K}), i.e., ƒ(X₁), . . . , ƒ(X_{K}), in which the (encoded) datasets are pre-stored in the workers such that the computations can be secure against adversarial workers in the system.

Any Boolean function can be modeled as an Algebraic normal form (i.e., multivariate polynomial). Thus, the Lagrange Coded Computing (LCC) set forth above [91], a universal encoding technique for arbitrary multivariate polynomial computations, can be used to simultaneously alleviate the issues of resiliency, security, and privacy. The security threshold (maximum number of adversarial workers can be tolerated) provided by LCC is

$$\frac{N - ( K - 1 ) d e gf - {1}^{′}}{{2}^{′}}$$

which can be extremely low if the degree of polynomial degƒ is high. Such degree problem can be further amplified in complex Boolean functions whose degree can grow exponentially in general. Thus, we aim at designing the efficient coding scheme achieves the optimal security threshold with low decoding overhead.

A. Main Contributions

As main contributions of the present section is that instead of modeling the Boolean function as a general polynomial, we propose the three proposed schemes modeling it as the concatenation of some low-degree polynomials and the threshold functions (see FIG. 9). To illustrate the main idea of the proposed schemes, consider an AND function of three input bits X[1], X[2], X[3] which is formally defined by ƒ(X)=X[1], X[2], X[3]. The function ƒ can be modeled as a polynomial function (Algebraic normal form) X[1]X[2]X[3] which has a degree of 3. For this polynomial, LCC achieves the security threshold

$$\frac{N - 3 ( K - 1 ) - 1}{{2}^{′}} .$$

Instead of directly computing the degree 3 polynomial, our proposed approach is to model it as a linear threshold function sgn(X[1]+X[2]+[3]− 5/2) in which ƒ(X)=1 if and only if sgn (X[1]+X[2]+[3]− 5/2)>0. Then, a simple linear code (e.g., (N, K) MDS code) can be used for computing the linear function X[1]+X[2]+[3]− 5/2), which provides the optimal security threshold

$$\frac{N - K}{2} .$$

We propose three different schemes called coded Algebraic normalform (ANF), coded Disjunctive normal form (DNF) and coded polynomial threshold function (PTF). The idea behind coded ANF (DNF) is to first decompose the Boolean function into some monomials (clauses) and then construct a linear threshold function for each monomial (clause). Then, an (N; K) MDS code is used to encode the datasets. On the other hand, the proposed coded PTF models the Boolean function as a low-degree polynomial threshold function, then LCC is used for the data encoding.

In Table 2.1, we summarize the performance comparison of LCC and the proposed three schemes in terms of the security threshold and the decoding complexity. For any general Boolean function ƒ, the proposed coded ANF and coded DNF achieve the best security threshold

$$\frac{N - K}{2}$$

(matches to the theoretical outer bound) which is independent of degf. As compared to LCC, coded ANF and coded DNF provides the substantial improvement on the security threshold.

TABLE 2.1
Performance comparison of LCC and the proposed three schemes for the
Boolean function f(X) which has the sparsity r(f) and weight w(f).

| | Security Threshold | Decoding Complexity |
|---|---|---|
| LCC | $\frac{N - ( K - 1 ) deff - 1}{2}$ | O(N log³ N log logN) |
| coded ANF | $\frac{N - K}{2}$ | O(r(f)N log² N log logN) |
| coded DNF | $\frac{N - K}{2}$ | O(w(f)N log² N log logN) |
| coded PTF | $\frac{N - ( K - 1 ) ( ⌊ {log}_{2} w ( f ) ⌋ + 1 ) - 1}{2}$ | O(N log² N log logN) |
| Outer bound | $\frac{N - K}{2}$ | — |

In particular, coded ANF has the decoding complexity O(r(ƒ)N log² N log log N) which works well for the Boolean functions with low sparsity r(ƒ); coded DNF has the decoding complexity O(w(ƒ)N log² N log log N) which works well for the Boolean functions with small weight w(ƒ) (see the definitions of r(ƒ) and w(ƒ) in Section 3.2. For the Boolean functions with the polynomial size of r(ƒ) and w(ƒ), coded PTF outperforms LCC by achieving the better security threshold and the almost linear decoding complexity which is independent of m (see more details in Section 3.6).

B. Related Prior Work

Coded computing broadly refers to a family of techniques that utilize coding to inject computation redundancy in order to alleviate the various issues that arise in large-scale distributed computing. In the past few years, coded computing has had a tremendous success in various problems, such as straggler mitigation and bandwidth reduction (e.g., [92]-[99]). Coded computing has also been expanded in various directions, such as heterogeneous networks (e.g., [100]), partial stragglers (e.g., [101]), secure and private computing (e.g., [102], [103]-[105]), distributed optimization (e.g., [106]) and dynamic networks (e.g., [107]). So far, research in coded computing has focused on developing frameworks for some linear function (e.g., matrix multiplications). However, there has been no works prior to our work that consider coded computing for Boolean functions. Compared with LCC, we make the substantial progress of improving the security threshold by proposing coded ANF, coded DNF and coded PTF.

3.2 System Model

We consider the problem of evaluating a Boolean function ƒ: {0, 1}^{m}→{0, 1} over a dataset \vec{X}=(X₁, . . . , X_{K}, where X₁, X₂, . . . , X_{K}ϵ{0, 1}^{m}. Given a distributed computing environment with a master and N workers, our goal is to computer ƒ(X₁, . . . , ƒ(X_{K}).

Each Boolean function ƒ: [0, 1]^{m}→[0, 1] can be represented by an Algebraic normal form (ANF) as follows:

$$f ( X ) = f ( X ) = {⊕}_{𝒮 ⊆ [ m ]} {μ}_{f} ( 𝒮 ) {\prod }_{j ɛ 𝒮} X [ j ] \qquad ( 3.1 )$$

where X[j] is the j-bit of data X and μ_{f}(S)ϵ{0, 1} is the ANF coefficient of the corresponding monomial Π_{J∈S}X[j]. We denote the degree of Boolean function ƒ by degƒ and the sparsity (number of monomials) of ƒ by r(ƒ), i.e., r(ƒ)=Σ_{s⊆[m]}, μ_{ƒ}(S).

Furthermore, we denote the support of ƒ by Supp(ƒ) which is the set of vectors in {0, 1)^{m} such that ƒ=1, i.e., Supp(ƒ)={X∈{0, 1}m: ƒ(X)=1}. Let w(ƒ) be the weight of Boolean function ƒ, defined by w(ƒ)=|Supp(ƒ)|. Alternatively, each Boolean function ƒ can be represented by a Disjunctive normal form (DNF) as follows:

f=T₁∨T₂∨ . . . ∨T_{w}(f) (3.2)

where each clause Tᵢ has m literals which corresponds to an input Yᵢ such that ƒ(Yᵢ)=1. For example, if Yᵢ=001, then the corresponding clause is ˜Yᵢ[0]∧˜Yᵢ[1]∧Yᵢ[2].

Prior to computation, each worker has already stored a fraction of the dataset in a possibly coded manner. Specifically, each worker n stores \tilde{X}ₙ=gₙ(X₁, . . . , X_{K}, where gₙ is the encoding function of worker n. Each worker n computes hₙ\tilde{X}ₙ and returns the result to the master, in which hn is the function decided by the master. Then, the master aggregates the results from the workers until it receives a decodable set of local computations. We say a set of computations is decodable if ƒ(X₁), . . . , ƒ(X_{K}) can be obtained by computing decoding functions over the received results. More concretely, given any subset of workers that return the computing results (denoted by K), the master computes v_{K}({hₙ(\tilde{X})ₙ)}_{n∈K}), where each v_{K} is a deterministic function. We refer to the v_{K}'S as decoding functions.

In particular, we focus on finding the coding scheme to be robust to as many adversarial workers as possible in the system. The following term defines the security which can be provided by a coding scheme.

Definition 1 (Security Threshold). For an integer b, we say a scheme S is b-secure if the master can be robust against b adversaries. The security threshold, denoted by βs, is the maximum value of b such that a scheme S is b-secure, i.e.,

$${β}_{𝒮} {=}^{Δ} sup \{ b \text{:} 𝒮 is b - secure \} . \qquad ( 3.3 )$$

Based on the above system model, the problem is now formulated as: What is the coding scheme which achieves the optimal security threshold with low decoding complexity?

3.3. Overview Of Lagrange Coded Computing

In this section, we consider Lagrange Coded Computing (LCC) [91] and show how it works for our problem.

Since Lagrange coded computing requires the underlying field size to be at least the number of workers N, we first extend the field size of {0, 1}^{m} such that the size of extension field is at least the number of workers N. More specifically, we embed each bit Xₖ[j]∈{0, 1} of data Xₖ into a binary extension filed {0, 1}^{t} such that with 2^{t}≥N. The embedding X̅ₖ[j] of the bit Xₖ[j] is generated such that

$${\overline{X}}_{k} [ j ] = \{ \begin{matrix}\underbrace{00 … 0}_{t} , & {X}_{k} [ j ] = 0 , \\ \underbrace{00 … 0}_{t - 1} 1 , & {X}_{k} [ j ] = 1\end{matrix} . \qquad ( 3.4 )$$

Note that over extension field the output of Boolean function ƒ is

$$\underbrace{00 … 0}_{t}$$

if the original result is 0;

$$\underbrace{00 … 0}_{t}$$

1 if the original result is 1.

For the data encoding by using LCC, we first select K distinct elements β₁, β₂, . . . , β_{K} from extension field {0, 1}^{t}, and let u be the respective Lagrange interpolation polynomial:

$$u ( z ) {=}^{△} {\sum }_{k = 1}^{K} {\overline{X}}_{k} {\prod }_{l ∈ [ K ] \backslash \{ k \}} \frac{z - {β}_{l}}{{β}_{k} - {β}_{l}} , \qquad ( 3.5 )$$

where u: {0, 1}^{t}→{0, 1}^{mt} is a polynomial of degree K−1 such that u(βk)=Xₖ. Then we can select distinct elements α₁, α₂, . . . , α_{N} from extension field {0, 1}^{t}, and encode X₁, . . . , X_{K} to \tilde{X}ₙ u(αₙ) for all n ∈[N], i.e.,

$${\tilde{X}}_{n} = u ( {α}_{n} ) {=}^{△} {\sum }_{k = 1}^{K} {\overline{X}}_{k} {\prod }_{l ∈ [ K ] \backslash \{ k \}} \frac{{α}_{n} - {β}_{l}}{{β}_{k} - {β}_{l}} . \qquad ( 3.6 )$$

Each worker n∈[N] stores \tilde{X}ₙ locally. Following the above data encoding, each worker n computes function ƒ on \tilde{X}ₙ and sends the result back to the master upon its completion.

In the following, we present the security threshold provided by LCC. By [91], to be robust to b adversarial workers (given N and K), LCC requires N≥(K−1)degƒ+2b+1; i.e., LCC achieves the security threshold

$${β}_{LCC} = \frac{N - ( K - 1 ) deg f - 1}{2} . \qquad ( 3.7 )$$

After receiving results from the workers, the master can obtain all coefficients of ƒ(u(z)) by applying Reed-Solomon decoding [108], [109]. Having this polynomial, the master evaluates it at βₖ for every k∈[K] to obtain ƒ(u(βk))=ƒ(X̅ₖ). The complexity of decoding a length-N Reed-Solomon code with dimension t is O(tN log² N log log N). To have a sufficiently large field for LCC, we pick t=[log N]. Thus, the decoding process by the master requires complexity O(N log³ N log log N).

The security threshold achieved by LCC depends on the degree of function ƒ, i.e., the security guarantee is highly degraded if ƒ has high degree. To mitigate such degree effect, we model the Boolean function as the concatenation of some low-degree polynomials and the threshold functions by proposing three schemes in the following sections.

3.4. Scheme 1: Coded Algebraic Normal Form

In this section, we propose a coding scheme called coded Algebraic normalform (ANF) which computes the ANF representation of Boolean function by the linear threshold functions (LTF) and a simple linear code is used for the data encoding. We start with an example to illustrate the idea of coded ANF.

Example 1. We consider a function which has an ANF representation defined as follows:

$$f ( X ) = X [ 1 ] X [ 2 ] \cdot X [ \frac{m}{2} ] . \qquad ( 3.8 )$$

Then, we define a linear function over the real field:

$$L ( X ) = {\sum }_{j = 1}^{\frac{m}{2}} X [ j ] - \frac{m}{2} + \frac{1}{2} \qquad ( 3.9 )$$

where L(X)=½ if and only if F(X)=1. Otherwise, L(X)≤½. Thus, we can computer ƒ(X) by computing its corresponding linear threshold function sgn(L(X)), i.e., ƒ(X)=1 if sgn(L(X))=: otherwise, ƒ(X)=0 if sgn(L(X))=−1. Unlike computing the function ƒ(X) with the degree

$$\frac{m}{2}$$

which results in low security threshold, computing the linear function L(X) allows us to apply a linear code on the computations.

A. Formal Description of coded ANF

Given the ANF representation defined in (1), we now present the proposed coded ANF as follows. For each monomial Π_{j∈S}X[j] such that μ_{ƒ}(S)=1, we define a linear function L_{S}(X) as follows:

$${L}_{𝒮} ( X ) = {\sum }_{j ∈ 𝒮} X [ j ] - \vert 𝒮 \vert + \frac{1}{2} \qquad ( 3.10 )$$

It is clear that Lₛ(X)=½ if and only if Π_{j∈s}X[j]=1. Otherwise, Ls(X)≤−½. Thus, there are r(ƒ) constructed linear threshold functions, and each monomial Π_{j∈S}X[j] can be computed by its corresponding linear threshold function sgn(L_{S}(X)).

The master encodes X₁, X₂, . . . , X_{K} to 1, X₂, . . . \tilde{X}₁, \tilde{X}₂, . . . , \tilde{X}_{N} over the real field using an (N, K) MDS code. Each worker nϵ[N] stores \tilde{X}ₙ locally. Each worker nϵ[N] computes the functions {L_{S}(\tilde{X}ₙ{S⊆[m],μ_{ƒ}(S)=1} and then sends the results back to the master. After receiving the results from the workers, the master first recovers L_{S}(Xₖ) for each k∈[K] and each S∈{G: G⊆[m], μ_{ƒ}(G)=1}. Then, the master has j∈S Xₖ[j]=1 if sgn(L_{S}(Xₖ))=1; j∈S Xₖ[j]=0 if sgn(L_{S}(Xₖ))=−1. Lastly, the master recovers ƒ(X₁), . . . , ƒ(X_{K}) by summing the monomials.

B. Security Threshold of Coded ANF

To decode the (N, K) MDS code, coded ANF applies Reed-Solomon decoding.

Successful decoding requires the number of errors of computation results such that N≥K+2b. The following theorem shows the security achieved by coded ANF.

Theorem 1. Given a number of workers N and a dataset X=(X₁, . . . , X_{K}), the proposed coded ANF can be robust to b adversaries for computing {ƒ(Xₖ)}ₖ₌₁^{K} for any Boolean function ƒ, as long as

N≥K+2b (3.11)

i.e., coded ANF achieves the security threshold

$${β}_{A N F} = \frac{N - K}{2} . \qquad ( 3.12 )$$

Whenever the master receives N results from the workers, the master decodes the computation results using a length-N Reed-Solomon code for each of r(ƒ) linear functions which incurs the total complexity O(r(ƒ)N log² N log log N). Computing all the monomials via the signs of corresponding linear threshold functions incurs the complexity O(Nr(ƒ)). Lastly, computing ƒ(X₁), . . . , ƒ(X_{K}) by summing the monomials incurs the complexity O(Nr(ƒ)) since there are r(ƒ)−1 additions in function ƒ. Thus, the total complexity of decoding step is O(r(ƒ)N log² N log log N) which works well for small r(ƒ). Note that the operation of this scheme is over the real field whose size doesn't scale with size of m.

3.5 Scheme 2: Coded Disjunctive Normal Form

In this section, we propose a coding scheme called coded Disjunctive normal form (DNF) which computes the DNF representation of Boolean function by LTFs and a simplelinear code is used for the data encoding. We start with an example to illustrate the idea behind coded DNF.

Example 2. Consider a function which has an ANF representation defined as follows:

ƒ(X)=(X[1] . . . X[m])⊕(X[1]⊕1) . . . (X[m]⊕1)

which has the degree degƒ=m−1 and the number of monomials r(ƒ)=2ₘ−1. Alternatively, this function has a DNF representation as follows:

ƒ(X)=(X[1]∧ . . . ∧X[m])∨(˜X[1]∧ . . . ∧˜X[m])

which has the weight w(ƒ)=2.

For the clause X[1]∧ . . . ∧X[m], we define a linear function over the real field:

L₁(X)=X[1]+ . . . +X[m]+m+½ (3.13)

where X[0]∧ . . . ∧ X[m]=1 if and only if L (X)=½. Otherwise, L1(X)≤½. Similarly, for the clause ˜X[0]∧ . . . ∧˜X[m], we define a linear function over the real field:

L₂(X)=−X[1]− . . . −X[m]+½ (3.14)

where ˜X[1]∧ . . . ∧˜X[m]=1 if and only if L₂(X)=½. Otherwise, L₂(X)≤−½. Therefore, we can compute ƒ(X) by computing sgn(L₁(X)) and sgn(L₂(X)), i.e., ƒ(X)=1 if at least one of sgn(L₁(X)) and sgn(L₂(X)) is equal to 1. Otherwise, ƒ(X)=0. Unlike directly computing the function ƒ(X) with the degree of m−1, computing the linear functions L₁(X) and L₂(X) allows us to apply a linear code on the computations.

A. Formal Description of Coded DNF

Given the DNF representation defined in (2), we now present the proposed coded DNF as follows. For each clause Tᵢ with the corresponding input Yᵢ such that ƒ(Yᵢ)=1, we define a linear function Lᵢ(X) over the real field:

$$\begin{matrix}{L}_{i} ( X ) = {\sum }_{j = 1}^{m} {Z}_{i} [ j ] X [ j ] - {\sum }_{j = 1}^{m} {Y}_{i} [ j ] + \frac{1}{2} where & ( 3.15 ) \\ {Z}_{i} [ j ] = \{ \begin{matrix}1 , & if {Y}_{i} [ j ] = 1 \\ - 1 , & if {Y}_{i} [ j ] = 0\end{matrix} . & ( 3.16 )\end{matrix}$$

It is clear that Lᵢ(Yᵢ)=½ and Lᵢ(X)≤−½ for all other inputs X≠Yᵢ. Thus, there are w(ƒ) constructed linear threshold functions, and each clause Tᵢ can be computed by its corresponding linear threshold function sgn(Lᵢ(X)).

The master encodes X₁, X₂, . . . , X_{K} to \tilde{X}₁, \tilde{X}₂, . . . , \tilde{X}_{N} over the real field using an (N, K) MDS code. Each worker n∈[N] stores \tilde{X}ₙ locally. Each worker n computes the functions Lᵢ(\tilde{X}ₙ), . . . , L_{w(ƒ)}(\tilde{X}ₙ) and then sends the results back to the master. After receiving the results from the workers, the master first recovers Lᵢ(Xₖ) for each i∈[w(ƒ)] and each k∈[K] via MDS decoding. Then, the master has Tᵢ(Xₖ)=1 if sgn(Lᵢ(Xₖ))=1; otherwise Tᵢ(Xₖ)=0. Lastly, the master has ƒ(Xₖ)=1 if at least one of T₁(Xₖ), . . . , T_{w(ƒ)}(Xₖ) is equal to 1. Otherwise, ƒ(Xₖ)=0.

B. Security Threshold of Coded DNF

Similar to coded ANF, we present the following theorem shows the security threshold achieved by the coded DNF.

Theorem 2. Given a number of workers N and a dataset X=(Xᵢ, . . . , X_{K}), the proposed coded DNF can be robust to b adversaries for computing {f(Xₖ)}ₖ₌₁^{K} for any Boolean function ƒ, as long as

N≥K+2b (3.17)

i.e., coded DNF achieves the security threshold

$${β}_{D N F} = \frac{N - K}{2} \qquad ( 3.18 )$$

Whenever the master receives N results from the workers, the master decodes the computation results using a length-N Reed-Solomon code for each of w(ƒ) linear functions which incurs the total complexity O(w(ƒ)N log² N log log N). Computing all the clauses via the signs of corresponding linear threshold functions incurs the complexity O(Nw(ƒ)). Lastly, computing ƒ(X₁), . . . , ƒ(X_{K}) by checking all the clauses requires the complexity O(Nw(ƒ)). Thus, the total complexity of decoding step is O(w(ƒ)N log²N log log N) which works well for small w(ƒ).

3.6. Scheme 3: Coded Polynomial Threshold Function

In this section, we propose a coding scheme called coded polynomial threshold function which computes the DNF representation of Boolean function by the polynomial threshold functions (PTF) and LCC is used for the data encoding.

A. Formal Description of Coded PTF

Given the DNF representation defined in (2), we now present the proposed coded PTF. Following the construction proposed in [110], [111], we now construct a polynomial threshold function sgn(P(X)) for computing ƒ(X) where P(X) is a polynomial function with the degree at most └log₂w(ƒ)┘+1. The construction of such PTF has the following steps.

Decision Tree Construction: We construct an w(ƒ)-leaf decision tree over variables X[1], . . . , X[m] such that each input in Supp(ƒ) arrives at a different leaf. Such a tree can be always constructed by a greedy algorithm. Let lᵢ be a leaf of this tree in which Yᵢ reaches leaf lᵢ. We label lᵢ with the linear threshold function sgn(Lᵢ(X)) defined in (15). The constructed decision tree, in which internal nodes are labeled with variables and leaves are labeled with linear threshold functions, computes exactly ƒ.

Decision List: For this w(ƒ)-leaf decision tree, we construct an equivalent └log₂w(ƒ)┘-decision list. Following from the definition that the rank of an w(ƒ)-leaf tree is at most └log₂w(ƒ)┘. We find a leaf in the decision tree at distance at most └log₂w(ƒ)┘ from the root, and place the literals along the path to the leaf as a monomial at the top of a new decision list. We then remove the leaf from the tree, creating a new decision tree with one fewer leaf, and repeat this process [112]. Without loss of generality, we let lᵢ be the i-th removed leaf in the process of list construction with the corresponding monomial Cᵢ of at most └log₂w(ƒ)┘ variables. The constructed list is defined as “if C₁(X)=1 then output

$$\frac{1 + sgn ( {L}_{1} ( X ) )}{2} ;$$

else if C₂(X)=1 then output

$$\frac{1 + sgn ( {L}_{2} ( X ) )}{2} ;$$

. . . else if C_{w(ƒ)}(X)=1 then output

$$\frac{1 + sgn ( {L}_{w ( f )} ( X ) )}{2} .$$

Polynomial Threshold Function: Having the constructed decision list, we now construct the polynomial function P(X) with degree of at most [log w(ƒ)]+1 as follows:

P(X)=A₁C₁(X)L₁(X)+ . . . +A_{w(ƒ)}C_{w(ƒ)}(X)L_{w(ƒ)}(X)

where A₁>>A₂>>A₃>>A₃ . . . Aₘ>0 are appropriately chosen positive values.

The master encodes X₁, X₂, . . . , X_{K} to \tilde{X}₁, \tilde{X}₂, . . . , \tilde{X}_{N} over the real field using LCC. Each worker n∈[N] stores \tilde{X}ₙ locally. Each worker n computes the function P(\tilde{X}ₙ) and then sends the result back to the master. After receiving the results from the workers, the master first recovers P(X₁), . . . , P(X_{K}) via LCC decoding. Then, the master has ƒ(Xₖ)=1 if sgn(P(Xₖ))=1; otherwise ƒ(Xₖ)=0.

B. Security Threshold of Coded PTF

Since P(X) has degree of at most └log₂w(ƒ)┘+1, to be robust to b adversaries, LCC requires the number of workers N such that N≥(K−1)(└log₂w(ƒ)┘+1)+2b+1. Then, we have the following theorem.

Theorem 3. Given a number of workers N and a dataset X=(X₁, . . . , X_{K}), the proposed coded polynomial thresh-old function can be robust to b adversaries for computing {f (X)}ₖ₋₁^{K} for any Boolean function ƒ, as long as

N≥(K−1)(└log₂w(ƒ)┘+1)+2b+1 (3.19)

i.e., coded PTF achieves the security threshold

$${β}_{P T F} = \frac{N - ( K - 1 ) ( ⌊ {log}_{2} w ( f ) ⌋ + 1 ) - 1}{2} \qquad ( 3.20 )$$

Whenever the master receives N results from the workers, the master decodes the computation results using a length—N Reed-Solomon code for the polynomial function which incurs the total complexity O(N log²N log log N). Lastly, computing ƒ(X₁), ƒ(X₂), . . . , ƒ(X_{K}) by checking the signs requires the complexity O(N). Thus, the total complexity of decoding step is O(N log² N log log N).

In the following example, we show that coded PTF outperforms LCC for the Boolean functions with the polynomial size of r(ƒ) and w(ƒ).

Example 3. Consider a function which has an ANF representation defined as follows:

ƒ(X)=X[1]⊕X[2]) . . . (X[2m′−1])⊕X[2m′]×X[2m′+1] . . . X[m] (3.21)

where m′=[log₂ m²]. Note that here we focus on the case that m is large enough such that m>m=[log₂ m²]. The function ƒ has the degree of m−[log₂ m²], the sparsity of≈m² and the weight of≈m².

For the Boolean function considered in Example 3, coded PTF achieves the security threshold

$$\frac{N - ( K - 1 ) ( ⌊ {log}_{2} {m}^{2} ⌋ + 1 ) - 1}{2}$$

which is greater than the security threshold

$$\frac{N - ( K - 1 ) ( m - ⌊ {log}_{2} {m}^{2} ⌋ ) - 1}{2}$$

provided by LCC. Although coded ANF and coded DNF achieve the optimal security threshold

$$\frac{N - K}{2}$$

but they require decoding complexity O(m²N log² N log log N) which has the order of m², i.e., they only work for small m. With the security slightly worse than coded ANF and coded DNF, coded PTF achieves the better decoding complexity which is independent of m, i.e., coded PTF works for large m.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

[1] M. Abadi, P. Barham, J. Chen, Z. Chen, A. Davis, J. Dean, M. Devin, S. Ghemawat, G. Irving, M. Isard, et al., “Tensorflow: A system for large-scale machine learning.,” in OSDI, vol. 16, pp. 265-283, 2016.
[2] J. Dean and L. A. Barroso, “The tail at scale,” Communications of the ACM, vol. 56, no. 2, pp. 74-80, 2013.
[3] M. Li, D. G. Andersen, A. Smola, and K. Yu, “Communication efficient distributed machine learning with the parameter server,” in Proceedings of the 27th International Conference on Neural Information Processing Systems—Volume 1, NIPS'14, (Cambridge, Mass., USA), pp. 19-27, MIT Press, 2014.
[4] N. J. Yadwadkar, B. Hariharan, J. E. Gonzalez, and R. Katz, “Multi-task learning for straggler avoiding predictive job scheduling,” Journal of Machine Learning Research, vol. 17, no. 106, pp. 1-37, 2016.
[5] M. Li, D. G. Andersen, A. J. Smola, and K. Yu, “Communication efficient distributed machine learning with the parameter server,” in Advances in Neural Information Processing Systems, pp. 19-27, 2014.
[6] P. Blanchard, R. Guerraoui, J. Stainer, et al., “Machine learning with adversaries: Byzantine tolerant gradient descent,” in Advances in Neural Information Processing Systems, pp. 118-128, 2017.
[7] R. Cramer, I. B. Damgrd, and J. B. Nielsen, Secure Multiparty Computation and Secret Sharing. New York, N.Y., USA: Cambridge University Press, 1st ed., 2015.
[8] D. Bogdanov, S. Laur, and J. Willemson, “Sharemind: A framework for fast privacy-preserving computations,” in Proceedings of the 13th European Symposium on Research in Computer Security: Computer Security, ESORICS '08, (Berlin, Heidelberg), pp. 192-206, Springer-Verlag, 2008.
[9] K. Lee, M. Lam, R. Pedarsani, D. Papailiopoulos, and K. Ramchandran, “Speeding up distributed machine learning using codes,” IEEE Transactions on Information Theory, vol. 64, pp. 1514-1529, March 2018.
[10] R. Tandon, Q. Lei, A. G. Dimakis, and N. Karampatziakis, “Gradient coding: Avoiding stragglers in distributed learning,” in Proceedings of the 34 International Conference on Machine Learning, ICML 2017, Sydney, NSW, Australia, 6-11 Aug. 2017, pp. 3368-3376, 2017.
[11] R. K. Maity, A. S. Rawat, and A. Mazumdar, “Robust gradient descent via moment encoding with ldpc codes,” SysML Conference, 2018.
[12] C. Karakus, Y. Sun, S. Diggavi, and W. Yin, “Straggler mitigation in distributed optimization through data encoding,” in Advances in Neural Information Processing Systems, pp. 5440-5448, 2017.
[13] S. Li, S. M. M. Kalan, A. S. Avestimehr, and M. Soltanolkotabi, “Near-optimal straggler mitigation for distributed gradient methods,” arXiv preprint arXiv:1710.09990, 2017.
[14] W. Halbawi, N. A. Ruhi, F. Salehi, and B. Hassibi, “Improving distributed gradient descent using reed-solomon codes,” CoRR, vol. abs/1706.05436, 2017.
[15] N. Raviv, I. Tamo, R. Tandon, and A. G. Dimakis, “Gradient coding from cyclic mds codes and expander graphs,” arXiv preprint arXiv:1707.03858, 2017.
[16] M. Ye and E. Abbe, “Communication-computation efficient gradient coding,” arXiv preprint arXiv:1802.03475, 2018.
[17] K. Lee, M. Lam, R. Pedarsani, D. Papailiopoulos, and K. Ramchandran, “Speeding up distributed machine learning using codes,” NIPS Workshop on Machine Learning Systems, December 2015.
[18] S. Li, M. A. Maddah-Ali, and A. S. Avestimehr, “Coded MapReduce,” in Proceedings of the 2015 53rd Annual Allerton Conference on Communication, Control, and Computing (Allerton), pp. 964-971, September 2015.
[19] Q. Yu, S. Li, M. A. Maddah-Ali, and A. S. Avestimehr, “How to optimally allocate resources for coded distributed computing?,” in 2017 IEEE International Conference on Communications (ICC), pp. 1-7, May 2017.
[20] S. Li, M. A. Maddah-Ali, Q. Yu, and A. S. Avestimehr, “A fundamental tradeoff between computation and communication in distributed computing,” IEEE Transactions on Information Theory, vol. 64, no. 1, pp. 109-128, 2018.
[21] S. Dutta, V. Cadambe, and P. Grover, “Short-dot: Computing large linear transforms distributedly using coded short dot products,” in Advances In Neural Information Processing Systems, pp. 2092-2100, 2016.
[22] Q. Yu, M. Maddah-Ali, and S. Avestimehr, “Polynomial codes: an optimal design for high-dimensional coded matrix multiplication,” in Advances in Neural Information Processing Systems 30, pp. 4406-4416, Curran Associates, Inc., 2017.
[23] S. Dutta, M. Fahim, F. Haddadpour, H. Jeong, V. R. Cadambe, and P. Grover, “On the optimal recovery threshold of coded matrix multiplication,” arXiv preprint arXiv:1801.10292, 2018.
[24] H. A. Nodehi and M. A. Maddah-Ali, “Limited-sharing multi-party computation for massive matrix operations,” in 2018 IEEE International Symposium on Information Theory (ISIT), pp. 1231-1235, June 2018.
[25] L. Chen, Z. Charles, D. Papailiopoulos, et al., “Draco: Robust distributed training via redundant gradients,” arXiv preprint arXiv:1803.09877, 2018.
[26] M. Ben-Or, S. Goldwasser, and A. Wigderson, “Completeness theorems for non-cryptographic fault-tolerant distributed computation,” in Proceedings of the twentieth annual ACM symposium on Theory of computing, pp. 1-10, ACM, 1988.
[27] P. Mohassel and Y. Zhang, “Secureml: A system for scalable privacy-preserving machine learning,” in 2017 IEEE Symposium on Security and Privacy (SP), vol. 00, pp. 19-38, May 2017.
[28] R. Bitar, P. Parag, and S. E. Rouayheb, “Minimizing latency for secure coded computing using secret sharing via staircase codes,” arXiv preprint arXiv:1802.02640, 2018.
[29] S. Wang, J. Liu, N. Shroff, and P. Yang, “Fundamental limits of coded linear transform,” arXiv preprint arXiv:1804.09791, 2018.
[30] Q. Yu, M. A. Maddah-Ali, and A. S. Avestimehr, “Straggler mitigation in distributed matrix multiplication: Fundamental limits and optimal coding,” arXiv preprint arXiv:1801.07487, 2018.
[31] P. Renteln, Manifolds, Tensors, and Forms: An Introduction for Mathematicians and Physicists. Cambridge University Press, 2013.
[32] S. Shalev-Shwartz and S. Ben-David, Understanding machine learning: From theory to algorithms. Cambridge university press, 2014.
[33] S. Li, S. Supittayapornpong, M. A. Maddah-Ali, and S. Avestimehr, “Coded terasort,” IPDPSW, 2017.
[34] Y. H. Ezzeldin, M. Karmoose, and C. Fragouli, “Communication vs distributed computation: an alternative trade-off curve,” arXiv preprint arXiv:1705.08966, 2017.
[35] S. Prakash, A. Reisizadeh, R. Pedarsani, and S. Avestimehr, “Coded computing for distributed graph analytics,” arXiv preprint arXiv:1801.05522, 2018.
[36] K. Konstantinidis and A. Ramamoorthy, “Leveraging Coding Techniques for Speeding up Distributed Computing,” ArXiv e-prints, 2018.
[37] R. Roth, Introduction to coding theory. Cambridge University Press, 2006.
[38] A. Shamir, “How to share a secret,” Commun. ACM, vol. 22, pp. 612-613, November 1979.
[39] S. Li, M. Yu, S. Avestimehr, S. Kannan, and P. Viswanath, “Polyshard: Coded sharding achieves linearly scaling efficiency and security simultaneously,” arXiv preprint arXiv:1809.10361, 2018.
[40] J. So, B. Guler, A. S. Avestimehr, and P. Mohassel, “Codedprivateml: A fast and privacy-preserving framework for distributed machine learning,” arXiv preprint arXiv:1902.00641, 2019.
[41] K. S. Kedlaya and C. Umans, “Fast polynomial factorization and modular composition,” SIAM Journal on Computing, vol. 40, no. 6, pp. 1767-1802, 2011.
[42] E. Berlekamp, “Nonbinary bch decoding (abstr.),” IEEE Transactions on Information Theory, vol. 14, pp. 242-242, March 1968.
[43] J. Massey, “Shift-register synthesis and bch decoding,” IEEE Transactions on Information Theory, vol. 15, pp. 122-127, January 1969.
[44] M. Sudan, “Notes on an efficient solution to the rational function interpolation problem,” Avaliable from http://people.csail.mit.edu/madhu/FT01/notes/rational.ps, 1999.
[45] M. Rosenblum, “A fast algorithm for rational function approximations,” Avaliable from http://people.csail.mit.edu/madhu/FTO1/notes/rosenblum.ps, 1999.
[46] V. Y. Pan, “Matrix structures of vandermonde and cauchy types and polynomial and rational computations,” in Structured Matrices and Polynomials, pp. 73-116, Springer, 2001.
[47] W. Huang, Coding for Security and Reliability in Distributed Systems. PhD thesis, California Institute of Technology, 2017.
[48] Yu, Q., Raviv, N., Kalan, S. M. M., Soltanolkotabi, M., and Avestimehr, A. S. Lagrange coded computing: Optimal design for resiliency, security and privacy. In International Conference on Artificial Intelligence and Statistics (AISTATS), 2019.
[49] Yao, A. C. Protocols for secure computations. In IEEE Annual Symposium on Foundations of Computer Science, pp. 160-164, 1982.
[50] Ben-Or, M., Goldwasser, S., and Wigderson, A. Com-pleteness theorems for non-cryptographic fault-tolerant distributed computation. In Proceedings of the Twentieth Annual ACM Symposium on Theory of Computing, pp. 1-10. ACM, 1988.
[51] Nikolaenko, V., Weinsberg, U., Ioannidis, S., Joye, M., Boneh, D., and Taft, N. Privacy-preserving ridge re-gression on hundreds of millions of records. In IEEE Symposium on Security and Privacy, pp. 334-348. IEEE, 2013.
[52] Gasco'n, A., Schoppmann, P., Balle, B., Raykova, M., Do-erner, J., Zahur, S., and Evans, D. Privacy-preserving distributed linear regression on high-dimensional data. Proceedings on Privacy Enhancing Technologies, 2017 (4):345-364, 2017.
[53] Mohassel, P. and Zhang, Y. SecureML: A system for scal-able privacy-preserving machine learning. In 38th IEEE Symposium on Security and Privacy, pp. 19-38. IEEE, 2017.
[54] Lindell, Y. and Pinkas, B. Privacy preserving data mining. In Annual International Cryptology Conference, pp. 36-54. Springer, 2000.
[55] Dahl, M., Mancuso, J., Dupis, Y., Decoste, B., Giraud, M., Livingstone, I., Patriquin, J., and Uhma, G. Private ma-chine learning in TensorFlow using secure computation. arXiv:1810.08130, 2018.
[56] Chen, V., Pastro, V., and Raykova, M. Secure computation for machine learning with SPDZ. arXiv:1901.00329, 2019.
[57] Shamir, A. How to share a secret. Communications of the ACM, 22(11):612-613, 1979.
[58] Wagh, S., Gupta, D., and Chandran, N. Securenn: Efficient and private neural network training. Cryptology ePrint Archive, Report 2018/442, 2018. https://eprint.iacr.org/2018/442.
[59] Mohassel, P. and Rindal, P. ABY 3: A mixed protocol framework for machine learning. In Proceedings of the 2018 ACM SIGSAC Conference on Computer and Com-munications Security, pp. 35-52, 2018.
[60] LeCun, Y., Cortes, C., and Burges, C. MNIST handwritten digit database. [Online]. Available: http://yann.lecun.com/exdb/mnist, 2, 2010.
[61] Gentry, C. and Boneh, D. A fully homomorphic encryption scheme, volume 20. Stanford University, Stanford, 2009.
[62] Gilad-Bachrach, R., Dowlin, N., Laine, K., Lauter, K., Naehrig, M., and Wernsing, J. Cryptonets: Applying neural networks to encrypted data with high throughput and accuracy. In International Conference on Machine Learning, pp. 201-210, 2016.
[63] Hesamifard, E., Takabi, H., and Ghasemi, M. Cryp-toDL: Deep neural networks over encrypted data. arXiv:1711.05189, 2017.
[64] Graepel, T., Lauter, K., and Naehrig, M. ML confidential: Machine learning on encrypted data. In International Conference on Information Security and Cryptology, pp. 1-21. Springer, 2012.
[65] Yuan, J. and Yu, S. Privacy preserving back-propagation neural network learning made practical with cloud com-puting. IEEE Transactions on Parallel and Distributed Systems, 25(1):212-221, 2014.
[66] Li, P., Li, J., Huang, Z., Gao, C.-Z., Chen, W.-B., and Chen, K. Privacy-preserving outsourced classification in cloud computing. Cluster Computing, pp. 1-10, 2017.
[67] Kim, A., Song, Y., Kim, M., Lee, K., and Cheon, J. H. Lo-gistic regression model training based on the approximate homomorphic encryption. BMC Medical Genomics, 11 (4):23-55, October 2018.
[68] Wang, Q., Du, M., Chen, X., Chen, Y., Zhou, P., Chen, X., and Huang, X.
Privacy-preserving collaborative model learning: The case of word vector training. IEEE Transactions on Knowledge and Data Engineering, 30(12): 2381-2393, December 2018.
[69] Han, K., Hong, S., Cheon, J. H., and Park, D. Logis-tic regression on homomorphic encrypted data at scale. Thirty-First Annual Conference on Innovative Applica-tions of Artificial Intelligence (IAAI-19), Available online: https://daejunpark.github.io/iaai19.pdf, 2019.
[70] Dwork, C., McSherry, F., Nissim, K., and Smith, A. Cali-brating noise to sensitivity in private data analysis. In The-ory of Cryptography Conference, pp. 265-284. Springer, 2006.
[71] Chaudhuri, K. and Monteleoni, C. Privacy-preserving lo-gistic regression. In Advances in Neural Information Processing Systems, pp. 289-296, 2009.
[72] Shokri, R. and Shmatikov, V. Privacy-preserving deep learn-ing. In Proceedings of the 2015 ACM SIGSAC Conference on Computer and Communications Security, pp. 1310-1321, 2015.
[73] Abadi, M., Chu, A., Goodfellow, I., McMahan, H. B., Mironov, I., Talwar, K., and Zhang, L. Deep learning with differential privacy. In Proceedings of the 2016 ACM SIGSAC Conference on Computer and Communications Security, pp. 308-318, 2016.
[74] Pathak, M., Rane, S., and Raj, B. Multiparty differential privacy via aggregation of locally trained classifiers. In Advances in Neural Information Processing Systems, pp. 1876-1884, 2010.
[75] McMahan, H. B., Ramage, D., Talwar, K., and Zhang, L. Learning differentially private recurrent language models. In International Conference on Learning Representations, 2018.
[76] Rajkumar, A. and Agarwal, S. A differentially private stochastic gradient descent algorithm for multiparty classification. In Proceedings of the Fifteenth International Conference on Artificial Intelligence and Statistics (AIS-TATS'12), volume 22 of Proceedings of Machine Learning Research, pp. 933-941, La Palma, Canary Islands, April 2012.
[77] Jayaraman, B., Wang, L., Evans, D., and Gu, Q. Distributed learning without distress: Privacy-preserving empirical risk minimization. In Advances in Neural Information Processing Systems, pp. 6346-6357, 2018.
[78] Melis, L., Song, C., Cristofaro, E. D., and Shmatikov, V. Exploiting unintended feature leakage in collaborative learning. arXiv:1805.04049, 2019.
[79] Zhang, H., Li, J., Kara, K., Alistarh, D., Liu, J., and Zhang, C. The ZipML framework for training models with end-to-end low precision: The cans, the cannots, and a little bit of deep learning. arXiv:1611.05402, 2016.
[80] Zhang, H., Li, J., Kara, K., Alistarh, D., Liu, J., and Zhang, C. ZipML: Training linear models with end-to-end low precision, and a little bit of deep learning. In Proceed-ings of the 34th International Conference on Machine Learning, pp. 4035-4043, Sydney, Australia, August 2017.
[81] Dalc'm, L., Paz, R., and Storti, M. MPI for Python. Journal of Parallel and Distributed Computing, 65(9):1108-1115, 2005.
[82] Brinkhuis, J. and Tikhomirov, V. Optimization: Insights and Applications. Princeton Series in Applied Mathematics. Princeton University Press, 2011.
[83] Cover, T. M. and Thomas, J. A. Elements of information theory. John Wiley & Sons, 2012.
[84] M. Abadi, P. Barham, J. Chen, Z. Chen, A. Davis, J. Dean, M. Devin, S. Ghemawat, G. Irving, M. Isard, et al., “Tensorflow: A system for large-scale machine learning,” in 12th {USENIX} Symposium on Operating Systems Design and Implementation ({OSDI}16), pp. 265-283, 2016.
[85] P. Blanchard, R. Guerraoui, J. Stainer, et al., “Machine learning with adversaries: Byzantine tolerant gradient descent,” in Advances in Neural Information Processing Systems, pp. 119-129, 2017.
[86] R. Cramer, I. B. Damgård, and J. B. Nielsen, Secure multiparty computation. Cambridge University Press, 2015.
[87] D. Bogdanov, S. Laur, and J. Willemson, “Sharemind: A framework for fast privacy-preserving computations,” in European Symposium on Research in Computer Security, pp. 192-206, Springer, 2008.
[88] B. K. Natarajan, “On learning boolean functions,” in Proceedings of the nineteenth annual ACM symposium on Theory of computing, pp. 296-304, ACM, 1987.
[89] L. M. Moreira, “The use of boolean concepts in general classification contexts,” tech. rep., EPFL, 2000.
[90] T. W. Cusick and P. Stanica, Cryptographic Boolean functions and applications. Academic Press, 2017.
[91] Q. Yu, S. Li, N. Raviv, S. M. M. Kalan, M. Soltanolkotabi, and S. A. Avestimehr, “Lagrange coded computing: Optimal design for resiliency, security, and privacy,” in The 22nd International Conference on Artificial Intelligence and Statistics, pp. 1215-1225, 2019.
[92] K. Lee, M. Lam, R. Pedarsani, D. Papailiopoulos, and K. Ramchandran, “Speeding up distributed machine learning using codes,” IEEE Transactions on Information Theory, vol. 64, no. 3, pp. 1514-1529, 2018.
[93] S. Li, M. A. Maddah-Ali, Q. Yu, and A. S. Avestimehr, “A fundamental tradeoff between computation and communication in distributed computing,” IEEE Transactions on Information Theory, vol. 64, no. 1, pp. 109-128, 2018.
[94] S. Dutta, V. Cadambe, and P. Grover, “Short-dot: Computing large linear transforms distributedly using coded short dot products,” in Advances In Neural Information Processing Systems, pp. 2100-2108, 2016.
[95] K. Lee, C. Suh, and K. Ramchandran, “High-dimensional coded matrix multiplication,” in Information Theory (ISIT), 2017 IEEE International Symposium on, pp. 2418-2422, IEEE, 2017.
[96] Q. Yu, M. Maddah-Ali, and S. Avestimehr, “Polynomial codes: an optimal design for high-dimensional coded matrix multiplication,” in Advances in Neural Information Processing Systems, pp. 4403-4413, 2017.
[97] R. Tandon, Q. Lei, A. G. Dimakis, and N. Karampatziakis, “Gradient coding: Avoiding stragglers in distributed learning,” in International Conference on Machine Learning, pp. 3368-3376, 2017.
[98] S. Li, M. A. Maddah-Ali, and A. S. Avestimehr, “Coding for distributed fog computing,” IEEE Communications Magazine, vol. 55, no. 4, pp. 34-40, 2017.
[99] K. G. Narra, Z. Lin, M. Kiamari, S. Avestimehr, and M. Annavaram, “Slack squeeze coded computing for adaptive straggler mitigation,” in Proceedings of the International Conference for High Performance Computing, Networking, Storage and Analysis, p. 14, ACM, 2019.
[100] A. Reisizadeh, S. Prakash, R. Pedarsani, and A. S. Avestimehr, “Coded computation over heterogeneous clusters,” IEEE Transactions on Information Theory, 2019.
[101] N. Ferdinand and S. C. Draper, “Hierarchical coded computation,” in 2018 IEEE International Symposium on Information Theory (ISIT), pp. 1620-1624, IEEE, 2018.
[102] L. Chen, H. Wang, Z. Charles, and D. Papailiopoulos, “Draco: Byzantine-resilient distributed training via redundant gradients,” in International Conference on Machine Learning, pp. 903-912, 2018.
[103] J. So, B. Guler, A. S. Avestimehr, and P. Mohassel, “Codedprivateml: A fast and privacy-preserving framework for distributed machine learning,” arXiv preprint arXiv:1902.00641, 2019.
[104] S. Kadhe, O. O. Koyluoglu, and K. Ramchandran, “Gradient coding based on block designs for mitigating adversarial stragglers,” arXiv preprint arXiv:1904.13373, 2019.
[105] H. A. Nodehi and M. A. Maddah-Ali, “Secure coded multi-party computation for massive matrix operations,” arXiv preprint arXiv:1908.04255, 2019.
[106] C. Karakus, Y. Sun, S. Diggavi, and W. Yin, “Straggler mitigation in distributed optimization through data encoding,” in Advances in Neural Information Processing Systems, pp. 5434-5442, 2017.
[107] C.-S. Yang, R. Pedarsani, and A. S. Avestimehr, “Timely-throughput optimal coded computing over cloud networks,” in Proceedings of the Twentieth ACM International Symposium on Mobile Ad Hoc Networking and Computing, pp. 301-310, ACM, 2019.
[108] E. Berlekamp, “Nonbinary bch decoding (abstr.),”IEEE Transactions on Information Theory, vol. 14, no. 2, pp. 242-242, 1968.
[109] J. Massey, “Shift-register synthesis and bch decoding,” IEEE transactions on Information Theory, vol. 15, no. 1, pp. 122-127, 1969.
[110] R. O'Donnell and R. A. Servedio, “External properties of polynomial threshold functions,” Journal of Computer and System Sciences, vol. 74, no. 3, pp. 298-312, 2008.
[111] A. R. Klivans and R. A. Servedio, “Learning dnf in time 2o (n1/3),” Journal of Computer and System Sciences, vol. 68, no. 2, pp. 303-318, 2004.
[112] A. Blum, “Rank-r decision trees area subclass of r-decision lists,” Information Processing Letters, vol. 42, no. 4, pp. 183-185, 1992.

What is claimed is:

1. A method for calculating a given multivariate polynomial ƒ(Xᵢ) for every Xᵢ in a large dataset X=(X₁, X₂, . . . ; X_{K}) in accordance with an S-resilient, A-secure, and T-private scheme where K is an integer enumerating the number of elements in a dataset X, S is the number of stragglers to be tolerated, A is the number of adversaries to be tolerated, and T is the number of colluding workers that to be tolerated, the method implemented by a computer system comprising a master computing device and a plurality of worker computing devices, the master computing device operable to execute steps of:
a) selecting K+T distinct elements;
b) transforming the K+T distinct elements with a Lagrange interpolation polynomial to determine input variables \tilde{X}ᵢ;
c) determine input variables \tilde{X}ᵢ to the plurality of worker computing devices to determine f(\tilde{X}ᵢ);
d) receive outputs f(\tilde{X}ᵢ) from the plurality of worker computing devices; and
e) determine coefficients of ƒ(u(z)) from outputs f(\tilde{X}ᵢ).

2. The method of claim 1 wherein:
step a) comprises selecting any K+T distinct elements β₁, . . . , β_{K+T} from a field [symbol] where K is a predetermined integer; and
step b) comprises finding a Lagrange interpolation polynomial u: [symbol] → [symbol] of degree at most K+T−1 such that u(βᵢ)=Xᵢ for any i∈[K], and u(βᵢ)=Zi for i∈{K+1, . . . , K+T}, where all Zi's are chosen uniformly at random from [symbol] , where [symbol] is a vector space of dimension M and determining input variables \tilde{X}ᵢ=u(αᵢ) for any integer (i.e., i∈[N]); and wherein deg(ƒ(u(z)))≤deg(ƒ)·(K+T−1), and N≥(K+T−1) deg(ƒ)+S+2A+1 where N is the number of worker computing devices.

3. The method of claim 2 wherein the Lagrange interpolation polynomial describe by the following formula:
$$u ( z ) {=}^{Δ} {\sum }_{j ∈ [ K ]} {X}_{j} \cdot {\prod }_{k ∈ [ K + T ] ∖ \{ j \}} \frac{z - {β}_{k}}{β j - β k} + {{Σ}_{j = K + 1}}^{K + T} {Z}_{i} \cdot {Π}_{k ∈ [ K + T ] ∖ \{ j \} z} \frac{z - β k}{β j - β k} .$$

4. The method of claim 1 wherein the coefficients of ƒ(u(z)) are determined by applying Reed-Solomon decoding.

5. The method of claim 1 wherein input variables are encoded as
\tilde{X}ᵢ=u(αᵢ)=(X₁, . . . ,X_{K},Z_{K+1}, . . . ,Z_{K+T})·Uᵢ (2)
where U∈ [symbol] _{q}^{(K+T)×N} is encoding matrix
$${U}_{i , j} {=}^{Δ} {Σ}_{𝓁 ∈ [ K + T ] ∖ \{ i \}} \frac{{α}_{j} - {β}_{𝓁}}{β i - {β}_{𝓁}} ,$$
and Ui is its i'th column.

6. The method of claim 1 wherein no element of αᵢ is the same as any element of βⱼ that is {αᵢ}_{i∈[N]}∩{βⱼ}_{i∈[K]}=Ø.

7. The method of claim 1 wherein each working computing device is operable to:
receive input variables \tilde{X}ᵢ from the master computing device;
calculate outputs f(\tilde{X}ᵢ); and
send outputs f(\tilde{X}ᵢ) to the master computing device.

8. The method of claim 1 wherein the given multivariate polynomial is a representation of a Boolean function.

9. The method of claim 1 wherein the given multivariate polynomial a loss function for a machine learning training process applying a training process, the training process including gradient computation on both coded and uncoded data with model updates being decoded at the master.

10. The method of claim 9 wherein the loss function is a cross-entropy function.

11. The method of claim 10 wherein training dataset is represented by a matrix Xϵ{0, 1}^{m} with row i denoted by xᵢ, model parameters (weights) wϵR^{d} are obtained by minimizing the cross-entropy function,
$$C ( w ) = \frac{1}{m} {\sum }_{i = 1}^{m} ( - {y}_{i} log {\hat{y}}_{i} - ( 1 ( - {y}_{i} ) log ( 1 - {\hat{y}}_{i} ) ) \qquad ( 2.1 . )$$
where ŷᵢ=g(xᵢ·w)ϵ(0, 1) is the estimated probability of label i being equal to 1 and g(·) is a sigmoid function:
g(z)=1/(1+e^{-z}) (2.2)

12. The method of claim 11 wherein C(w) is solved via gradient descent, through an iterative process that updates the model parameters in the opposite direction of the gradient where the gradient for C(w) is given by
$$∇ C ( w ) = \frac{1}{m} {X}^{T} ( g ( X \times w ) - y )$$
and wherein the model parameters are updated as:
$${w}^{t + 1 )} = {w}^{t} - \frac{n}{m} {X}^{T} ( g ( X \times {w}^{} ( ( t ) ) ) - y ) \qquad ( 2.3 )$$
where t is an integer label for each iteration, w^{(t)} holds the estimated parameters from iteration t, n is the learning rate, and function (g(·) operates element-wise over a vector given by X×w^{(t)}.

13. A method for calculating a given multivariate polynomial ƒ(Xᵢ) for every Xᵢ in a large dataset X=(X₁, X₂, . . . ; X_{K}) in accordance with an S-resilient, A-secure, and T-private scheme where K is an integer enumerating the number of elements in a dataset X, S is the number of stragglers to be tolerated, A is the number of adversaries to be tolerated, and T is the number of colluding workers that to be tolerated, the method implemented by a computer system comprising a master computing device and a plurality of worker computing devices, the master computing device operable to execute steps of:
select any K+T distinct elements β₁, . . . , β_{K+T} from a field [symbol] where K is a predetermined integer;
find a polynomial u: [symbol] → [symbol] of degree at most K+T−1 such that u(βᵢ)=Xᵢ for any i∈[K], and u(βᵢ)=Zi for i∈{K+1, . . . , K+T}, where all Zi's are chosen uniformly at random from [symbol] , where [symbol] is a vector space of dimension M;
select a predetermined number N of elements {αᵢ}_{i∈[N]} from field [symbol] where N is the number of worker computing devices;
determine input variables \tilde{X}ᵢ=u(αᵢ) for any integer (i.e., i∈[N]); and
provide determine input variables \tilde{X}ᵢ to the plurality of worker computing devices to determine f(\tilde{X}ᵢ);
receive outputs f(\tilde{X}ᵢ) from the plurality of worker computing devices; and
determine coefficients of ƒ(u(z)) from outputs f(\tilde{X}ᵢ), wherein deg(ƒ(u(z)))≤deg(ƒ)·(K+T−1), and N≥(K+T−1) deg(ƒ)+S+2A+1 and wherein the polynomial u is a Lagrange interpolation polynomial.

14. The method of claim 13 wherein the polynomial u is a Lagrange interpolation polynomial describe by the following formula:
$$u ( z ) {=}^{Δ} {\sum }_{j ∈ [ K ]} {X}_{j} \cdot {\prod }_{k ∈ [ K + T ] ∖ \{ j \}} \frac{z - {β}_{k}}{β j - β k} + {{Σ}_{j = K + 1}}^{K + T} {Z}_{i} \cdot {Π}_{k ∈ [ K + T ] ∖ \{ j \} z} \frac{z - β k}{β j - β k} .$$

15. The method of claim 13 wherein the coefficients of ƒ(u(z)) are determined by applying Reed-Solomon decoding.

16. The method of claim 13 wherein input variables are encoded as
\tilde{X}ᵢ=u(αᵢ)=(X₁, . . . ,X_{K},Z_{K+1}, . . . ,Z_{K+T})·Uᵢ (2)
where U∈ [symbol] _{q}^{(K+T)×N} is encoding matrix
$${U}_{i , j} {=}^{Δ} {Σ}_{𝓁 ∈ [ K + T ] ∖ \{ i \}} \frac{{α}_{j} - {β}_{𝓁}}{β i - {β}_{𝓁}} ,$$
and Ui is its i'th column.

17. The method of claim 13 wherein each working computing device is operable to:
receive input variables \tilde{X}ᵢ from the master computing device;
calculate outputs f(\tilde{X}ᵢ); and
send outputs f(\tilde{X}ᵢ) to the master computing device.

18. A method for calculating a predetermined Boolean function ƒ(X) for every Xᵢ in a large input dataset X=(X₁, X₂, . . . ; X_{K}) to provide security against malicious worker computing devices, the method implemented by a computer system comprising a master computing device and a plurality of worker computing devices, the master computing device operable to execute steps of:
representing the predetermined Boolean function ƒ(X) as a concatenation of low-degree polynomials and the threshold functions, the low-degree polynomials each having a degree less than a general polynomial representation of the Boolean function ƒ(X);
encoding the input data to form a set of encoded input data;
transmitting the set of encoded input data to the working computing devices which calculate partial output results; and
receiving and decoding the partial output results to determine an output for the predetermined Boolean function.

19. The method of claim 18 wherein the Boolean function ƒ(X) is represented by determining the coded algebraic normal form (ANF) as follows:
$$f ( X ) = f ( X ) = {}_{{𝒮 ⊆ [ m ]}^{⊕}}^{}{μ}{}_{f}^{} ( 𝒮 ) {Π}_{j ∈ 𝒮} X [ j ] \qquad ( 3.1 )$$
where X[j] is the j-bit of data X and μ_{f}(S)ϵ{0, 1} is the ANF coefficient of the corresponding monomial Π_{jεS}X[j].

20. The method of claim 18 wherein the Boolean function is represented by coded disjunctive normal form (DNF) as follows:
f=T₁∨T₂∨ . . . ∨T_{w}(f) (3.2)
where each clause Tᵢ has m literals which corresponds to an input Yᵢ such that ƒ(Yᵢ)=1.

21. The method of claim 18 wherein the master computing device applies MDS code to encode the input dataset.
